(19) United States
(12) Patent Application Publication
(10) Pub. No.: US 2024/0086803 A1
(43) Pub. Date: Mar. 14, 2024

(54) Platform for Cross-Enterprise Project Monitoring, Management, and Reporting

(71) Applicant: David Lopez, Torrance, CA (US)

(72) Inventor: David Lopez, Torrance, CA (US)

(21) Appl. No.: 17/942,133

(22) Filed: Sep. 10, 2022

Related U.S. Application Data
(60) Provisional application No. 63/243,093, filed on Sep. 10, 2021.

(51) Int. Cl. G06Q 10/06

(52) U.S. Cl. CPC G06Q 10/06313; G06Q 10/067

(57) ABSTRACT

A platform for cross-enterprise project monitoring, management, and reporting, with web-browser and mobile application implementations, said platform allowing eligible users to create and manage project information records, said platform capable of mining specific information from a database, then generating, delivering, and archiving any one of a plurality of report types, said platform possessing further embodiments depending on user type, said platform comprising a set of a curated set of menu titles and navigation topics corresponding to each said menu title, said platform possessing two intermediate layers linking a project to requisite fulfillment tasks, wherein one layer represents a set of one or more units and another layer represents a set of one or more task groups, said platform possessing templatization modules for said units and individual tasks binned by said task groups, said mobile application possessing the capability to operate without a data network.

### CROSS-REFERENCE TO RELATED APPLICATIONS

The present application claims priority to provisional patent application No. 63/243,093 filed on Sep. 10, 2021, disclosures of which are incorporated herein at least by reference.

### FIELD OF THE DISCLOSURE

The field of disclosure described herein generally relates to a platform with methods for efficient and effective project monitoring, management, and reporting, particularly when a team(s) of service providers are dispatched to one or more remote locations.

### BACKGROUND OF THE DISCLOSURE

The advent of the digital computer, computer operating systems, data storage, networking, various input/output (I/O) devices like touch screens and keyboards, and associated drivers have fostered the development of certain software applications and methods to help monitor or update the status of complicated processes and projects that involve extensive human labor as well as support more efficient collaboration and supervision. Such platforms cater to business services, product development, manufacturing, and building construction projects.

One such provider, ZOHO®, currently develops and supports a software application called “Projects” in both web browser and mobile application implementations that allow users to add tasks and subtasks as well as the sequence of tasks, milestones, track progress with Gantt charts, define tasks and automate certain processes like notifications, log labor timesheets, create, store, and organize documents, create templates for tasks, task lists, and projects, add search tags, and facilitate communication through chat, forum, Email, and interactive news feeds. This application also allows one to view tasks in various manners such as a detailed Task list, a simplified list of tasks, and a Kanban board, which displays tasks as cards grouped in different columns based on task statuses.

Despite all these features, the ZOHO® Projects platform lacks key capabilities that are important for team members working at project sites where mission-critical information may not be easily or timely exchanged due to data network restrictions: for example, within a secure military base or simply no internet access signal. The following comments underscore both a long-standing and unmet need for an offline mode that is furthermore not planned for addition by ZOHO® (Source: https://help.zohoo.com/Portal/en/commUnity/topic/projects-offline-access-update):
Comment from a ZOHO® User affiliated with EASTERN STATE PENITENTIARY HISTORIC SITE: “Many areas at my location do not have internet access. This is becoming a big issue with Zoho Projects for my team. I would urge you to upgrade the priority of this feature. Projects may soon be replaced by my team because of crew frustrations with the issue.”
Comment from another ZOHO® User: “Any update on this request? My team (myself included) is frequently on flights where there is no WiFi access and offline access would be helpful. Thank you, Daphne”
Comment from a ZOHO® User: “This has been requested for 10 years. Please make projects available offline. Kind regards Mike”
ZOHO® representative stating offline mode is not planned for Projects line: “Hello, Folks! We don't have immediate plan to provide Zoho Projects as an offline application. Regards, Monica”

Another provider of project management tools, D-Tools, Inc. (@d®), does provide in their SYSTEM INTEGRATOR (SI) limited offline functionality of their mobile application for audio/video (A/V) and security system integrators, where the integrators perform functions such as cable pulls, equipment mounting, networking configuration, programming, and more at a customer site that is remote from the controlling vendor's center or hub of operations. However, the offline capability is heavily read-only and requires the initial installation and possible configuration of an instance of a SQL server. Furthermore, the offline mode lacks several features that are important to many users, such as:
An organized listing of searchable building units (“Units”) or spaces (“Spaces”) where project labor is being fulfilled
Means to scan QR codes into the equipment registration form
Upload a completion signoff form
Approve periodic (e.g., daily) report send-out to eligible recipients

SI's browser-based application implementation is also extremely cluttered with only a list-style view of all projects. The top of the SI application mimics the ribbon-style layout in many commonly used applications within the MICROSOFT® OFFICE or 365® software suite and grab bag of widgets under Home, Layouts, and Settings menus that lack both logical organization and important features for platform customizability. Finally, SI and other applications lack many reporting capabilities that maximize operational efficiency, like daily reporting to targeted recipients and customizable “snapshot” report generation that would be useful when, for example, a new project manager is brought mid-stream into a project and wants to be efficiently apprised on the project status, and a project completion report.

### SUMMARY OF THE DISCLOSURE

The present disclosure describes a novel digital “Platform” that possesses a curated selection and integration of many features and methods that advance the state of the art in cross-enterprise project monitoring, management, and reporting, particularly when a team(s) (“Team”) of service providers are dispatched to one or more remote locations. The capabilities disclosed in the present invention are the culmination of decades of experience on the part of the inventor in the audio/video (A/V) and information networking industry and were created to address a long, unfulfilled need.

The Platform is comprised of a suite of interlinked modules that underpin a fully integrated environment tracking environment. The organizational framework of the aspects of a project (“Project”) as defined within the present invention enables the capabilities to be generalizable and extensible.

Thus, the present invention allows users (“Users”) to organize and access project information, enable workflow automation, help stop wasted man-hours in the field, and provide unparalleled real-time visibility of a project's status, including customers in a manner not previously possible. This Platform also forces off-site “Project Manager Users” to become more engaged with each of his/her Project(s). At the same time, the present invention greatly improves a manager's oversite bandwidth such that a centrally located Project Manager User can monitor and manage more Projects.

At the top level, the Platform is comprised of two main components: a full web browser-based application (“Portal”) and a Mobile Application (“MA”). Each component has common features as well as unique features that are meant to complement each other for the various User types across an “Enterprise,” where Enterprise in this disclosure includes all entities with a vested interest in the Project: service provider (“Vendor”) who fulfills the project tasks and the end customer (“Customer”) who receive the product(s) and/or service(s) from the Vendor. Several key innovations of the present invention hitherto unavailable from existing offerings are:
1) Three Styles of Automated, Customizable, Targeted Reporting: The preferred embodiment of the present invention is capable of querying from the Platform's database (“Database”), a specific pre-defined and/or User-defined set of information fragments that can succinctly define a specific state of the Project's progress (“Daily,” “Current Snapshot” on cumulative progress, and “Project Completion”), generating a report (“Report”), file-size-compressing the Report into a portable document file (PDF) or format appropriate for the given usage embodiment, and making available for download or automated dissemination.
2) User-Defined Object-Oriented Configuration: Types or classes of: (A) Project tasks (“Task Groups”); (B) Team User responsibilities and corresponding Platform User permission set (“Permissions”) and execution regarding available widgets, available content, user interface (“UI”) form, viewing, editing, deleting records, and signing off on Project matters or status that triggers further Platform actions such as billing or Report generation and dissemination; (C) types of Budget line items and unit of measure; and (D) identifying/searchable handles or tags (“Tags”) for Project and Unit(s)/Space(s) are all defined here.

Configuration provisions in the Platform subsequently enable efficient instantiation or creation of specific Project Tasks, a particular Team User Permission set, or a specific Budget line item. Definitions created under the Configuration are general in nature and accessible Platform-wide.
3) Two Intermediate Layers Between Project and Tasks: To overcome the current organizational limitation of assigning tasks (“Tasks”) to a Project, the present invention has a widely applicable standardized framework that comprises two intermediate layers between “Projects” and “Tasks.” The first intermediate layer is a “Task Group,” which categorizes the Task into a functional bin (e.g., installation, commissioning, programming). Each “Task Group” is defined by one or more Tasks. The second intermediate layer comprises individual “Unit(s).” With this second intermediate layer, there can be different realizations for different embodiments. For example, an A/V or network system integrator Platform application embodiment of the present invention would have Spaces as the Units in this second intermediate layer. Spaces in the A/V Platform application embodiment of the present invention comprise one or more physical Units that can be, for example, various types of meeting rooms, public spaces, training rooms, and many other room types within corporate, government, or education where Tasks under specific Task Groups such as installation, modifying, upgrading, programming, and servicing can be fulfilled.

In short, each Project task or series of Tasks (i.e., task list) are binned under a Task Group and Unit where Tasks are to be fulfilled. This elegantly simple type of standardized framework allows easy extensibility of the Project scope implementable in a digital Platform designed for tracking, monitoring, and notification and is the result of heuristics developed before reducing the present invention to practice.

This easily scalable framework also allows Users to create and modify Unit and Task Group “Templates” that can be later imported directly into a Project or used as a basis to create “robust” Unit or Space variant definitions, where robust refers to being properly defined with no logical fallacies or omissions in the workflow.

For illustration and again using the audio/video (A/V) Platform application embodiment example, if a Project is to be carried out at a large site, with multiple identical Units (Spaces) that require the same Task Groups, then the Task Groups among the identical Units (Spaces) can be easily duplicated, through use of Units (Spaces) Templates, after the set of Task Groups of the first common Units (Spaces) is defined.

In addition to Unit Templates, Task Groups themselves can be templatized to best exploit the universalities across the range of possible Task Group operations. For the A/V Platform application embodiment of the present invention, there can be a Task Group called “Installation,” that is comprised of the following Tasks: cable pulls, report to lead technician, install display, install equipment behind the display, install transmitter(s), install display mount, install display mounted web conference application, verify man-hours, install touch-panel, and install/integrate mobile tablet device.

Defined Tasks and Units (Spaces) for a Project are searchable by the Task or Unit (Space) name. The search functions for Task and Unit (Space) are available in the preferred embodiment on both the Portal and Unit (Space) for the MA. Other embodiments of the Platform also have Task search functionality on the MA.
4) Easiest to Set Up MA with a Comprehensive Feature-Set: No special “Database” configuration knowledge is necessary to deploy all operational aspects of the MA, including its offline mode. MA Users are equipped with all necessary features to access any necessary support “Documents” (e.g., installation manuals, drawings, bill of materials), be productive, communicate, register certain information, trigger reporting events, and leave feedback (“Feedback”).
5) Vendor and Customer-Specific Plus Role-Specific Platform Implementations: The Platform is unique in that the Customer is not only recognized as an important component of the Project Team and fulfillment but also provided with individualized Platform-usage Permissions.
6) Two-Tier Menu and Curated Titles/Topics: Menus are ubiquitous widgets in digital device applications. However, for Project management, monitoring, and Reporting, the present invention possesses a carefully tuned, Vendor or Customer-specific, two-tier menu hierarchy that overcomes the clutter and ergonomic miscues of other offerings with specifically a useful set of titles within the Global Systems Menu and specifically chosen set of topics under the “Navigation Topics Submenu” that is based on the chosen Global Systems Menu title. The chosen set of titles and topics within the two-tier menu, which hitherto was not seen elsewhere and is not obvious from the other existing offerings, is critical to the Platform's intuitive and uncluttered presentation; this helps minimize the learning curve to master the usage of the Platform.
7) Job Board (JB) Resource Management Module: The present invention includes what is termed a “Job Board” (JB), which is a weekly resource manager that shows the amount of booked staffing resources and what resources are assigned to a particular Project for the given week. For large-scale operations, automating the Project status based on personnel availability is key to assessing resource commitment and optimizing resource management. Booking dates will automatically update the Budget Management Module to track the days available and the days used.
8) Milestones: The present invention includes a user-configurable milestones (“Milestones”) Module, which is tied into the JB and Reporting features as well as billing and invoicing (within the “Budget” module). The purpose of this feature is to trigger automated billing and Project Reporting to relevant parties. This feature highlights functional synergies between several seemingly standalone features to spawn new and useful Project management capabilities.
9) Budget: The present invention includes a user-configurable Budget Management Module that allows one to track any detail for each and every budget line item with respect to allocated man-days, man-hours, or any unit of measure defined by the User. Like many features, this is tied into many other modules such as the JB, Milestones, and Reporting.

The present invention is designed to be broadly versatile and application embodiments comprise building construction and services, A/V system integration, network system integration, security system installation, home improvement installation/integration, remote motor vehicle servicing (e.g., windshield replacement, detailing, emissions equipment retrofit, etc.), landscaping and gardening, furniture delivery and assembly services, building janitorial services, housekeeping, remote hardware or software servicing, and remote healthcare services.

### BRIEF DESCRIPTION OF THE DRAWINGS

The drawings are provided to facilitate understanding of the detailed description. It should be noted that the drawing figures may be in simplified form and should not be construed to limit the scope of the embodiment in any manner. Portions of certain figures are accompanied by icons depicting actions, processes, process states, individuals representing certain Role-based Permission sets defined herein, and items. These icons are meant to efficiently convey information in an impactful and potentially more universal manner. Any ambiguity in an icon's meaning is clarified by content provided in the DETAILED DESCRIPTION OF THE DISCLOSURE and not be construed to limit the scope of the embodiment in any manner.

FIG. 1 is a process flowchart and block diagram listing for the steps from Project inception to completion whose monitoring, management, and Reporting across the Enterprise are facilitated by a curated set of features and methods of the presented Platform.

FIG. 2 is a block diagram listing of key top-level modules/features/elements of the web browser (Portal) implementation within the Platform.

FIG. 3 is a block diagram listing of key top-level modules/features/elements of the Mobile Application (MA) implementation within the Platform.

FIG. 4 is a block diagram listing of the Role-based Platform Permission sets of two Platform Users types in the Enterprise: Administrator and Super Administrator (“SuperAdmin”).

FIG. 5 is a block diagram listing of the Role-based Platform Permission set of a Platform User type in the Enterprise: Lead Tech(nician).

FIG. 6 is a block diagram listing of the Role-based Platform Permission set of a Platform User type in the Enterprise: Tech(nician).

FIG. 7 is a block diagram listing of the Role-based Platform Permission set of a certain Platform User type in the Enterprise: Project Manager (PM).

FIG. 8A is a process flowchart and block diagram listing for the steps to create/define/edit/search/sort/view elements of a Customer (company) record or account on the Platform's Database through the Portal.

FIG. 8B is a block diagram listing of the widgets and fields used to create/define/edit/search/sort/view the in the Customer Account Dashboard as seen from the Portal under the Customer Global Systems Menu option.

FIG. 9A is a process flowchart and block diagram listing for the steps to create/define/edit/search/sort/view elements of the Project record on the Platform's Database through the Portal.

FIG. 9B is a block diagram listing of the Navigation Topics Submenu under the Project Global Systems Menu accessible from the Portal.

FIG. 9C is a block diagram listing of deeper level submenu topics within the Milestones Navigation Topics Submenu under the Projects Global Systems Menu accessible from the Portal.

FIG. 10 is a block diagram listing of the widgets and fields used to create/define/edit/search/sort/view the Project Unit (Space) records on the Platform's Database through the Portal.

FIG. 11 is a process flowchart and block diagram listing of the widgets and fields used to create/import/define/edit/view a Project Task record on the Platform's Database through the Portal.

FIG. 12 is a hierarchical block diagram generally defining a Task within the organizational structure of the Platform.

FIG. 13 is a process flowchart and block diagram listing of the widgets and fields used to create/import/define/edit/view Task and Unit (Space) Templates on the Platform's Database through the Portal.

FIG. 14A is a listing of the Project Report types and Report content that is created/edited/viewed/distributed/downloaded.

FIG. 14B shows an embodiment of a Daily Project Report that can be automatically disseminated to target recipients and how the Daily Project Report distribution is executed and archived.

FIG. 14C is a process flowchart illustrating the conditions for allowing distribution of the Daily Project Report, how the Daily Project Report is populated with content, and how the Daily Project Report distribution is executed and archived.

FIG. 14D shows an embodiment of the top-most fragment of a Current Project Snapshot Report that shows pre-chosen or User-defined Project status information.

FIG. 14E shows an embodiment of the middle fragment of a Current Project Snapshot Report that shows pre-chosen or User-defined Project status information.

FIG. 14F shows an embodiment of the bottom-most fragment of a Current Project Snapshot Report that shows pre-chosen or User-defined Project status information.

FIG. 14G is a process flowchart illustrating how the Current Project Snapshot Report is populated with content, and how the Current Project Snapshot Report distribution is executed.

FIG. 14H shows an embodiment of a Project Completion Report that can be automatically disseminated after a Project is declared completed, to target recipients with pre-chosen or User-defined Project information.

FIG. 14I is an example of the Final Comments dialog on the Portal where the Vendor-side User can leave any final remarks and have them placed in a designated area on the Project Completion Report before it is distributed and archived.

FIG. 14J is a process flowchart illustrating the conditions for allowing distribution of the Project (“P.”) Completion Report, how the Project Completion Report is populated with content, and how the Project Completion Report distribution is executed and archived.

FIG. 15 shows the Navigation Topics Submenu of the “Configuration” Global Systems Menu for object-based customization.

FIG. 16 is a listing of the widgets and fields of a Customer embodiment of the Portal.

FIG. 17 shows a UI embodiment of the Project Dashboard on the Mobile Application (MA), as seen by Team member(s) on the Vendor-side (e.g., Technician).

FIG. 18 shows a UI embodiment of a Customer's (company's) profile page on the MA, as seen by Team member(s) on the Vendor-side.

FIG. 19 shows a UI embodiment of the profile page indicating each Vendor-side User assigned to a given Project as seen on the MA by Team member(s) on the Vendor-side.

FIG. 20 shows a UI embodiment of the profile page indicating each Customer-side User assigned to a given Project as seen on the MA by Team member(s) on the Vendor-side.

FIG. 21 shows a UI embodiment of a card view of the status of each Project Unit (Space) on the MA, as seen by Team member(s) on the Vendor-side.

FIG. 22A shows a UI embodiment of a list view on the MA of all Project Units (Spaces) whose “Installation” Tasks are completed, as seen by Team member(s) on the Vendor-side.

FIG. 22B shows a UI embodiment of a card view on the MA of all Project Units (Spaces) whose “Installation” Tasks are completed, as seen by Team member(s) on the Vendor-side.

FIG. 23A shows a UI embodiment of displayed background information on the MA of a single installation Task order with a required picture upload widget, as seen by Team member(s) on the Vendor-side.

FIG. 23B shows a UI embodiment on the MA of the same single installation Task order page as shown in FIG. 23A except with the pull-down menu of Task status choices, as seen by Team member(s) on the Vendor-side.

FIG. 23C shows a UI embodiment on the MA, a single installation Task order page with a thumbnail image of the corresponding image file uploaded from a mobile device to the Platform, as seen by Team member(s) on the Vendor-side.

FIG. 23D: shows a UI embodiment on the MA, a single installation Task order page with a dialog asking the User permission for the app to access photos, media, and files on the local mobile device, as seen by Team member(s) on the Vendor-side.

FIG. 24 shows a UI embodiment on the MA, the registration page for a specific piece of equipment, as seen by Team member(s) on the Vendor-side.

FIG. 25 shows a UI embodiment on the MA, the Task viewing filter based on whether at least one installation proof image is required to be uploaded or not as part of its Task fulfillment, as seen by Team member(s) on the Vendor-side.

FIG. 26A shows a UI embodiment on the MA, the uploaded Documents page showing categorized folders of Documents, as seen by Team member(s) on the Vendor-side.

FIG. 26B shows a UI embodiment on the MA, the uploaded Documents page, and widgets allowing the User to browse files within a folder for upload or save the files to the Platform's Database, as seen by Team member(s) on the Vendor-side.

FIG. 26C shows a UI embodiment on the MA, a list of Documents within a certain category that can be downloaded onto the device hosting the MA page, as seen by Team member(s) on the Vendor-side.

FIG. 27A shows a UI embodiment on the MA, the Project Feedback survey homepage.

FIG. 27B shows a UI embodiment on the MA, the internal, Vendor-side Project Feedback survey.

FIG. 27C shows a UI embodiment on the MA, the Customer's Project Feedback survey.

FIG. 28 shows a UI embodiment on the MA, the “Sync & Download” page, as seen by Team member(s) on the Vendor-side.

FIG. 29 shows a UI embodiment on the MA, a card view of the Project file, and an information set that can be marked for download onto the mobile device, as seen by Team member(s) on the Vendor-side.

FIG. 30 shows a UI embodiment on the MA, a list and Project completion status percentage view of the Project file, and an information set that can be marked for download onto the mobile device, as seen by Team member(s) on the Vendor-side.

FIG. 31 shows a UI embodiment on the MA, the “Sync & Download” page on FIG. 28 plus an indication of a downloaded set of Project files, as seen by Team member(s) on the Vendor-side.

FIG. 32 shows a UI embodiment on the MA, the “Notifications” page showing the feed of short messages for eligible Vendor-side Team Users to see and read.

FIG. 33 shows a UI embodiment of the Job Board (JB) on the Portal.

### DETAILED DESCRIPTION OF THE DISCLOSURE

The underlying capability described herein relies on foundational elements described in Sections #1- #9 below.
1) Client-side Device Hardware/Software: The client-side device includes hardware and operating system software to allow Users to interact with the Platform application software (Portal or MA) over a communications network. The operating system may be or include a variety of operating systems such as the Android®, Macintosh® OS or iOS, Microsoft Windows®, Unix, Linux, Xenix, IBM AIX™, Hewlett Packard UX™, Novell Netware™, the Sun Microsystems 35 Solaris™, OS/2™, BeOS™, Apache™, OpenStep™, or another operating system or platform.

Exemplary devices can be a desktop personal computer (PC), laptop/notebook personal computer, portable mobile device (tablet, smartphone), or any hardware apparatus that includes a processor or plurality of processors, system memory (i.e., RAM/ROM/cache), large permanent (i.e., non-volatile) local data storage where an operating system, hardware drivers, applications, and applications are stored, optional removable flash memory (e.g., regular/mini/micro-SD cards, thumb drives), optional disk drives, remote cloud storage directly linked to the device, built-in or connected external I/O devices (e.g., buttons, monitor, capacitive touchscreen, trackpad, speaker, jack(s)/port(s) to connect to external devices), network adaptor(s), hardware drivers to control external devices like speaker(s), display(s), monitor(s), camera(s), and a bus that couples various system components including the system memory to the processor(s). For embodiments requiring wireless connectivity, the device also has radio hardware, circuitry, and drivers to enable such communications.

At a minimum, the memory includes at least one set of instructions that is either permanently or temporarily stored. The processor executes the instructions that are stored in order to process data. The set of instructions may include various instructions that perform a particular task or multiple tasks. Such a set of instructions for performing a particular task may be characterized as a program, software program, software, engine, module, component, mechanism, or tool. The computer may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary-coded machine instructions specific to a particular computer.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is recognized that each of the processors and/or memory may be composed of different physical pieces of equipment.

The client application software employs a graphical user interface (GUI) or simply user interface (UI) that drives User interaction with the client-side device through several input/output (I/O) elements including but not limited to: display including those that respond to touch (on a touchscreen), mouse, trackpad, keyboard (virtual or mechanical), and built-in and/or plugged-in audio output devices. Installed software on a client-side device including the kernel or operating system, hardware drivers, and applications including the Platform application itself. For the Portal variant of the Platform, a web browser is used in lieu of a downloadable application that is used on an MA embodiment of the Platform. Either Platform application variant (Portal or MA) provides a network interface to access or send content over the network or request services from the Platform's server and can be implemented under a subscription-based Software-as-a-Service (SaaS) licensing model.

Any suitable programming language may be used in accordance with the various embodiments of the invention. Illustratively, the programming language used may include assembly language, Ada®, APL, Basic, C, C++, COBOL, dBase, Forth, FORTRAN, HTML5, Java®, Kotlin™, Modula-2, Pascal, Prolog®, Python®, REXX, Swift, and/or JavaScript®, for example. Further, it is not necessary that a single type of instruction or programming language be utilized in conjunction with the operation of the system and method of the invention. Rather, any number of different programming languages may be utilized as necessary or desirable.

In addition, the instructions and/or data used in the practice of the invention may utilize any compression or encryption technique or algorithm, as may be desired. An encryption module might be used to encrypt data. Further, files or other data may be decrypted using a
suitable decryption module.

2) Server-side Hardware/Software and Database: The server-side hardware/software may be described in the general context of computer system-executable instructions, such as program modules, being executed by a computer system. Generally, program modules may include routines, programs, objects, components, logic, data structures, and so on that perform tasks or implement abstract data types. The server functions may be practiced in distributed cloud computing environments where tasks are performed by remote processing devices that are linked through a communications network. In a distributed cloud computing environment, program modules may be in both local and remote computer system storage media including memory storage devices. The server hardware may comprise at least one processor core or processing unit, a system memory (i.e., RAM/ROM/cache), storage, and a bus that couples various system components including the system memory to the processor(s).

To respond to client requests for Platform data or requests to store data, the server may query its Database to retrieve or store various data, such as a User's profile, Document or multi-media content, and other Platform content that will be described in the following sections. The Database may be a relational Database responsive to Structured Query Language (“SQL”) commands. The behavior adapter server may execute a hypertext preprocessor (“PHP”) script including SQL commands to query the Database for various data.
3) Internet and Data Network: The internet and data network, in one embodiment, may be implemented as a single network or a combination of multiple networks. Various networks may be implemented in accordance with embodiments of the invention, including a wired or wireless local area network (LAN) and a wide area network (WAN), a wireless personal area network (PAN), and other types of networks. When used in a LAN networking environment, computers/devices may be connected to the LAN through a network interface or adapter. When used in a WAN networking environment, devices typically include a modem or other communication mechanism. In another example, the network may comprise a wireless telecommunications network (e.g., cellular phone network) adapted to communicate with other communication networks, such as the internet.

Hence, embodiments of the present invention include the ability for the devices and Platform to send and access data locally (e.g., Local Area Network, LAN) as well as send/receive signals to peripheral devices using a wired or wireless connection. An intermediary router can be used to connect local system devices as well as to a modem (not shown) for internet access. Said router can be combined with a modem for internet access. Alternatively, the devices may directly access the internet with an appropriate built-in radio, circuitry, and supporting wireless telecommunications network.

Some suitable communications protocols may include TCP/IP, UDP, or OSI, for example. For wireless communications, communications protocols may include Bluetooth®, Zigbee®, IrDa, Wi-Fi®, 2G, 3G, Ultra-Wideband, and Long-Term Evolution (LTE) or other suitable protocols. The wireless communications protocol may also include short-range communications devices and protocols, such as RFID, or Near-Field Communication radio transmissions. Furthermore, components of the system may communicate through a combination of wired or wireless paths.

Access to the internet enables a variety of Application (102) functions including Over-the-Air (OTA) software updates, features, content such as new/revised Prompts, remote storage of photos and video, SaaS services, social media management, customer account management, and more. Some of these features will be discussed later.

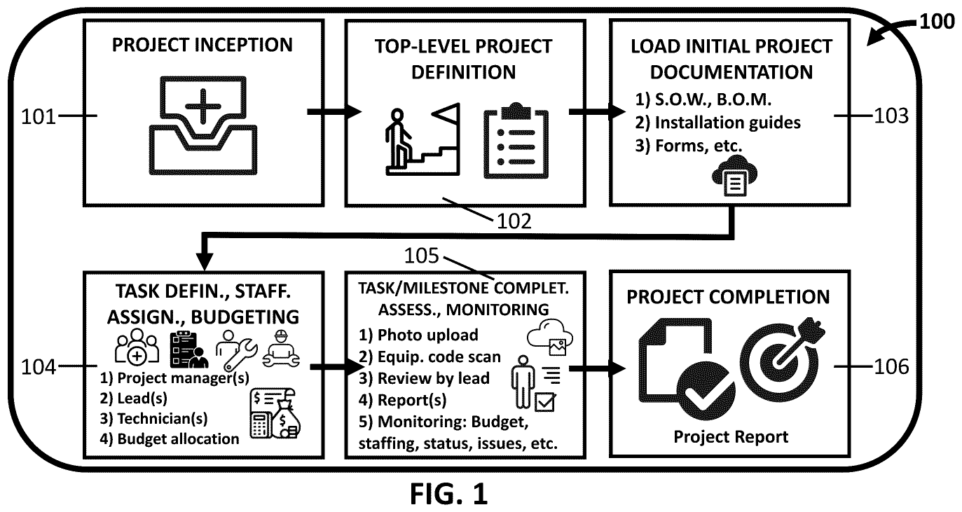

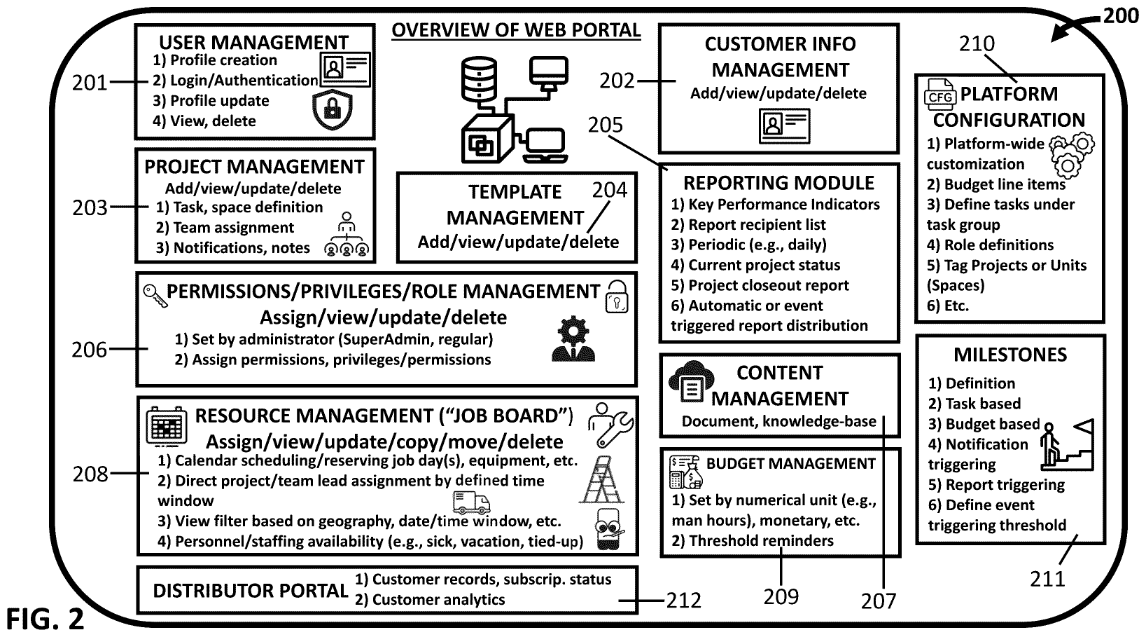

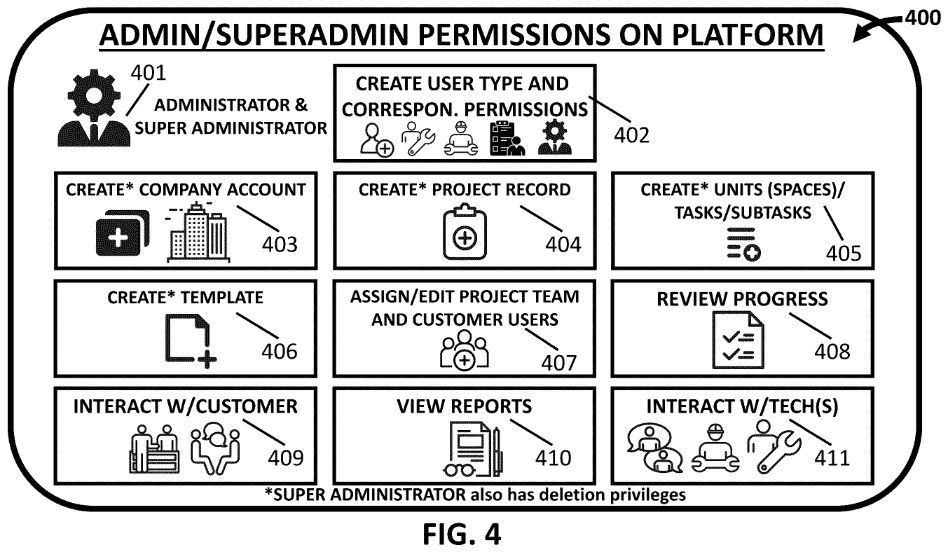

Although many other internal components of the computer are not shown, those of ordinary skill in the art will appreciate that such components and the interconnections are well known. Accordingly, additional details concerning the internal construction of the computer need not be disclosed in connection with the present invention.
4) User Interface (UI): On the client-side, functional requests to the client application and server are made with the guidance of a GUI or UI as displayed on the client side's device display. The UI comprises virtual windows and panels (fixed or dock-able), menus, text fields, radio buttons, checkboxes, buttons, and many other “widgets” that guide the User (i.e., aim a cursor or pointer) on interacting with the client-side I/O hardware to execute the desired actions such as type, select, save, edit, view, play multi-media, and more actions. The UI also includes physical controls on the device.
5) Communications Modules: This Platform can have communication module embodiments with embedded or third-party plug-in provisions for communicating. One embodiment includes an instant messaging (a.k.a. SMS) service. Other embodiments can have features like group chats, secure end-to-end encrypted chat mode, means to text emojis/emoticons, record and transmit voice notes, autocomplete text, autocorrect text, send attachments, archiving, microphone on/off switching, and access Platform server or device stored contacts. Another embodiment of a communication module includes live video conferencing that can include group video conferencing functionality, archiving, supplementary text messaging, camera on/off switching, microphone on/off switching, and the ability to access Platform or device stored contacts. The communications applications transmit or receive signals from the client devices' microphone(s), speaker(s), camera(s), or externally connected devices.
6) Content Import/Export Module: In addition to adding information to the Platform server's storage with the client device's I/O hardware (e.g., typing in a physical or virtual keyboard), the Platform's server, at the eligible User's request, can also import content via upload from the client's device or the client's device can also request to download content from the Platform's Database within the project-linked repository. At the eligible User's request, files can be deleted and expunged from the server's Database. Other management embodiments include a means to organize the content in folders, which can be created, named, renamed, and deleted by eligible Users.
7) Document and Multi-media Repository: Embodiments of the Platform include server Database provisions to upload, compress store, and retrieve multi-media data that comprise pictures, videos, spreadsheets, drawings, word processor files, and portable document files (PDFs).
8) User Authentication: The Platform has embodiment means to authenticate the User, beginning with a password or personal identification number (PIN) and embodiments can be expanded to include two-factor authentication where a code is generated by the Platform's server or third-party service, sent to the User generally through the internet, where the User would enter the temporarily generated code to the client-side device on hand within a brief allotted time that if correct, allows the use of the Platform. Other authentication embodiments can include biometric means such as fingerprint or facial recognition.
9) Subscription-based Platform/Feature Activation: Embodiments of the Platform can include multiple tiered account types based on a Software-as-a-Service (SaaS) licensing model. Licensing embodiments can include various levels of subscription fees (e.g., free, fee, higher fee, etc.) that delineate what services the Platform offers to the Customer User.
10) General Steps of a Project (Ref. FIGS. 1-3, 5, 14B, and 14H): Most projects involving multiple organizations follow a universal series of common steps (101-106), which the Platform is designed to greatly facilitate. First, there is the birth of a Project (101) after a contractual agreement of the Project Enterprise has been formed between the Vendor and Customer. Afterward, comes the planning stage, where first, the top-level or overall steps to execute and fulfill the Project are defined (102). For many usage embodiments (e.g., construction, A/V and security system integration), before the remote site work can be carried out, initial project Documentation needs to be loaded onto the Platform's cloud Database, which includes the Statement of Work (S.O.W.), Bill of Materials (B.O.M.), installation guides, drawings, Project or Project Milestone Signoff Forms, and more. The next step collectively involves some reduction of the plan to actionable Tasks and Subtasks that are binned into Task Groups and assigned to Units (Spaces) at the Project site as well as assignment of the actual Vendor and Customer-side Team Users (104). More specific details of this process will be discussed later in the present disclosure. After Team members are assigned (104) on the Portal (200), the actual execution of the tasks in the Units (Spaces) are carried out by the Team (105) and for A/V and security system application embodiments, the MA (300) is the only means where tasks comprising of equipment registration, multi-media documentation, review by a qualifying Team User such as a Lead Tech (501), and approving the send-out of Daily (progress) Reports (1410) to target Customer Team Users get accomplished. After the Project has been declared complete, the Portal automatically queries all required information to generate a comprehensive Project Completion Report (1430) detailing what has been accomplished and what equipment has been implemented before sending it out to Users on the recipient list (106).
11) Portal Implementation (Ref. FIGS. 2 and 4): One of the implementation embodiments of the Platform's software application is web browser-based and is therefore compatible with any type of hardware and operating system (OS) hosting the application as long as the web browser is compatible with the application's source code/script. Because of this approach, the application can be updated on the server end without the need for Users to download a new installation executable. As previously mentioned, the web browser implementation of the Platform is referred to as “Portal” (200).

Eligible Platform Users can create User accounts and define each User's profile that comprises basic identifying information, Role, which in turn defines the default Platform usage Permissions and execution regarding available widgets, available content, UI form, viewing, editing, deleting records, and signing off on Project matters or status that triggers further Platform actions such as billing or Report generation and dissemination, and affiliation (201). Embodiments can include provisions (201) for logging into and authentication as previously discussed and profile update or deletion. A preferred embodiment of the Platform can allow eligible Platform Users to create and manage the Customer (company) accounts and records (202). A preferred embodiment of the Platform enables Project records to be created and managed on the Portal (203), including Task and Unit (Space) definitions, personnel and Team User assignment to the Project, and notification (“Notification”) creation and send-out. To facilitate robust definitions of Task Groups and Unit definitions, preferred embodiments of the Portal have the capability to templatize such definitions that can be leveraged to create variant definitions (204). An essential embodiment of the Portal (200) has a Reporting Module (205) that can search for Project-specific information fragments stored on the Platform's Database, generate, distribute to eligible Customer Team recipients, and archive various types of reports that greatly augment the ability for certain Team Users across an Enterprise to monitor and manage the Project as intended. Embodiments of the Platform allow Administrators (401) to establish appropriate Permissions (206) according to a Team member's specific Role(s) in a Project so that the Project can be executed in a secure and orderly fashion. Embodiments of the Portal (200) allow important Documents or training content (e.g., instructive videos for Team members in the field to access) to be uploaded and managed (207) by eligible Team Users. Embodiments of the Portal (200) can include a resource management provision (a.k.a. Job Board), to allow eligible Users to schedule and review allocated resources (208), be it equipment and/or personnel of a given project to certain time slots. Embodiments of the Portal (200) can include a Budget Manager (209) that allows Team Users to track resource utilization (money, consumable materials such as zip ties) as well as create customizable Notifications/alerts when certain thresholds are crossed. Embodiments of the Platform can be configurable from the Portal through the Configuration feature (210) to tailor aspects of other features such as budget line item types, Tasks, etc. The level of Project completion or expenditures can be broken up into intermediate milestones (“Milestones”) and embodiments of the Platform allow Milestones (211) to be defined and report distribution or Notifications to be based on Milestone fulfillment. The Platform may be sold through a sales or distributor and the Platform has provisions (211) or distributors to track the Platform's customers' background information relevant for license/purchase records, license subscription status, subscription level, etc. Embodiments of the Portal are such that the set of available and visible controls and level of privileges depend on whether the User is on the Vendor-side, Customer-side, or distributor and what type of User within each of those three main types. Details of some of these Portal features or provisions will be described later in the present disclosure.
12) MA Implementation (Ref. FIGS. 2, 3, 5, 17, 23D, 24, 27A-C, 28, and 31): When Project Task fulfillment involves remote site work at a Customer's site, a preferred embodiment of the present invention includes a MA (300), including an application embodiment that is downloadable from an application repository and installable on the Team User's mobile device, such as a mobile phone or tablet. For application usage embodiments that require pictures and/or videos to be taken or bar codes, QR codes, or serial numbers to be easily registered, then the mobile client-side device should have a built-in camera(s). Following conventional best practices of MA design, preferred embodiments have the MA (300) not include all widgets or functionality of the Portal (200), but instead, be optimized for focused engagement on a mobile device with the Platform related to key tasks done by personnel Users at the Customer Project site.

More specifically, embodiments of the MA (300) can restrict Platform profile management restricted to one eligible User per allowed log-in (301). Embodiments of Project management functionality (302) can include the ability for Users to convey the status of the Project he or she is working on by a variety of means comprising: declaring the status on a certain task comprised of one of the following indicators: “Completed,” “In-progress,” “Open,” “On-hold,” or “Canceled.” The MA also includes provisions for Users to add important comments (“Comments”) (302, 303, 307) such as Task fulfillment pitfalls that others can avoid, unforeseen difficulties, suggestions for the future, and more. Embodiments of the present MA (300) can present a set of Tasks organized by function Groups such as installation, commissioning, reporting, programming, calibration, and more (302). Access to the Budget Management Module (302) provides the MA (300) Users the ability to update & track the budget line items, which will be described later in the present disclosure. Embodiments of the present MA (300) can allow provisions for Action Items that have cropped up during Project fulfillment (304) and include provisions for status declaration, Commentary, and means to assign the Action Items to eligible Users on either the Vendor or Customer side of the Project. An embodiment can allow assignment permissions to be restricted to qualified Team members, such as a Lead Tech (501).

Embodiments of the present MA (300) can include a Project Dashboard (304, 1700) showing the status of the Tasks to be fulfilled, the assigned Team members, and a global search bar. Embodiments can additionally include an Offline Mode (305, 3100) in case of unavailability of internet service due to various reasons including security. This capability allows Project Tasks to be fulfilled independent of whether the mobile device is connecting to the Platform server. Before and after Offline Mode is invoked, certain Documents and recorded interactions between the Team Users and the MA (300) can be synchronized (2804) with the Platform Database where and when a data network is available. The MA's (300) offline mode allows for reading and creating, updating, or deleting project and/or customer records from the database associated with the Platform.

Many types of Project management endeavors would benefit from some form of equipment registration or proof of fulfillment by way of picture or video upload (306, 2308, 2400). An embodiment of the present invention has provisions (2400) for such and in some instances make direct use of the mobile device's optical hardware and other input (e.g., virtual keyboard to enter MAC addresses) provisions. Each picture or video content piece when uploaded will automatically be linked by the Platform to a certain Task within a certain Task Group of a certain Unit (Space) for a given Project. Other tags such as a specific type of Team member (e.g., technician) can also be attached for future traceability. As mentioned, Documents such as Signoff Forms or manuals, for example, can be uploaded or downloaded, respectively when a data network is available to the mobile device.

The preferred embodiment of the MA (300) includes provisions for user MA Feedback (307, 2700). There are MA Feedback forms for the Vendor (2710) and Customer (2720). Embodiments of the MA (300) are such that the set of available and visible controls and level of privileges also depends on what type of User within each of those three main types (e.g., Lead Tech, PM, Tech, Engineer, etc.). Further details of these and other aspects of the MA (300) with reference to GUI screenshots of one embodiment of the present invention will be provided later in this disclosure.
13) Two-Tier Menu and Curated Titles/Topics (Ref. FIGS. 2, 3, and 32): A viable menu embodiment on the Vendor-side of the Portal (200) includes a horizontally arranged “Global Systems Menu” titles bar comprising the titles from left to right: Home, Customers, Projects, Users, Template, Configuration, Reporting, Knowledge Base, and Resource Management. Selecting one of the submenu titles provides a unique list of Navigation Topics visibly arranged on the UI in contrast to the Global Systems Menu title bar (e.g., vertical Navigation Topics Submenu). A subset of the pages defined by the combination of Global Systems Menu choice and Navigation Topics Submenu choice comprises additional choices that further modify the content of the page.

An embodiment of the Navigation Topics Submenu under the Home Global Systems Menu comprises:
Total Projects
Completed Projects
Customer vs. Projects
Projects vs. Resources
Open Actions Items
Overdue Action Items
Projects by User
Project Report Readiness

An embodiment of the Navigation Topics Submenu under the Customers Systems Menu comprises:
Customer
User

An embodiment of the Navigation Topics Submenu under the Projects Systems Menu comprises:
Projects
Drafts
Completed
Dashboard
Units (Spaces)
Tasks
Team
Documents
Daily Reports
Action Items
Comments
Gallery
Budget
Internal Notes
Feedback

An embodiment of the Navigation Topics Submenu under the Template Global Systems Menu comprises:
Unit (Space)
Task Groups

An embodiment of the Navigation Topics Submenu under the Configuration Global Systems Menu option comprises:
Permissions
Budget
Tags

An embodiment of the Navigation Topics Submenu under the Reporting Global Systems Menu option comprises:
Timeline (On Time*)
Timeline (Delayed*)
Action Items (Completed*)
Action Items (Open*)
Action Items (Overdue*)
Sync
Feedback
Project Leads
Open Action
Completed
Budget
Comments

An embodiment of the Navigation Topics Submenu under the Job Board Global Systems Menu comprises:
Display Job Board by date range filter (can be combined with other filters)
Display Job Board by location filter (can be combined with other filters)

The combined choices and arrangement of the Global Systems Menu and Navigation Topics Submenu is the tuned result of experience by the inventor of the preferred embodiment that enables an intuitive and clutter-free UI with a similar look and feel regardless of menu choice, which in turn allows Users to quickly master the usage of the Platform.

An embodiment of the MA (300) puts a reduced Global Systems Menu Titles bar along the bottom of the application page and a fixed Navigation Topics Submenu along the top of the application page, both arranged horizontally. This will be discussed later with reference to GUI screenshots in one embodiment of the present invention later in this disclosure.

The Global Systems Menu Titles of the MA (300) comprise the following:
Projects
Sync & Download
Notifications
Profile

The Navigation Topics Submenu of the MA (300) under the Projects Global Systems Menu of the MA (300) comprises the following:
Dashboard
Units (Spaces)
Documents
Actions Items
Comments
Feedback
Project Notes
Team Members
Project Description

Like the Portal (200), these carefully chosen and arranged MA (300) Global Systems Menu Titles and Navigation Topics Submenu lend to the most compact form that supports the versatility and specificity needed in a broad range of application embodiments. Further details of each Global Systems Menu Title and Navigation Topic Submenu will be provided below.

Other information records stored on the Platform's Database, that in the preferred embodiments of the Portal (200) and MA (300) implementations, have always-visible widgets, are those associated with the Profile and Notifications functions. In the preferred embodiment of the Portal (200) or MA (300), a “My Profile” or “Profile” widget (201 and 301) opens a panel comprises of the logged in User's name, contact information like address, telephone number, and Email address, brief biographic background, and a toggle checkbox for receiving Daily Reports (1410) or not and can have additional settings to control the User's experience or security credentials (e.g., log-in password) with the Portal (200), and “Update” button to confirm the state of inputs be recorded in the Platform's Database, and a “Cancel” button to disregard any changes made after spawning the My Profile dialog.

For the preferred Portal (200) and MA (300) embodiments of the Platform, Notifications and/or internal notes (“Internal Notes”) (203 and 3201) are short messages with an indication of the date and time stamps as well as the Team User writer of the message. The Notifications feature updates eligible Project participants with important information not shown elsewhere on the Platform. Embodiments of the Platform can have the series of individual messages arranged in a number of ways, such as on pages or on a scrollable window organized by date and, within a date, a time step in each partition containing the message (3201), which can be text or voice. A preferred embodiment can have newer messages get appended to the bottom of the message feed, and therefore form a continuous ribbon or ticker of information. Widget embodiments of a Notification widget can be a bell-shaped icon button or a plain “Notification” label on a button.
14) Platform Users: Platform Users are those with a vested and active interest in the Project. To maintain an orderly and secure operation, the User's engagement with the Platform preferably depends on their functional job Role within the Enterprise and whether one is affiliated with the Vendor or Customer. That in turn will define the hierarchy of privileges and Permissions of the individual Platform User: what the individual User can see, create, edit, delete, sign off on, etc. For illustration purposes, the following presents examples of Platform users in an application embodiment that caters to audio/video (A/V) and security system integrators, the Users have Role-based Permissions as follows:

A) Administrator and Super Administrator (Ref. FIG. 4): The Administrator(s) (401) of the Platform are responsible for all aspects of managing the Platform's design and content as performing necessary server-side hardware and software maintenance to keep the Platform fully operational and secure. Administrators (401) can be appointed by higher authorities in the Enterprise. Certain Platform embodiments can further delineate privileges and permissions among Administrators can be done if necessary; for example, a regular Administrator may not have all the privileges and permissions of a “Super Administrator (SuperAdmin).” Certain embodiments give the Administrator (401) direct access to the Platform and all or a subset of all User accounts from that point onward within the restrictions of privacy laws. Administrator(s) (401) through its terms of service, reserve the right to suspend or delete accounts.

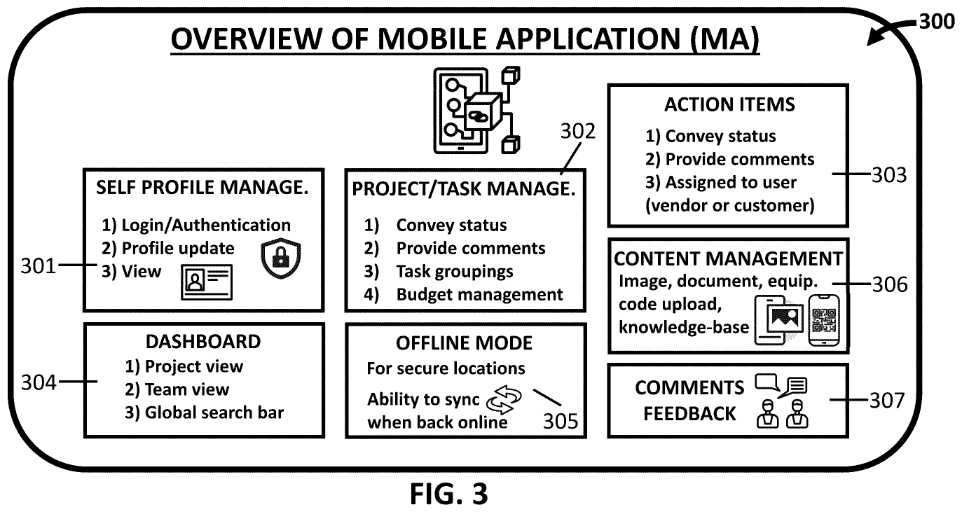

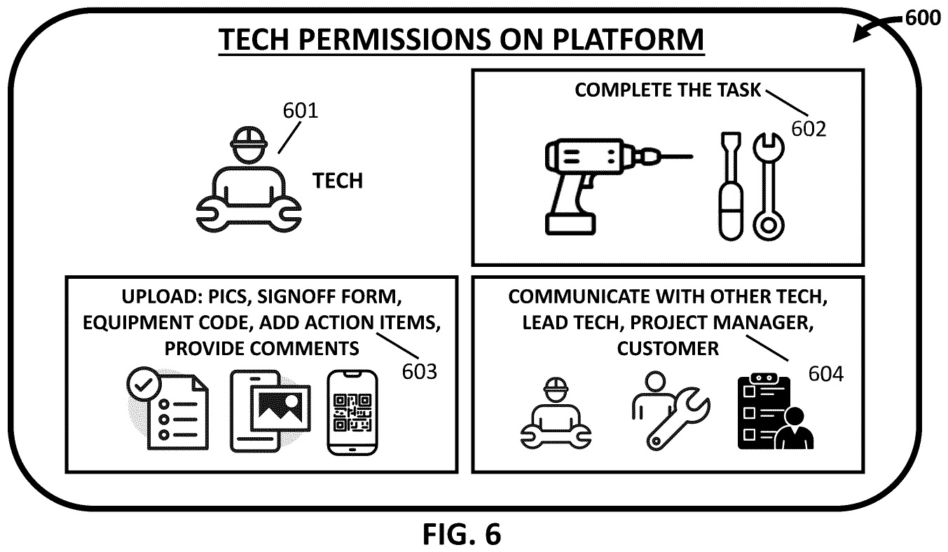

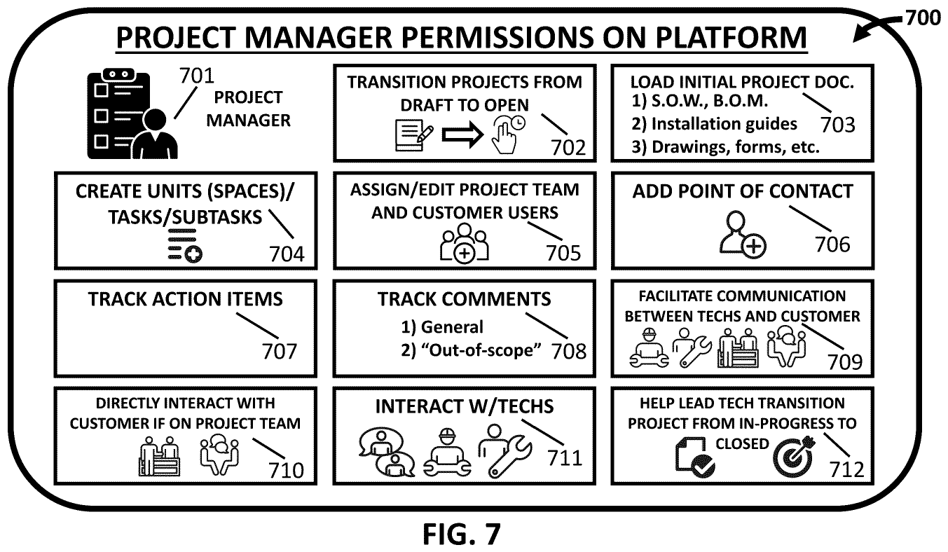

For Platform embodiments catering to audio/video (A/V) and security system integrators, especially those with a lean staff, the following Platform engagement profile was found to be effective for Administrator (401) User types; on the creation front, Administrators (401) can create other User-type accounts and corresponding permissions (402), a company (or Customer) account (403), a Project record (404), Project fulfillment definitions for Units (Spaces)/Tasks/Subtasks (405), Unit (Space) and Task Templates (406), assign/edit Users of the Project Team on the Vendor and Customer side (407), review Project progress (408), interact with the Customer (409), view Reports (410), and interact with Technicians, Engineers, and other staff at the remote work site (411). SuperAdmin Users can additionally have the Platform privilege to delete company (Customer) accounts (403), Project records (404), Project fulfillment definitions for Units (Spaces)/tasks/subtasks (405), and Unit (Space) and Task Templates (406). Other Platforms embodiments can vary the level of involvement of the Administrator with Project operations and have a Role and associated Permissions that is more compartmentalized to just the supporting information technology (IT) like services for the Platform.
B) Lead Tech(nician) (Ref. FIGS. 3, 5, 6, 7, 14B, 14C, 23C, 23D, 24, and 25): A Lead Tech (501) is a User-type on the Platform that works remotely on-site in different Units (Spaces) possesses certain permissions and privileges over a regular Tech (601). A Lead Tech (501) is responsible for reviewing Tasks (502) that have been binned into Task Groups and assigned to Units (Spaces), as indicated on the Vendor-side of the MA (300). Furthermore, the Lead Tech (501) delegates the Task Groups and tasks to other personnel such as a regular Tech (601), which can be noted in the MA (300).

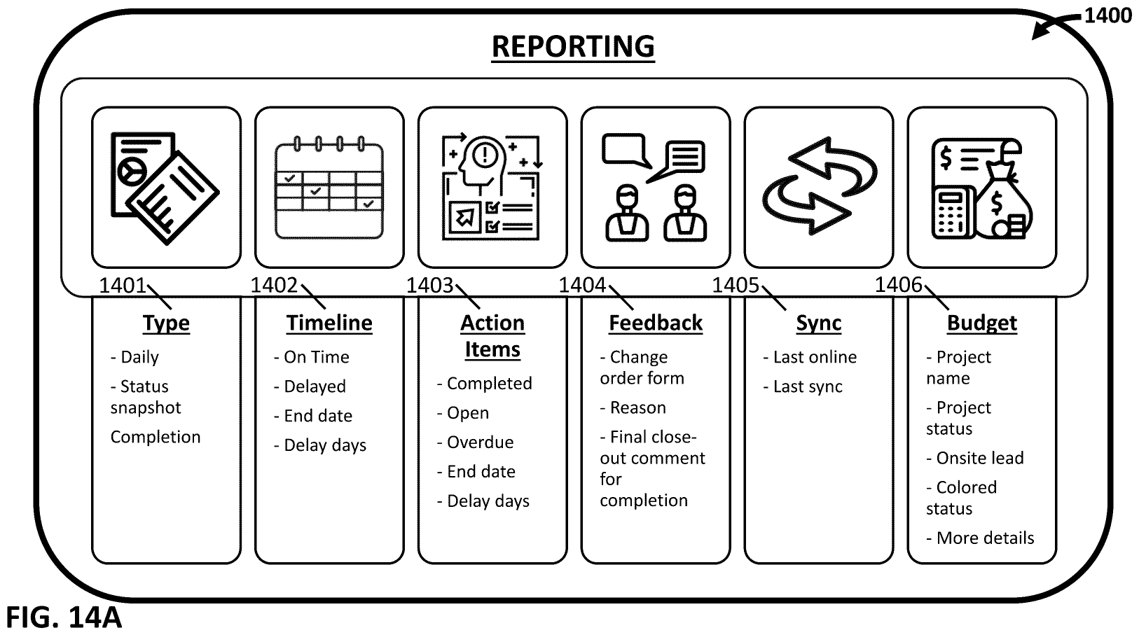

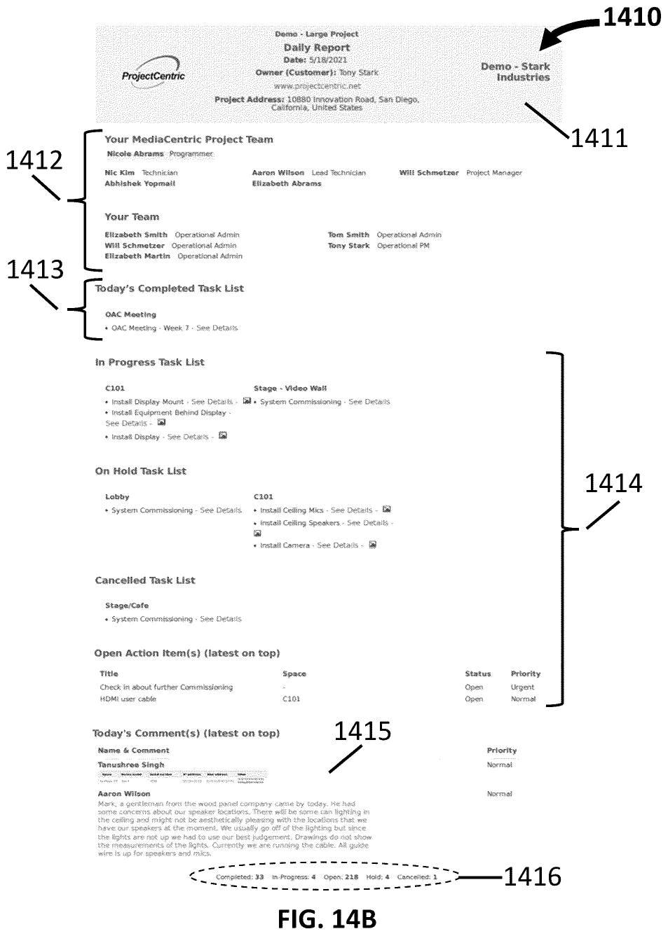

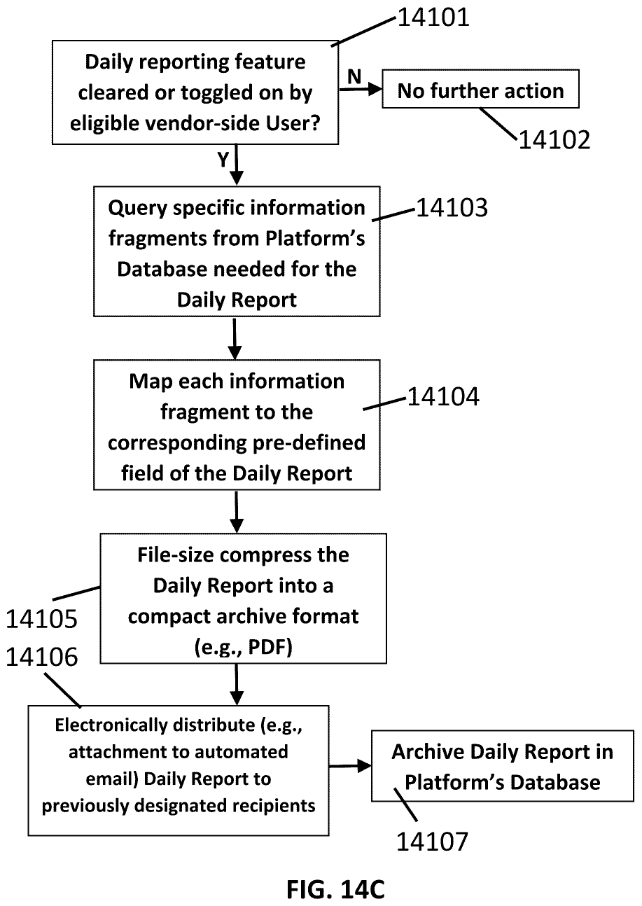

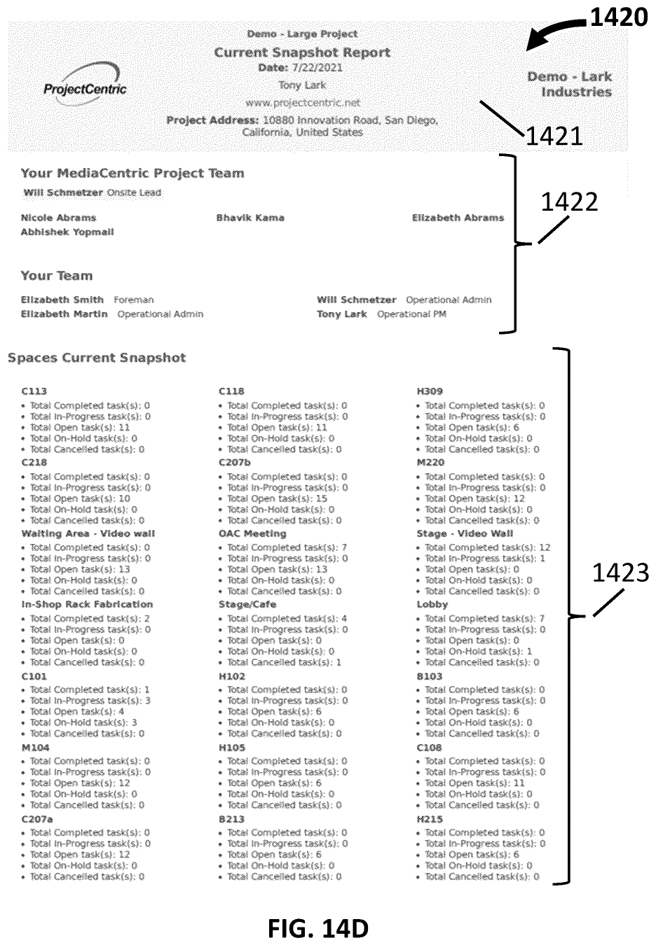

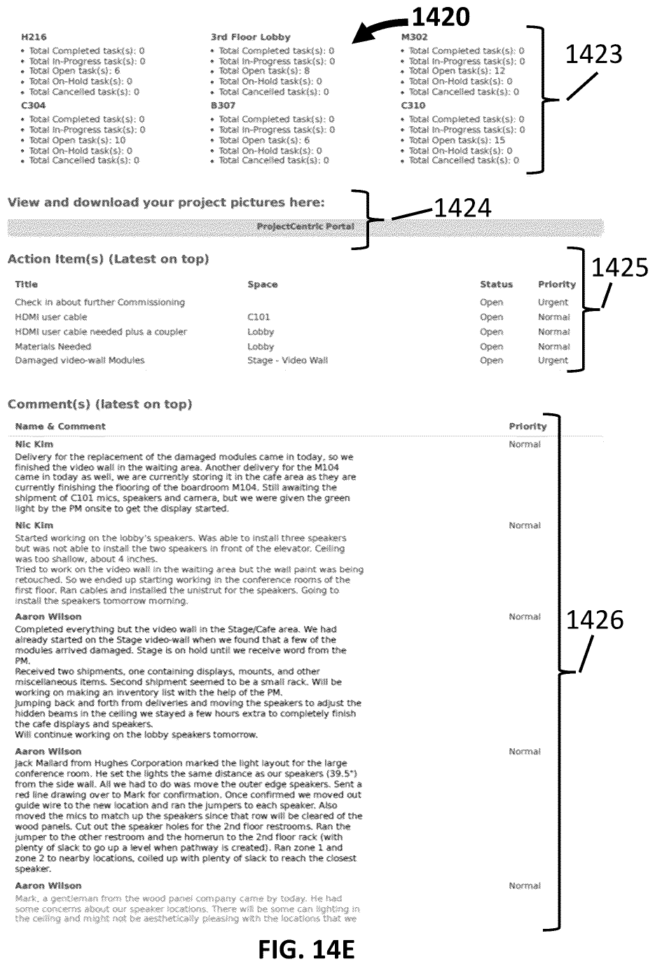

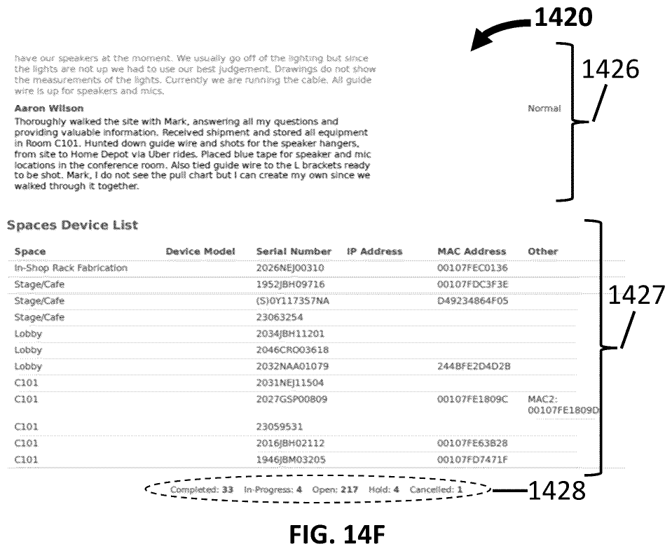

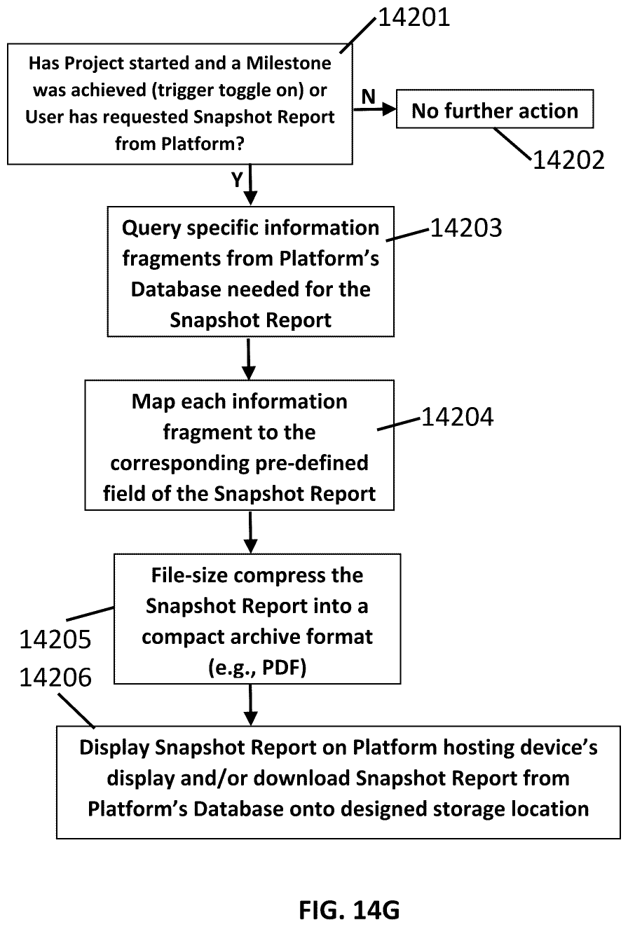

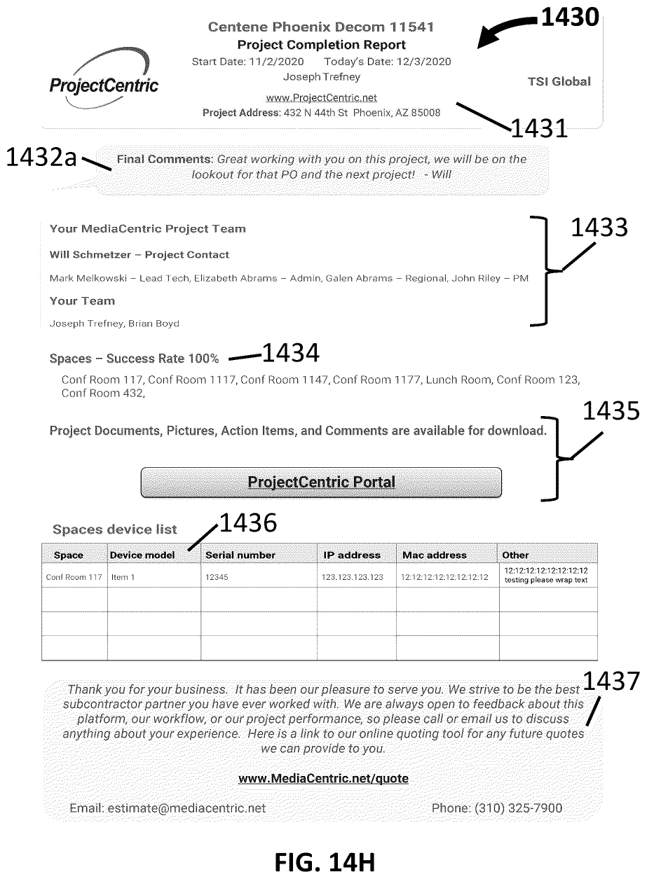

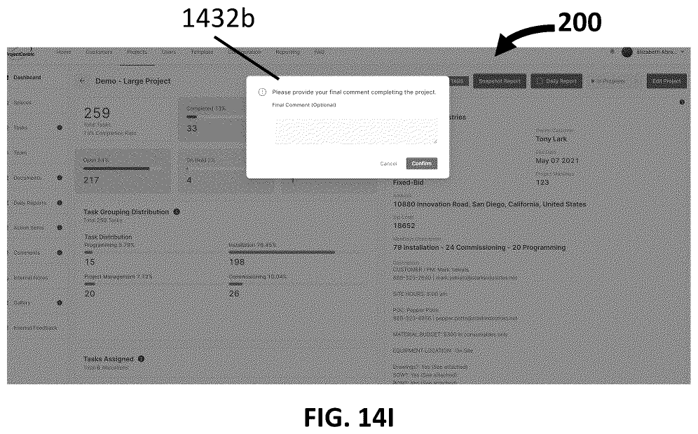

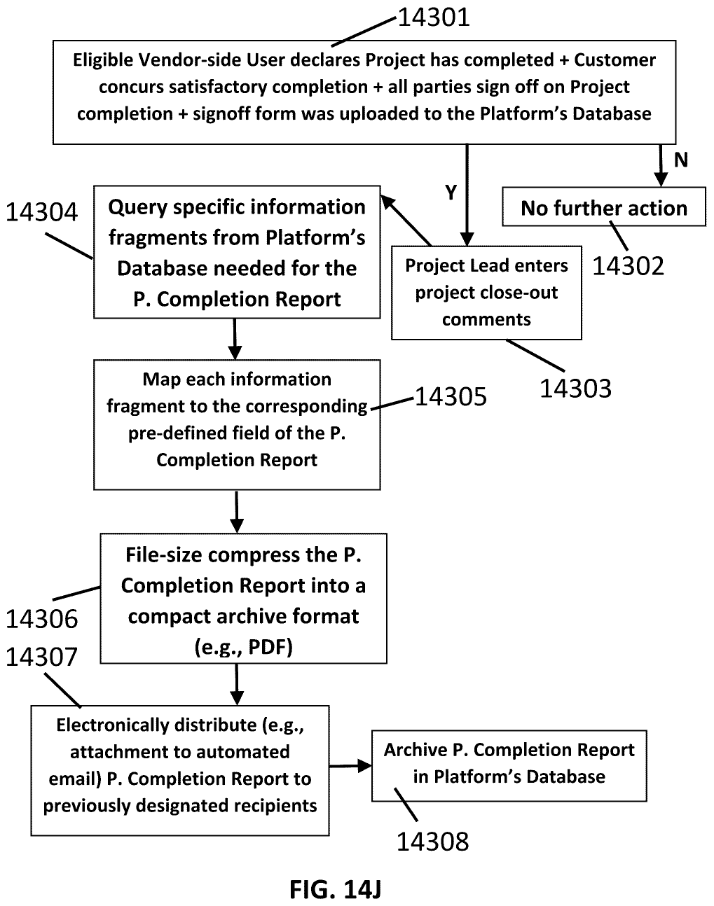

The Platform of the present invention has provisions for Daily or periodic Progress Reports (1410) that are sent to targeted recipients and the Lead Tech (501) is typically the User-type allowed to approve (503) the send-out of the Daily (1410) or periodic Progress Report to Customer Platform Users. Approval to send out (503) the Daily (1410) or periodic Progress Report is accomplished by the Lead Tech (501) by checking off or activating a certain widget (e.g., on-off toggle) on the MA's UI, which causes the Platform to capture relevant information fragments and organize into a distilled progress information Report that is automatically sent to the Customer User's designated Email address, as shown in FIG. 14C. The Platform also tracks that the Lead Tech (501) follows through on the Daily (1410) or periodic Progress Report send-out assessment and approval to help enforce management accountability (503).

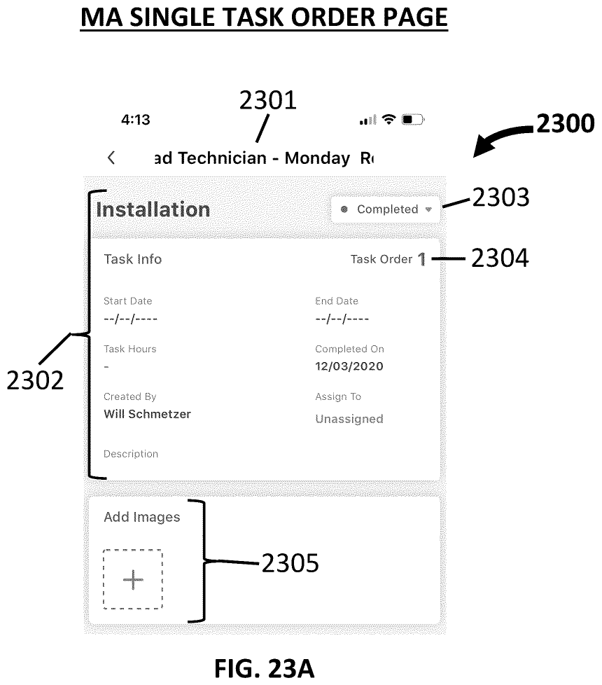

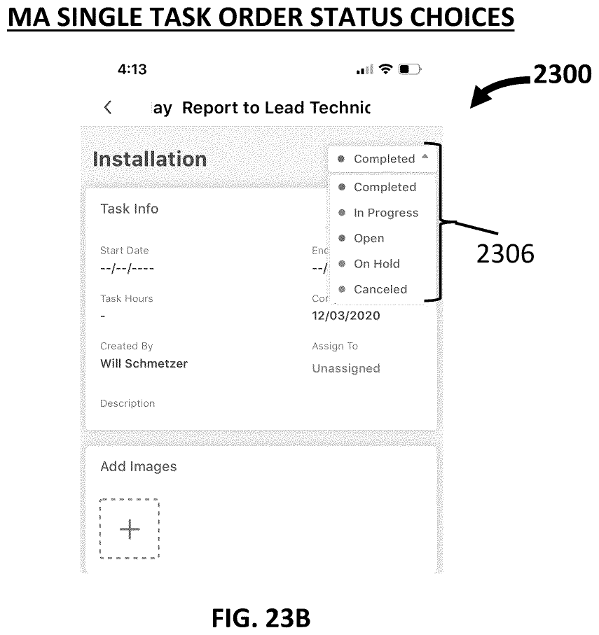

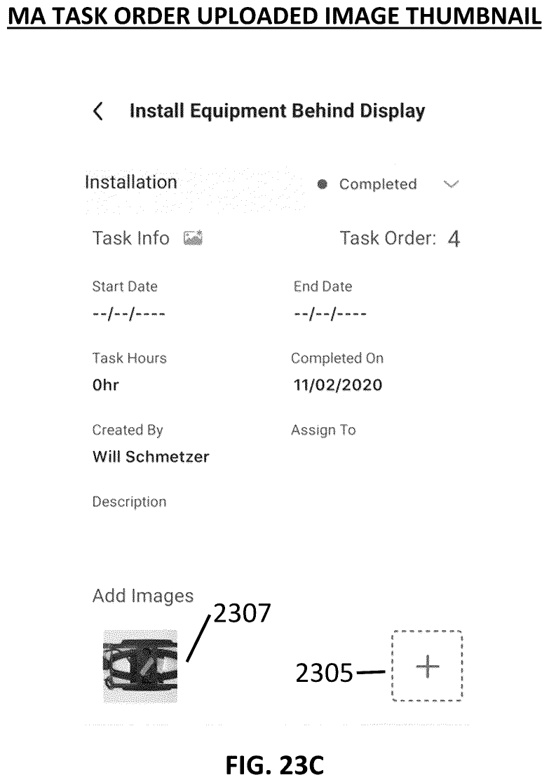

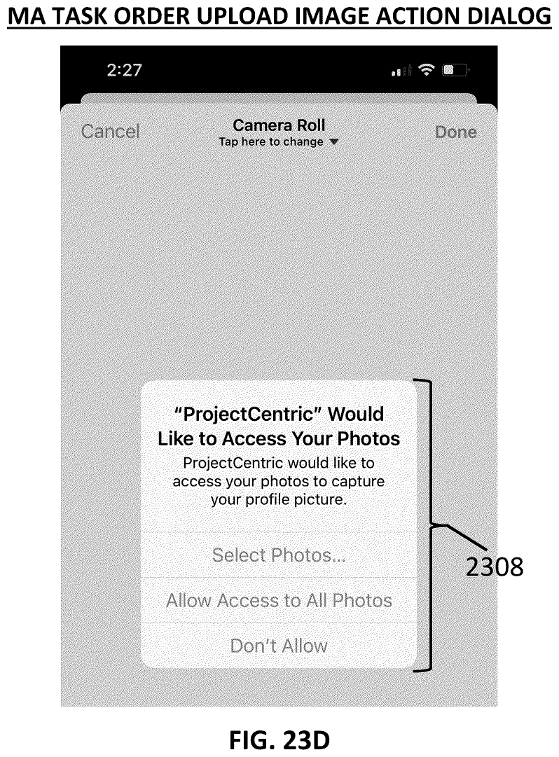

A Lead Tech (501) is also assigned to fulfilling the system integration tasks (504) where fulfillment or progress difficulties or delays are noted on the MA's UI. Certain Tasks (505) that require equipment registration (e.g., serial number or QR code scan), installation proof by picture taking and uploading onto the MA, uploading of a Project or Project Milestone Signoff Form that is signed off by a Customer User, adding Action Items that have cropped up during Task fulfillment, adding Internal Notes, and providing Comments can all be done on the MA's UI (see FIGS. 23C, 23D, 24, and 25), which will be covered in more detail later in this disclosure. Communication with other Tech(s) (601) or Project Manager(s) (701) is also a Lead Tech (501) Role that is facilitated by the Platform.

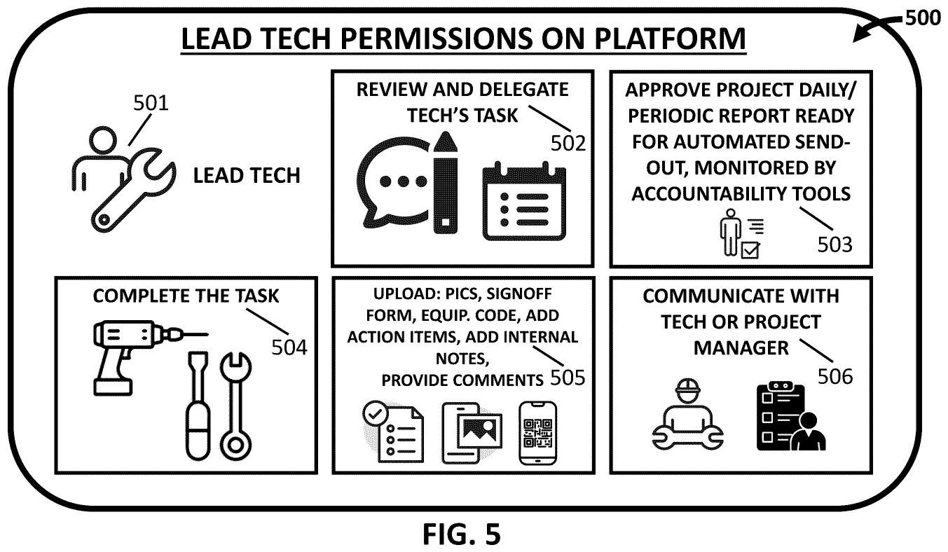

C) Tech(nician) (Ref. FIGS. 5, 6, and 7): Like the Lead Tech (501), a regular tech or “Tech” (601) is a User-type on the Platform that works remotely on-site fulfilling various Project Tasks (602) in different Units (Spaces), except certain permissions and privileges are not shared with the Lead Tech (601), except for situations when no Lead Tech (601) is available and the “Tech” (601) is permitted to execute some of the traditional Lead Tech (501) actions, such as upload a Customer Signoff Form (603). certain Tasks (603) requiring equipment registration (e.g., serial number or QR code scan), installation proof by picture taking and uploading onto the MA, adding Action Items that have cropped up during Task fulfillment, and providing Comments can all be done on the MA's UI, which will be covered in more detail later in this disclosure. Communication with other Tech(s) (601), Lead Tech(s) (501), or Project Manager(s) (701) is also a Tech (601) Role that is facilitated by the Platform. “Engineer” is an additional, separate User type on the Vendor-side that works remotely on-site in different Units (Spaces) with similar collaboration functions (604) as a Technician (501 and 601), but an Engineer's primary Task Groups for the A/V and network security system integrator application embodiment may be focused on equipment programming and set up.

D) Project Manager (Ref. FIGS. 2, 5, 6, 7, and 27A-C): The Project Manager (PM) on the Vendor-side (701) oversees and coordinates many aspects of a Project before actual site work begins to Project Completion. Typically, a PM on the Vendor-side (701) engages the Platform using the Portal (200). The Portal (200) has UI widgets and back-end functionality to enable PMs (701) to transition a Project from the drafts (planning) stage to Open status (702) and official Project fulfillment can begin. Before remote site work can be carried out, the PM (701) loads initial Project Documentation (703) onto the Platform's cloud Database, which includes the Statement of Work (S.O.W.), Bill of Materials (B.O.M.), installation guides, drawings, Project or Project milestone Signoff Forms, and more. The PM (701) also reduces the draft plan into actionable Tasks and Subtasks that are binned into Task Groups that get assigned to Units (Spaces) at the Project site (704), which can all be performed on the Portal (200). Templates can also be used to facilitate robust task and Unit definitions, which will be covered in later sections of this disclosure. In addition to Task and Unit definitions, the PM (701) uses the Portal (200) to assign and if necessary, later edit, the actual Vendor and Customer-side Team Users (705). A subset of the Team will be established on the Portal (200) as the point of contact (706) on the Customer and Vendor sides. Action Items added through the MA UI by Techs (501 and 601) in the field from matters that cropped up during Project Task fulfillment are seen on the Portal and tracked by the PM (707) to make sure the Action Items receive attention in a timely manner. Likewise, Comments added through the MA UI by Techs (501 and 601) in the field during Project Task fulfillment are seen on the Portal (200) and tracked (708) by the PM (701), which can serve a variety of purposes and include Commentary on Tasks that were outside the bounds of the originally agreed contract or purchase order but perhaps needed to be fulfilled. PMs (701) can also facilitate communication between the site Tech(s) (501 and 601) and the Customer (709). If the Customer (e.g., system integrator if the Vendor-Customer relationship is of a business-to-business format) is a registered User on the Platform, then the PM (701) can directly communicate with the Customer through the Platform (710) for reasons comprising of clarification, problem discussion, and “out-of-scope” work. The PM (701) can also interact with Techs (501 and 601) in a number of ways including Notifications, which will be covered later in the disclosure, and help the Lead Tech (501) transition the Project from “In-progress” to “Closed” by, for example, double-checking all objectives, Action Items, “out-of-scope” matters and before affirming a Lead Tech's (501) intent to close out the Project.

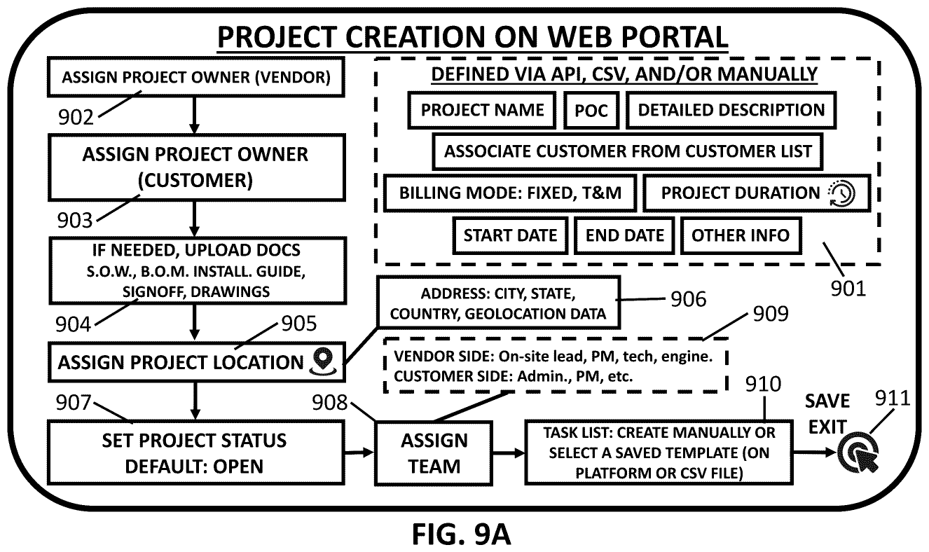

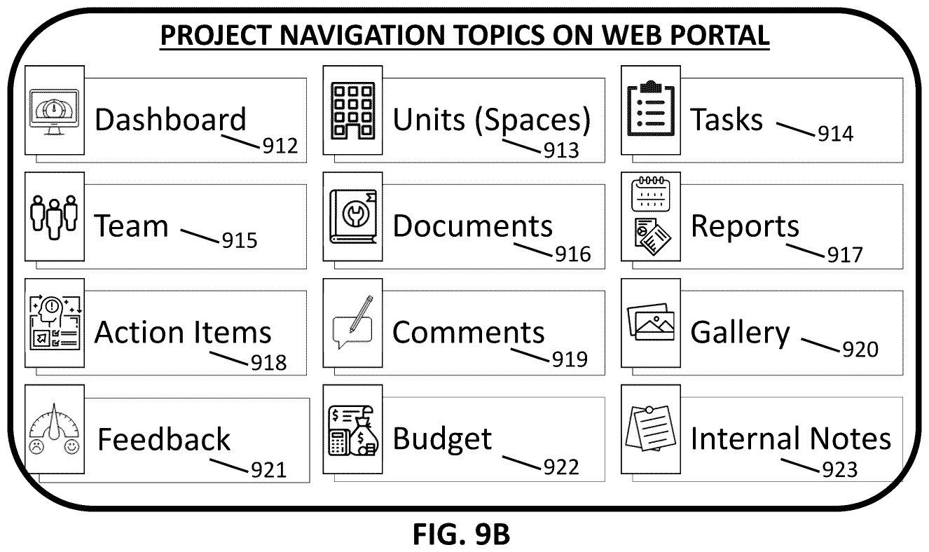

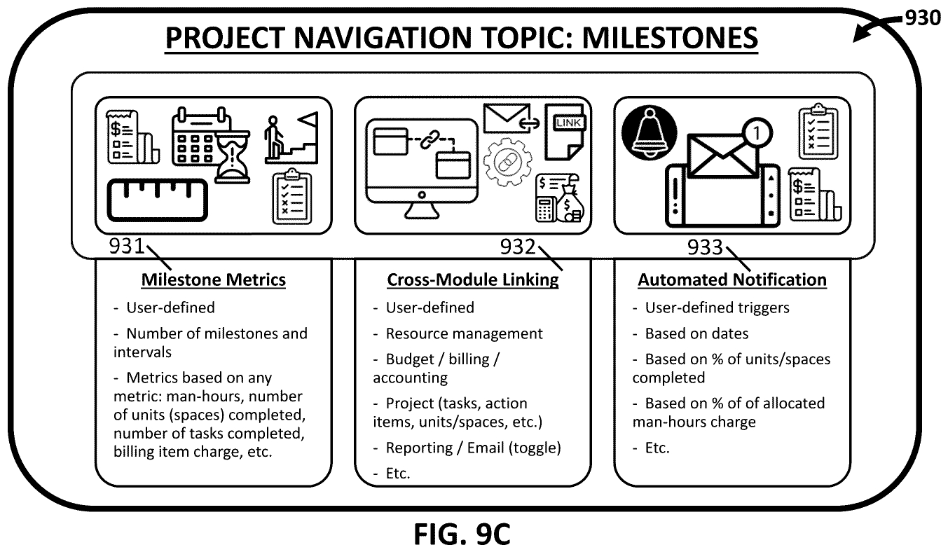

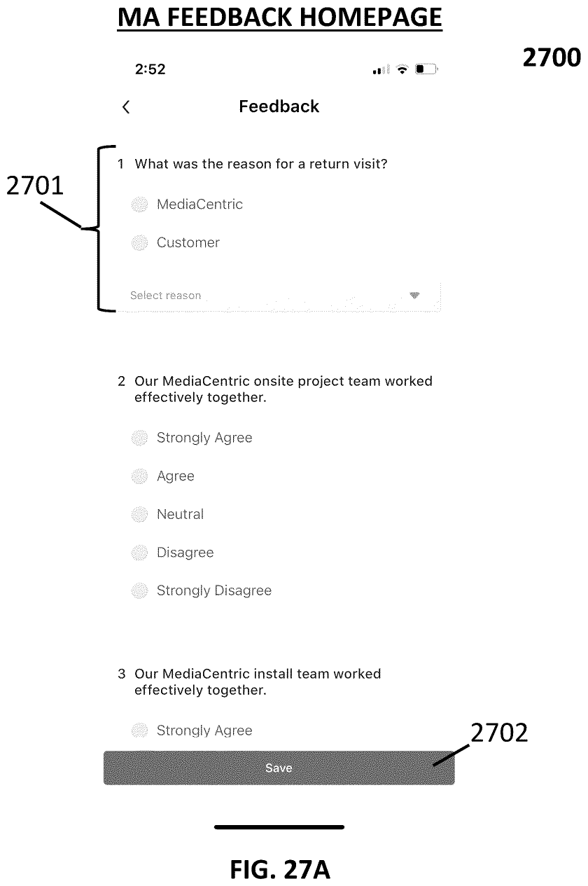

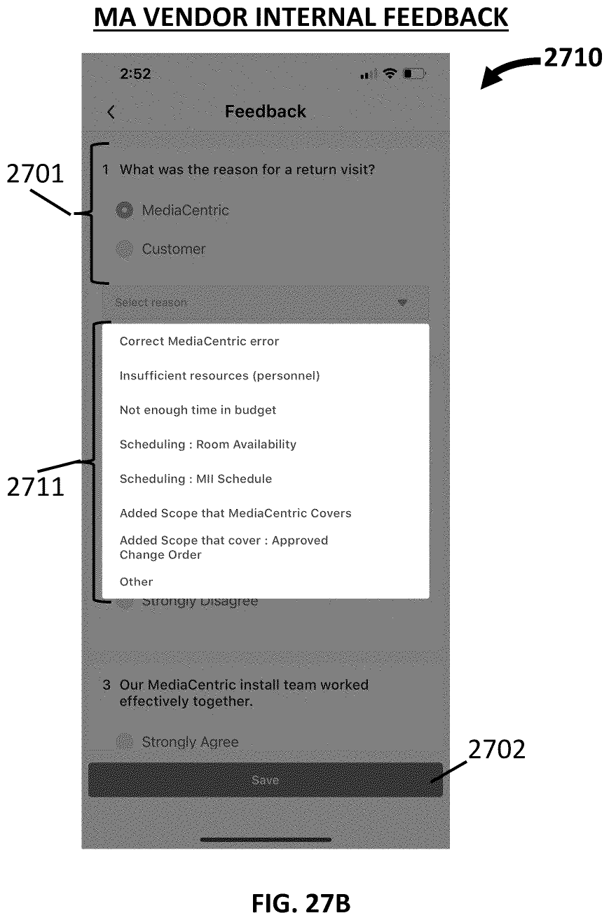

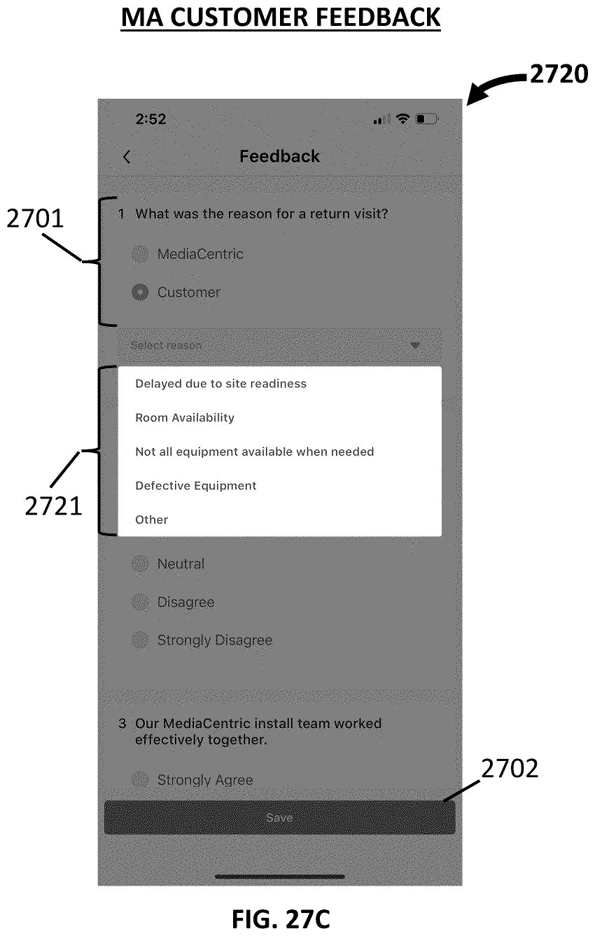

E) Customer (Ref. FIGS. 9B and 27A-C): The Platform has provisions to include Customer User-types so that the Customer can monitor progress and interact with certain Vendor-side Users. This feature is advantageous in allowing Customers to be in-the-loop and maximize Project fulfillment productivity and success. Customers as registered Users also open the possibility to access archived Reports. As will be discussed later, Customer-side Users can fill out Feedback forms (921, 2700, 2710, and 2720) that can improve future Vendor productivity and service quality.

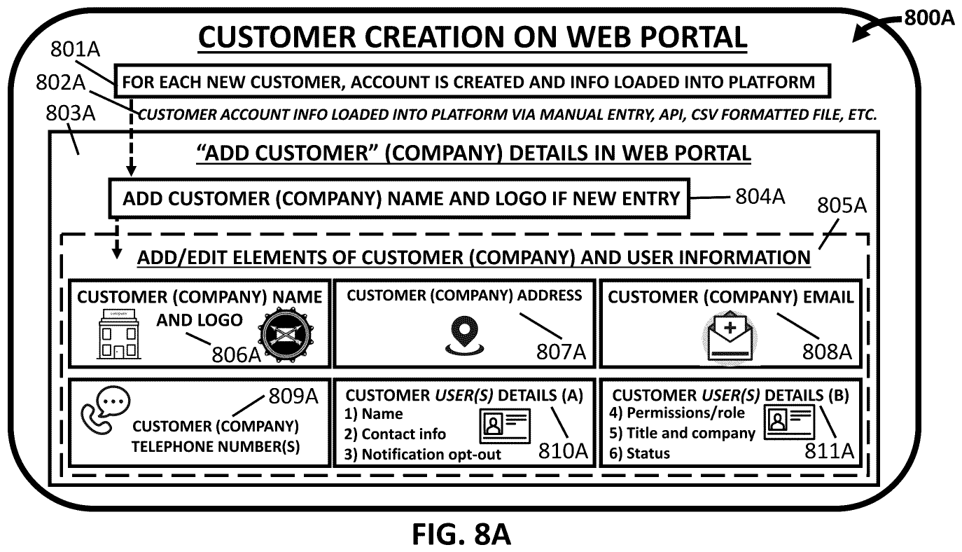

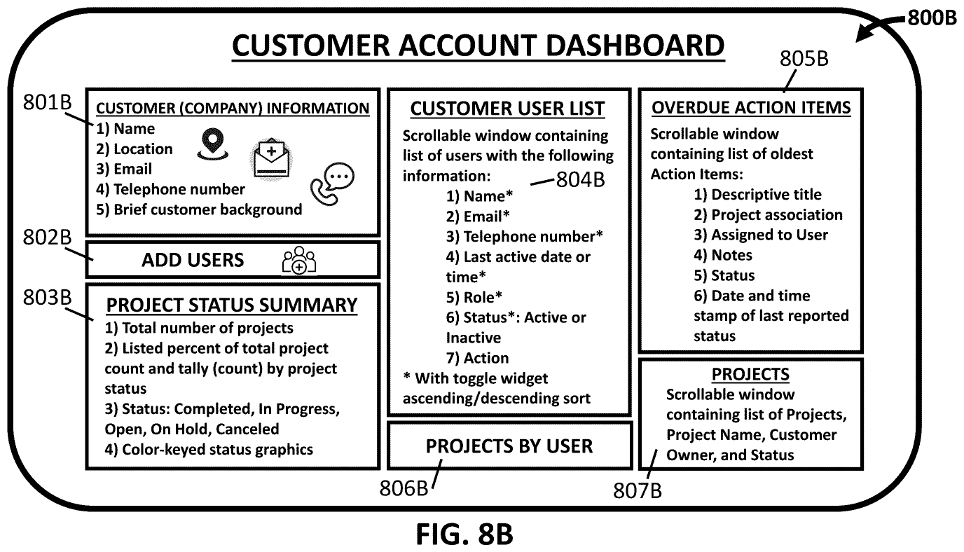

Nothing in the above description—that used an A/V or security system integration application embodiment—should be taken to limit the type of Users that can be used on the Platform. The important points are the generalizable ways different User types can use the Platform to help assist Project monitoring, management, and reporting throughout an Enterprise.
15A) Establishing Customer (Company) Record (Ref. FIG. 8A): After a purchase order or contract has been signed between the Vendor and Customer, or during the writeup of a contract in other embodiments, the Customer account or record is created (801A). If the usage embodiment of the Platform caters to Customers that are organizations or companies (e.g., business-to-business), a company account or record is created.

Embodiments of the Platform allow the Customer account information or record to be loaded onto the Platform's Database by a number of means (802A) including manual entry, using an application programming interface (API) to “hook” into a Database, comma-separated value (CSV) formatted files to facilitate automated string parsing and record field populating, and more. Other embodiments where individuals are the Customers can be through scanning the Customer's identification card and using object character recognition (OCR) and string parsing software to populate the Customer account or record.

After the basic Customer account information has been loaded, application usage embodiments catering to Customer organizations can have additional record fields specified and/or subsequently modified; if necessary, more identifying information (803A, 804A, 805A) The box of elements (805A) is an embodiment summarizing what Customer information can be part of the record, including the company name and logo (806A), address (807A), Email tied to the main organization account (808A), telephone numbers (809A), and assigned Team member User details (810A and 811A) affiliated with the Customer such as Platform Role-based Permissions, name, contact information, an opt-out toggle that precludes the particular individual from receiving project notifications, the User's Role and corresponding Permissions within the Customer organization, the User's title, and status on the Project (e.g., active).
15B) Customer Account Dashboard (Ref. FIGS. 8A and 8B): After a Customer's account is established (800A), the Platform creates an accessible Customer Account Dashboard (800B) that stores and displays on the Portal (200) all relevant customer account information that is stored in the Platform's Database. Embodiments of the Platform can have the Customer Account Dashboard (800B) viewable by eligible Users on both the Vendor and Customer sides. This component is intended for certain Users to review Customer-specific information in an organized and compact manner. This Customer Account Dashboard (800B) also serves as the top-level pointer to more detailed information for widgets or User-interactive information fields with jump links to other parts of the Portal (200) to provide more context and details. Editable information that is displayed includes the Customer's contact information (801B), widgets to add Users (802B), the status of all the Customer's Projects (803B), the list of Vendor-side Users to fulfill the Tasks (804B), list of Overdue Action Items (805B), Projects each Vendor-side User is assigned to (806B), and a list of all Projects under this Customer (807B).
16) Establishing the Project Record (Ref. FIGS. 8A and 9A): After a Customer's account or record has been created (800A), the next step is to define the Project on the Platform. The Portal (200) of the present invention has provisions to quickly define all the information to define every relevant aspect of the Project. During Project creation, embodiments can include definitions of the following:

One of the first pieces of information to define (901) are the Project name, point of contact on the Customer side, detailed description of the deliverables, associate the Customer from a separate list of Customers, mode of billing (e.g., fixed bid, time and material or T&M, etc.), anticipated Project duration, start date, end date, and other pertinent information. Embodiments can include varying means to define these fields, such as API “hook” into an online Database, CSV file(s), and/or manual typed entry on the Portal.

Most generally speaking, there are two Project “owners” or parties, starting with the Vendor or service provider (902) and then the Customer (903). Eligible Users on the Vendor side will upload relevant Documents (904) needed to carry out the Project Tasks with certain embodiments calling for Statement of Work (S.O.W.), Bill of Materials (B.O.M.), installation guides, Project and/or milestone completion Signoff Forms, drawings, and more. Then the Project site location is assigned (905 and 906), and an embodiment of the Platform has the Project status set to “Open” to signify the Project is in progress, Team members from the Vendor and Customer organizations are assigned and noted on the Portal (908 and 909), and then a Task list within Unit(s)/Space(s) and Task Groups are defined manually or by CSV file or Templates (910), which will be described later in the present disclosure. Further details on Task definition and Templates will be provided later in the disclosure. Embodiments can have this portion of the Project definition be concluded at this point (911).
17) Topics Under the Project Navigation Topics Submenu (Ref. FIGS. 2, 9B, and 9C): For the preferred embodiment of the Portal (200), when “Projects” is selected from the Global Systems Menu, the Navigation Topics Submenu listed in FIG. 9B appears on the Portal (200). This list of topics, whose specific ordering is not compulsory, is the “best practices” manifestation of a heuristics-based approach that most effectively enables Projects to be planned, managed, monitored, and reported on.

A) Dashboard (912): The first Navigation Topic is the Project “Dashboard” (912), which is the preferred embodiment of the Portal (200) and includes a mix of text and graphical conveyance of the Task's progress status, Task Group distribution, information listed in (901), Action Items, and a gallery of installation Pictures. As is done Platform-wide, ample use of blank spacing between information bits spread out on a larger scrollable window and expandable (after clicking “View All”) section panes all lend to a more readable UI than numerous other Project management applications.

The state of Task progress comprises the total number of Tasks, percent of total Tasks completed, and separate “card” panels for Tasks classified as “Completed,” “In Progress,” “Open,” “On Hold,” and “Canceled.” Each card has a written and visual bar line percentage of the total Task count in that status along with the number of Tasks with the status. Task Group distribution indicates the class of tasks apportioned in the Project; for example, 80% of the Tasks to be fulfilled fall under “Installation” and 20% under “Commissioning.”

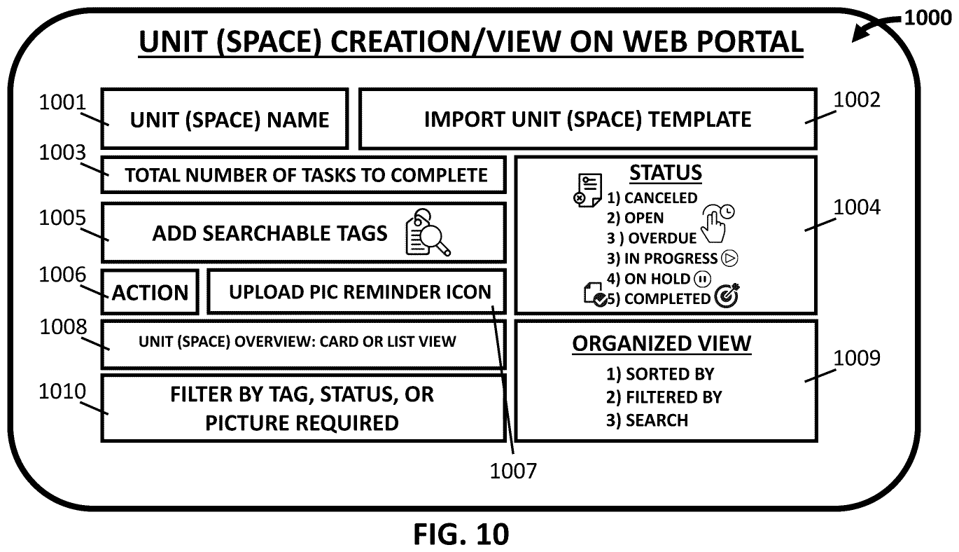

B) Units (Spaces) (913) (Ref. FIGS. 2, 9B, and 10): The second Navigation Topic is Units (Spaces) (913) where tasks are to be fulfilled, which is an A/V system integration application embodiment representation of “Units.” Each Unit (Space) corresponds to a discrete module where a series of Tasks are carried out and can be marked with specific Project status or completion tags. Units (Spaces) are one of the intermediate layers or Project object types that serve as a handle to map specific Tasks to the Project. The preferred embodiment of the Platform has Database records for each Unit (Space) only creatable, editable, or capable of being deleted from the Platform's Database from the Portal (200) and not the MA (300). This helps the MA (300) stay focused on relevant functionality.

Units (Spaces) can be whatever is an appropriate representation where tasks are to be fulfilled. For example, Units (Spaces) can be vehicles to be serviced if the Platform is integrated into the workflow of, for example, emission system retrofit of Customer vehicle fleets. Selecting the Units (Spaces) topic on the Portal (200) has the UI show either a scrollable window or a non-scrollable window of a list or Kanban card(s) (1008) for each and all the Units(Spaces) that need to be tended to before Project completion. The list element or card for each Unit (Space) indicates information comprising:
i) Unit (Space) name (1001).
ii) Short descriptive tags that act as search handles (1005).
iii) Total number of tasks that need to be completed (1003).
iv) Icon to indicate if installation Pictures need to be taken as part of the assigned Tasks for the Unit (Space) (1007).
v) The number of tasks that fall under one of the following status labels (1004): Embodiments can include a list comprising “Completed,” “In Progress,” “Open,” “On Hold,” “Overdue,” and “Canceled.”

Each card or list element can be selected from the UI for further details of the Tasks and Team members assigned to the specific Unit (Space). On the main Units (Spaces) page (1000) where multiple Units (Spaces) can be shown, the other widgets or labels not yet mentioned can comprise:
i) Project name.
ii) Total number of Project Tasks (1003).
iii) Unit (Space) name string search bar that filters to the displayed Unit (Space) names containing the typed letters on the main scrollable window as the Unit (Space) name is being typed (1009).
iv) Widget to toggle between list and Kanban card view (1008).
v) An “Add Unit (Space)” widget to define a new Unit (Space) and the associated Task details. When this widget is pressed, a dialog appears and the preferred embodiment of this first dialog has fields for the Unit (Space) name (1001), a pull-down menu for importing a pre-defined Unit (Space) Template (1002), and a field for search string tags (1005). The preferred embodiment of the present invention also has a widget to add more Units (Spaces) in this first dialog so that multiple Unit (Space) definitions can be performed.
vi) A pull-down menu of ways to sort the Units (Spaces) (e.g., alphabetical, number of Tasks, etc.) is displayed on the main scrollable window.
vii) User choices for organizing the view (1009) of Units (Spaces), where embodiments can comprise sorting in some order, filtered by some criterion, or search results.
viii) A filter (1010) to show only Units (Spaces) on the main scrollable window that fits a certain criterion where filter embodiments can comprise search tag, completion status, or a picture or proof-of-task-fulfillment is required.
ix) Action: Embodiments can include delete, copy, edit, etc. of the Unit (Spaces) item on the same row.

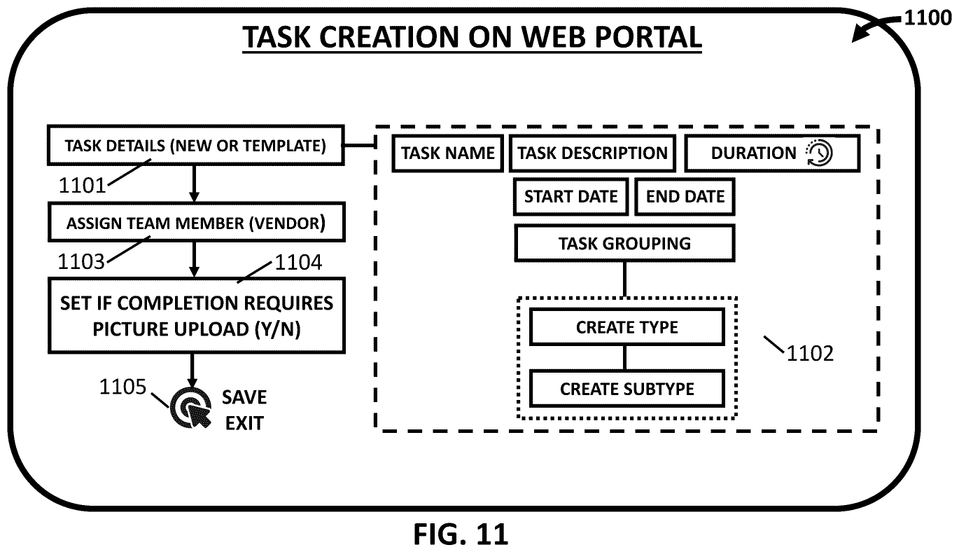

C) Tasks (914) (Ref. FIGS. 2, 11, and 12): The third Navigation Topic is “Tasks” (914), which when selected on the Portal (200), has the UI show a scrollable or non-scrollable window list of the tasks that need to be fulfilled to before Project completion.

When a new Task is created (1100), the Portal (200) has queries or fields that eligible Users will fill out to define the record that is stored on the Platform's Database. One embodiment of the Platform has the following queries or fields that define a task comprising Task Details (1101) which can be newly created, or a Task variant expeditiously created if a similar Task Template already exists. Task definition by Template follows a User action to start importing most of the Task detail and the User modifying any detail particular to the new Task definition. During this definition stage (1102), the preferred embodiment has the following specifications defined: Task name, Task description, anticipated duration to complete the Task, start and end dates of fulfillment, and the category or group the Task falls under (e.g., Installation, Commissioning, etc.). Tasks can be further defined by type and subtype. In the preferred embodiment, Tasks can be one action or comprise multiple actions. Before saving the record and exiting the Task definition UI (1105), final definitions in the preferred embodiment can comprise the Vendor-side Team member assigned to fulfill the Task (1103) and certain other requisite requirements (1104) like taking picture proof of the Task deliverable; the latter specification can be a Boolean toggle from a checkbox and subsequent indicators can comprise a generic picture icon indicating the Task is one that requires picture proof before completion.

The notion of Task (1200) in the preferred embodiment of the Platform is that each Task needs to be classified under a Task Group (1201). For an A/V system integrator application embodiment, Task Groups (1201) can comprise Installation, Commissioning, Programming, Custom, and more. Then the Task Group (1201) itself can be classified by a main Task Group Type (1202). For an A/V system integrator application embodiment, examples of Task Group Types (1202) can comprise Display, Audio, Structural and more. Beyond that, a Task Group Subtype (1203) can be defined, which for the same application embodiment discussed here, can comprise Small Rack, Medium Rack, Large Rack, and more. Such methods of Task definition (1200) in combination with Templatization in a preferred embodiment, allow easy and rapid yet versatile and robust specification for Projects of a massive scale, where for example, hundreds of Units (Spaces) need to be serviced.

The “look and feel” of the main Tasks page on the Portal (200) resembles the Units (Spaces) page (1000), with the widgets or labels comprising:
i) Project name.
ii) Total number of Tasks to be completed in the Project.
iii) Task string search bar that filters to the displayed task names containing the typed letters on the main scrollable window as the Task name is being typed.
iv) “Export Data” button which opens a dialog to export Project data.
v) Task search filter (e.g., tasks with a “completed” status).

Each list element can be selected from the UI for further details of the tasks and Team members assigned to the specific Task. On the main Tasks page(s) (914) where multiple Tasks arranged along sorted rows can be shown, the information pieces for each Task are placed under columns titled:
i) Task “Name” (1102) and the entire list can be sorted by alphanumerical—ascending or descending order of the list of Task names.
ii) Unit (Space) name where the Task is to be carried out and the entire list can be sorted by alphanumerical—ascending or descending order of the list of Unit (Space) names. The same tasks can be carried out in different Units (Spaces).
iii) “Task Group Name” (1102) and the entire list can be sorted by alphanumerical—ascending or descending order of the list of Task Group names.
iv) Team member(s) the Task is “Assigned To.”
v) “Status” of progress (e.g., Completed, Open, etc.) and the entire list can be sorted by alphanumerical—ascending or descending order of the Status string.
vi) “Completed On” is the date shown only next to “Completed” Status Tasks and the entire list can be sorted by chronological—ascending or descending order of the “Completed On” date string.
vii) Action: Embodiments can include delete, copy, edit, etc. of the Task on the same row.

D) Team (915): The fourth Navigation Topic is what “Team” (915) assigned to the Project, that when selected on the Portal (200), has the UI show a scrollable or non-scrollable window list of the Team members under either the “Vendor” or “Customer” tab.

The “look and feel” of the main Team page (915) on the Portal (200) resembles the Units (Spaces) (913) and Tasks (914) pages, with the widgets or labels comprising:
i) Project name.
ii) Total number of Vendor Team members assigned to the Project.
iii) Team member (User) name string search bar that filters to the displayed names containing the typed letters on the main scrollable window as the name is being typed.
iv) An “Add User” button that spawns a dialog with queries and fields or widgets comprising the name of the Team member for the Vendor or Customer, full contact information, Role, and corresponding Permissions, portrait photo, and title within the organization.
v) A “Create User” button that spawns a dialog with queries and fields or widgets comprising all the conceivable privileges and permissions defining the User type that require delineation between other types of Users (e.g., permissions set between Administrator and SuperAdmin).
vi) “Export Data” button which opens a dialog to export Project data.
vii) “Filter” button to display list based on user-defined criterion/criteria.

Each list element can be selected from the UI for further details of the Team member assigned to the Project. On the main Team page(s) (915) where multiple Team members (Users on either the Vendor or Customer side) arranged along sorted rows can be shown, the information pieces for each Team member are placed under columns titled:
i) “Name” and the entire list can be sorted by alphanumerical—ascending or descending order of the list of Team member names.
ii) “Title” of the Team member User in his or her organization and the entire list can be sorted by alphanumerical—ascending or descending order of the list of Titles.
iii) “Telephone” number and the entire list can be sorted by numerical—ascending or descending order of the list of telephone numbers.
iv) “Email” if the corresponding Team member and the entire list can be sorted by alphanumerical—ascending or descending order of the list of Task Group names.
v) “Role” and associated Permissions of the Team member and the entire list can be sorted by alphanumerical—ascending or descending order of the Role string.
vi) “Created On” is the date when the Team member was added to the Platform's Database.
vii) Action: Embodiments can include delete, copy, edit, etc. of the Team User on the same row.

E) Documents (916): The fifth Navigation Topic is what “Documents” (916) are uploaded to the Project's record, that when selected on the Portal (200), has an embodiment of the UI show a scrollable or non-scrollable window list or icon representing the Project document file that has been uploaded to the Database and can be later downloaded from the Portal (200) or MA (300).

The “look and feel” of the main Documents page (916) on the Portal (200) resembles the Unit (Spaces) (913) and Tasks (914) pages, with the widgets or labels comprising:
i) Project name.
ii) Total number of project Documents uploaded to the Platform.
iii) Document filename string search bar that filters to the displayed filenames or type of file containing the typed letters on the main scrollable window as the filename is being typed.
iv) An “Add Documents” button that spawns a file browse or “drag and drop” dialog so that the User can interact with the UI to browse file directories, select one or more file(s), upload, and then have an icon reflecting the document has been uploaded and available for actions comprising future download (a copy is downloaded, not moved), deletion, or overwriting.
v) A “Filter” button to display a list based on user-defined criterion/criteria.

Each icon representing an uploaded Project Document can have embodiments with information or symbols comprising the file format (e.g., .xlsx, .pdf, jpg), the file upload date, and file size (e.g., KB, MB).

F) Reports (917): The sixth Navigation Topic focuses on what “Daily Reports” have been generated by the Platform and automatically delivered to a predefined recipient list. Note, Daily Reports are only one of three types of reports described in the present disclosure, whereas the other two types are Current Snapshot Report and Project Completion Report. The provisions within this Navigation Topic Submenu option along with those of the Reporting Global Systems Menu option are part of what is called the “Reporting Module” within the Platform. For this page on the Portal (200), the UI shows a scrollable or non-scrollable window list or icon representing each and every instance of a daily report document that has been archived to the Database and can be later downloaded or sent from the Portal (200). This page and functionality are useful for a number of situations, for example, when a recipient has misplaced the file and wishes for another copy to be sent to him or her.

The “look and feel” of the main Reports page (917) on the Portal (200) resembles the Unit (Spaces) (913) and Tasks (914) pages, with the widgets or labels comprising:
i) Project name.
ii) Total number of Daily Report Documents uploaded to the Platform.
iii) Daily Report filename string search bar that filters to the displayed filenames or type of file containing the typed letters on the main scrollable window as the filename is being typed.
iv) A “Filter” button to display a list based on user-defined criterion/criteria.

Each icon representing an uploaded daily report can have embodiments with information or symbols comprising the file format (e.g., .xlsx, .pdf, jpg), the file upload date, and file size (e.g., KB, MB). Auxiliary actions such as right-clicking on the icon can spawn a menu of actions comprising Download or Send. If Send is the selected action, an embodiment can further spawn a dialog querying the User to specify whom to send the Document to as well as the subject line.

G) Action Items (918): The seventh Navigation Topic is what “Action Items” (918) have been added to the Project, that when selected on the Portal (200), has the UI show a scrollable or non-scrollable window list of Action Items. Action Items are Tasks that have cropped up during the Project and may be outside the original planned Tasks.

The “look and feel” of the main Action Items page on the Portal resembles the Units (Spaces) (913) and Tasks (914) pages, with the widgets or labels comprising:
i) Project name.
ii) Total number of Action Items added to the Project.
iii) Action Item title string search bar that filters to the displayed names containing the typed letters on the main scrollable window as the name is being typed.
iv) An “Add Action Item” button that spawns a dialog with queries and fields or widgets comprising the Action Item Title, End Date, Priority selection menu, editable rich text action description box, Unit (Space) associated with the Action Item, and Team member Users assigned to fulfill the Action Item Task.
v) “Export Data” button which opens a dialog to export project data.
vi) “Filter” button that when pressed, opens a search filter dialog based on Action Item Status, Team member(s) the task is assigned to, the Unit (Space) the Action Item is associated with, the priority level as chosen from a menu, and End Date.
vii) Action: Embodiments can include delete, copy, edit, etc. of the Comment on the same row.

Each list element can be selected from the UI for further details of the Action Item added to the project. On the Action Items page(s) (918), where multiple Action Items arranged along sorted rows can be shown, the information pieces for each Action Item are placed under columns titled:
i) “Action Items” and the entire list can be sorted by alphanumerical—ascending or descending order of the list of Action Items string.
ii) “Unit (Space)” of the associated Actions Item and the entire list can be sorted by alphanumerical—ascending or descending order of the list of Action Items.
iii) “Created On” is the date when the Action Item was added to the Platform's Database and the entire list can be sorted by chronological—ascending or descending order of the “Created On” date.
iv) “Priority” of the associated Action Item and the entire list can be sorted by alphanumerical—ascending or descending order of the Priority string.
v) “Assign To” Team member responsible for fulfilling the Action Item. Embodiments of indication in this field can be color-keyed circular icons with the Team member's first and or last initials.
vi) “End Date” target for the Action Item to be addressed and the entire list can be sorted by chronological—ascending or descending order of the End Date.
vii) Upload multimedia or document widget
viii) Action: Embodiments can include delete, copy, edit, etc. of the Action Item on the same row.

H) Comments (919): The eighth Navigation Topic is what “Comments” (919) have been added to the Project, that when selected on the Portal (200), has the UI show a scrollable or non-scrollable window list of Comments. For the preferred embodiment of the Platform, each Comment can be a handle for its own action item, and each comment is both editable and able to be deleted from the Platform's Database.

The “look and feel” of the main Comments page on the Portal (200) resembles the Units (Spaces) (913) and Tasks (914) pages, with the widgets or labels comprising:
i) Project name.
ii) Total number of Comments added to the Project.
iii) Comments title string search bar that filters to the displayed names containing the typed letters on the main scrollable window as the name is being typed.
iv) An “Add Comment” button that in the preferred embodiment, opens a dialog with an editable rich text box where Comments can be entered by an input device like a physical or virtual keyboard. To the right of the rich text widget box is a pull-down menu for Users to select a priority level of the Action Item, and adjacent to that a pair of buttons, one with a checkmark icon and the other an “X” symbol, to allow the User to either confirm and add the comment to the list as a read-only text label or string (clicking the check button) or cancel (clicking the button marked “X”) and action to add a comment.

On the main Comments page(s) (919), where multiple Comments arranged along sorted rows can be shown and sorted in columns titled, the information pieces for each Comment are placed under columns titled:
i) “Name” of the Team member User.
ii) “Out of Scope” (Yes/No): Indicator of whether the line item comment pertains to originally planned or current Statement Work (S.O.W.) or something outside of the current S.O.W.
iii) “Priority” of the associated Comment if the comment itself is an action item, and the entire list can be sorted by alphanumerical—ascending or descending order of the Priority string.
iv) “Created On” is the date when the Comment was added to the Platform's Database and the entire list can be sorted by chronological—ascending or descending order of the Created On date.
v) Action: Embodiments can include delete, copy, edit, etc. of the Comment on the same row.

I) Gallery (920): The ninth Navigation Topic is what “Gallery” (920) proof-of-task-fulfillment Pictures (e.g., wiring and TV wall mount installation Pictures before TV installation) have been added to the Project, that when selected on the Portal (200), has the UI show a scrollable or non-scrollable window list of Unit (Space) names.

Initially, the frame for each Unit (Space) is unexpanded, without an array of picture(s) shown. However, clicking on a frame expands the frame to include thumbnail views of each picture uploaded to the Platform's Database. Embodiments of the thumbnails can have a checkbox placed at one corner of each thumbnail to select the picture for deletion or downloading. A preferred embodiment of the thumbnail layout can be horizontal and optionally, the thumbnail images can be placed on a horizontally scrollable frame so that access to all images can be from one frame if more thumbnail images exist than can be shown across the width of said frame at one time. Embodiments can have a “Select All” widget in the proximity of the expanded frame to allow all images to be selected at once.

The “look and feel” of the main Gallery page on the Portal (200) resembles the Units (Spaces) (913) and Tasks (914) pages, with the widgets or labels comprising:
i) Unit (Space) name.
ii) Total number of Units (Spaces) added to the Project.
iii) Unit (Space) name string search bar that filters to the displayed names containing the typed letters on the main scrollable window as the Unit (Space) name is being typed.

J) Feedback (921): The tenth Navigation Topic is a Portal (200) embodiment of the Feedback web form (921) and be placed on either a scrollable or non-scrollable window. Widgets and labels of this page include the Project Name, preferably above the Feedback web form. Optional embodiments can have this page serve for either the Vendor or the Customer, as decided by User activating one of two radio buttons next to the Vendor or Customer. The selection event triggers a specific survey. Both surveys have embodiments that have a “Submit” or “Cancel” button at the bottom or end of the Feedback web form. Clicking Submit will archive the User entries onto the Platform's Database. Clicking Cancel will clear or reset any User Feedback web form response.

K) Budget (922): The eighth Navigation Topic is what “Budget” (922) line items have been added to the Project of interest, that when selected on the Portal (200), has the UI show a scrollable or non-scrollable window list of Budget line items. The provisions here are part of the “Budget Management Module.” The Budget line items (922) are where Budget line items that were previously generally defined under Budget Navigation Topics (1503) within the Configuration Global Systems Menu option are now assigned actual allocated amounts, and notification thresholds, and where usage and remaining balances are reviewed or edited. The Budget Navigation Topic option (1503) will be discussed later in the present disclosure.

The “look and feel” of the main Budget page on the Portal (200) resembles the Units (Spaces) (913) and Tasks (914) pages, with the widgets or labels comprising:
i) Project name.
ii) Total number of Budget line items added to the Project.
iii) Budget line item string search bar that filters to the displayed names containing the typed letters on the main scrollable window as the name is being typed.
iv) Select Line Item
v) Edit Line Item
vi) Delete Line Item
vii) An “Add Line Item” button that in the preferred embodiment, opens a dialog window with fields for “Line Item Name,” “Budgeted” or budget allocation for the line item, how much is “Used” so far, how much is scheduled to be used in the Job Board for the future calendar days, the threshold relative to the total allocated where a yellow color indicator corresponding the line item of interest is shown, and the relative to the total allocated range where a green color indicator corresponding the line item of interest is shown. In the exemplary embodiment of the Platform, a red color indicator corresponding to the line item of interest is shown once the expenditure equals or exceeds what is allocated. A Budget line item can be user-configurable such that the line item expenditure is in units of man-days, man-hours, or any unit of measure defined earlier by an eligible User under the separate Configuration Global Systems Menu option/Budget Navigation Topics Submenu, that will be discussed later.

On the main Budget line item page(s) (922), where multiple Budget line items arranged along sorted rows can be shown, the information pieces for each Action Item are placed under columns titled:
i) Budget line item name.
ii) Budgeted or Allocated.
iii) Used or Spent.
iv) Scheduled.
v) Balance: This can be positive or negative with the appropriate color indicator described above.
vi) Action: Embodiments can include delete, copy, edit, etc. of the Budget line item on the same row.

The field values in the main Budget line item page(s) can be directly edited without having a full Add/Edit Budget Line Item dialog open. By engaging the field of interest by, for example, double-left mouse clicking while the UI pointer is hovering above the field of interest, the Platform will know to switch to a quick edit mode, and the User can directly select/type an edited value or a minimal UI dialog pops up with widgets comprising+/−buttons and editable string fields that the User can interact with. A save or confirm widget can exit the quick edit mode for the field of interest.

L) Internal Notes (923): The ninth Navigation Topic is what “Internal Notes” (923) have been added to the Project, that when selected on the Portal (200), has the UI show a scrollable or non-scrollable window list of Internal Notes. For the preferred embodiment of the Platform, each line item Internal Notes is both editable and able to be deleted from the Platform's Database. Unlike the Comments page (919), the Internal Notes page (923) is only usable and viewable only on the Vendor-side Portal (200) or MA (300). A filter for the displayed notes, export data provision, and a dialog to open/view/delete multimedia or documents (e.g., PDF) for each Note are also included in the exemplary embodiment of the Internal Notes page (923). Internal Notes are useful for Project handoffs from one Team Lead to the succeeding Team Lead. Information like where equipment important for Task fulfillment is, what Task pitfalls to watch out for to avoid, etc. Embodiments of the Platform can have an Email sent off to a target Vendor-side user every time or within a certain time when the Internal Notes have been updated.

The “look and feel” of the main Internal Notes page on the Portal (200) resembles the Comments (919) page, with the widgets or labels comprising:
i) Total number of Internal Notes added to the Project.
ii) Internal Notes or “Notes” string search bar that filters to the displayed names containing the typed letters on the main scrollable window as the name is being typed.
iii) An “Add Note” button that in the preferred embodiment, opens a dialog with an editable rich text box where Internal Notes can be entered by an input device like a physical or virtual keyboard.

On the main Internal Notes page(s) (923), where multiple Internal Notes arranged along sorted rows can be shown, the information pieces for each Action Item are placed under columns titled:
i) “Notes”
ii) “Created On” is the date when the line item Internal Note was added to the Platform's Database and the entire list can be sorted by chronological—ascending or descending order of the Created On date.
iii) Action: Embodiments can include delete, copy, edit, etc. of the Internal Note on the same row.

M) Milestones (930) (Ref. FIG. 9C): The tenth Project Navigation Topic is “Milestones.” Milestones are typically identified to mark a significant point in a Project, and the present invention has a Milestones feature which is linked to the Vendor's billing and invoicing functions and leverages off the records in the JB (3300) and serves as an alternative trigger for automated Reporting. This allows the project owner, PM, or even a billing position to see all the details and invoices for the correct amount. The provisions here are part of the “Milestones Module.”

On the Projects dashboard portion of the Portal (200), an eligible User would be able to activate whether Customer billing can be done by Milestones, how many Project milestones there are, milestone intervals (useful for tracking in-progress billing), and the target completion date (931). In the preferred embodiment, Milestones can be defined by Units (Spaces) completed (931, 932), by the percentage of the total number of Tasks completed, by completion date, date window, or by the number of “man days” or “man-hours.”

“Man days” or “man-hours” is a cumulative measure of staffing allocation that in one embodiment can be the total time across all staff members that worked on the Project Tasks to achieve a certain milestone. This serves as the labor portion of the milestone-specific bill that an embodiment can combine with the Bill of Materials (B.O.M.) for a total bill. Man days or hours are calculated by JB (3300).

Once a milestone is achieved (933), then eligible team members are kept informed via automated Email and/or push notification announcing such, preferably in congratulatory language that can also indicate the milestone number and automatically trigger the generation of the Current Snapshot Report (1420) that is attached with the Email.

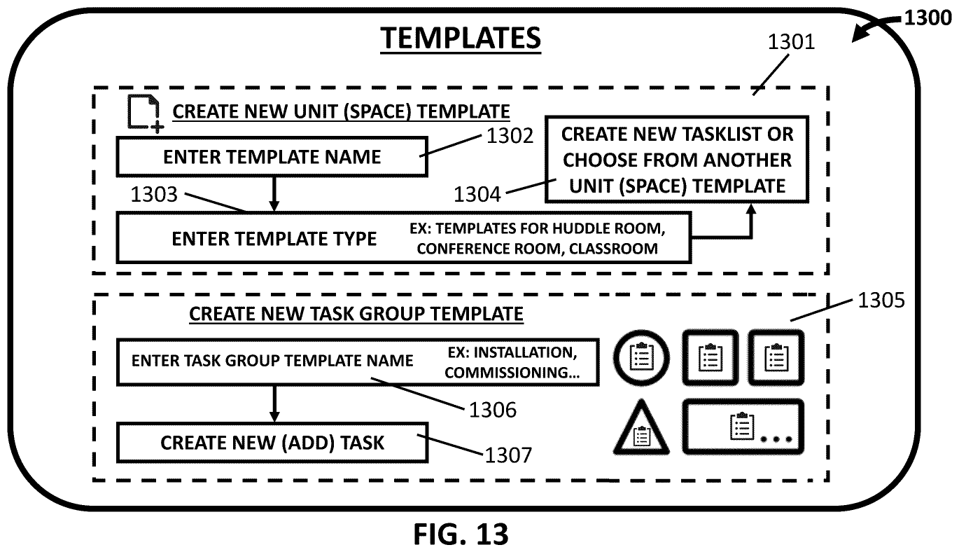

As opposed to having Milestones as a Navigation Topic under the Configuration Global Systems Menu, an alternative embodiment would allow Users to engage a Milestone configuration on/off toggle widget, which when turned “on,” would enable Users to set up how Milestones are triggered (933). As mentioned, triggers can be based on whether a Unit (Space), or a plurality of Unit(s) (Space(s)) are completed, or some threshold (e.g., every successive 25% completion triggers a milestone).
18) Templates (Ref. FIGS. 2, 7, 12, and 13): One of the titles on the Global Systems Menu on the preferred embodiment of the Portal (200) is Templates, which allows Project Managers (701) or eligible Team member Users to efficiently build a robust work plan for a Project regardless of its scale, by leveraging existing definitions from the Platform's pre-defined Template Database and applying them to the Project work plan. Furthermore, new Templates can also be created for other future Projects.

The preferred embodiment of the present invention provides for two different types of Templates. One relates to Units (Spaces) and the other pertains to Task Groups.

Selecting the Units (Spaces) Navigation Topic on the preferred embodiment of the Portal (200) has the UI show either a scrollable window or non-scrollable window of a list of Unit (Space) Templates. In the preferred embodiment of the Platform, the main UI page for Unit (Space) Templates can have the following labels or widgets:
A) Number of Pre-defined Unit (Space) Templates.
B) String search bar for finding an existing Unit (Space) Template by Template name or title, which dynamically filters to show just the displayed Template titles on the main Unit (Space) Templates page as the title is being typed.
C) An “Add Unit (Space)” Template (1301) to the Template repository stored on the Platform's Database. After this button is clicked, an embodiment can first open a dialog to define the new Unit (Space) Template name (1302). Then an embodiment can query the User to classify the template by type of Unit (Space) the Template applies for (1303) (e.g., Huddle Room, Conference Room, Classroom, etc.). Following this, an embodiment can query the User to create a new Task list (1304) one individual task at a time. In the preferred embodiment, an “Add Task” widget allows Individual Tasks to be added to the corresponding Unit (Space) Template; the preferred embodiment has this “Add Task” widget placed on the same frame as the corresponding Unit (Space) Template. Alternative to creation, an embodiment can have the Task list be based on that from an existing Unit (Space) Template (1304).

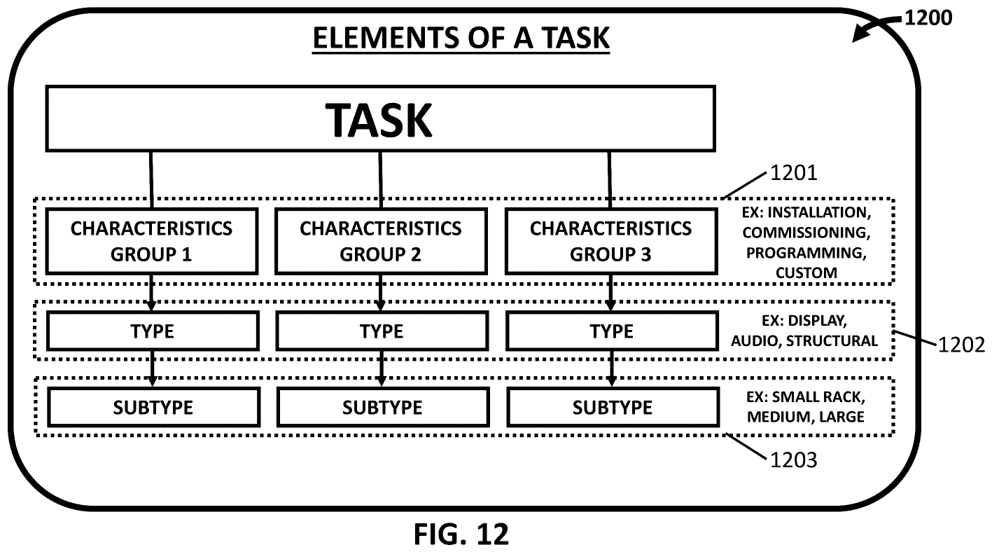

Selecting the Task Groups Navigation Topic (1501) under the Templates Global Systems Menu option on the preferred embodiment of the Portal (200) has the UI show either a scrollable window or a non-scrollable window of a list of Task Groups (1201) (see FIG. 12), which are Task lists for a specific purpose. For an A/V system integration application embodiment, examples of specific purposes comprise Installation, Commissioning, Programming, Deinstallation, Administrative, and more. Each Task Group can be tagged with one or more types (1202). For example, Installation can be typed into Installation of a display, audio system, structural component, etc. Each Task Group can be further classified into Subtypes (1203). In the preferred embodiment of the Platform, the main UI page for Task Groups can have the following labels or widgets:
A) Number of Task Groups Defined on the Platform.
B) String search bar for finding an existing Task Group Template by Template name or title, which dynamically filters to show just the displayed Template titles on the main Task Group Templates page as the title is being typed.
C) An “Add (Task) Group” Template (1305) to the Template repository stored on the Platform's Database. After this button is clicked, an embodiment can first open a dialog to define the new Task Group Template name (1306). In the preferred embodiment, an “Add Task” widget allows Individual Tasks to be added (1307) to the corresponding Task Group Template; the preferred embodiment has this “Add Task” widget placed on the same frame as the corresponding Task Group Template. Once this Task Group is defined, eligible Users can select the Templates title of the Global Systems Menu, click on Task, and define the Individual Tasks that make up the Task Group.
19) Reporting (Ref. FIGS. 3 and 14A-J): The preferred embodiment of the Platform has a multi-faceted Reporting Module (1400) to assist with Enterprise-wide (Vendor and Customer) and internal process monitoring and record keeping of as many salient aspects of Project fulfillment as possible. Embodiments of the Platform can have up to three styles of automated, customizable, targeted Reporting (1401): Daily Report (1410), Current Snapshot Report (1420), and Project Completion Report (1430). Embodiments of the Platform can have Reporting tied to Timeline-specific (1402) (e.g., On Time, Delayed, End date, Delay days) assigned to a Project or achieved Milestones (not shown in the figures). The status (e.g., Completed, Open, In-progress, Overdue, End date, Delay days) and other specifics of Action Items (1403) that were defined and updated on the Platform during the Project can be reported. Optional embodiments can tie Action Items to automated Notifications if the status rises above a certain threshold. Embodiments of the present Platform also have provisions to record, store on its Database, and display Feedback (1404) such as a Task change order form along with reasons for the change and the final close-out comment from an eligible Team User, which in certain embodiments can be extracted and placed on the final Project Completion Report (1430). Embodiments of the Platform can record when a User was last logged into the Platform and when a MA (300) User last synchronized with the Platform's Database (1405).

The Budget Navigation Topics Submenu option allows Users to scan a scrollable window of Project names with columns identifying the Project status (e.g., Completed, Open, In-progress, Overdue, etc.), onsite Lead Tech, and how many Budget line items are within the pre-defined range of Green, Yellow, and Red that will go into Reports (1410, 1420, 1430), categories which will be described later under Configuration. Embodiments of the Platform list the number of Projects, and a string search bar for finding an existing Project name or title, which dynamically filters to show just the displayed Project names as the title is being typed.

Reports (1410, 1420, 1430) may also include budget information. The sequence of how the content is added to Reports follows the Configuration of the type of Budget line items, which will be described later in the present disclosure. Once defined, instances of these Budget line items can be added to the Project in question.

Report automation embodiments of the Platform that take care of the multiple steps shown in FIGS. 14C, 14G, and 14J can be executed by code in the Platform that in turn executes either routines built into the Platform application's code or separate programs not built into the Platform's application. Regarding the latter, if the other programs are in what is known as compiled “executable” form (e.g., C, C++, etc.), then embodiments of the automation would invoke these executables using the same commands and optionally command arguments that an individual would invoke manually on the operating system's shell's command line or command prompt. Alternatively, certain non-compiled scripts (e.g., written in Python®, Perl®, TclTk, etc.) can carry out the multiple steps in FIGS. 14C, 14G, and 14J using separate code interpreters but invoked from routines within the Platform's application. Another alternative embodiment would have the Platform's application invoke semi-compiled utilities (like those written in Java® bytecode) and an interpreter to interpret the compiled intermediate form.

A) Daily Report (1410) (Ref. FIGS. 14B-C and 17): Large projects require frequent and regular progress report updates to assure everyone with a vested and active interest understands their Role in fulfilling the Project objectives, whether progress is trending toward timely completion, and if issues arise, that it is promptly visible to relevant personnel and project Platform Users.

FIG. 14B shows an example of a preferred embodiment of the Daily Report (1410) that can be in a number of formats comprising a PDF, an image format such as JPEG, TIFF, PNG, BMP, rich text, or a specific word processor file format. Embodiments of the Daily Report's header (1411) can include information comprising a document indicating “Daily Report,” Vendor and Customer identifying information and logos, Project title, Vendor contact information and website address, the lead Team member(s) on the Vendor-side, and Project address. In the body of the Daily Report (1410), embodiments can indicate the names of the following comprising the Vendor-side Team, the lead Team member on the Vendor side, and the Customer-side Team (1412). Embodiments can additionally provide a brief description of the completed Units (Spaces) with embodiments listing information per Unit (Space) (1413) comprising the Unit (Space) name, type of Task or Task Group fulfilled in each Unit (Space), and a Document jump link or web hyperlink to further details for each Unit (Space). Embodiments of the Daily Report (1410) can additionally show the list of Tasks or Task Groups under various status monikers such as In Progress, On Hold, Canceled, Open Action Items of certain chronological sorting (1414). Additional information like Start and End Dates, associated Units (Spaces), Budget line items, overall Budget expenditures, and Milestones (not shown) can also be added. Embodiments of the Daily Report (1410) can also incorporate the day's Comments (1415) starting with the most recent on top, where each comment identifies the Team User who wrote the particular comment and any priority assignment if the matter requires future attention. The preferred embodiment of the invention closes off the Daily Report (1410) with a total Project-wide list of Tasks that have been Completed, In Progress, Open, On Hold, and Canceled (1416). Other embodiments may include other status monikers. Embodiments can also have a number in each of the total Project-wide status monikers, a percentage of the total, or a graphical indicator.

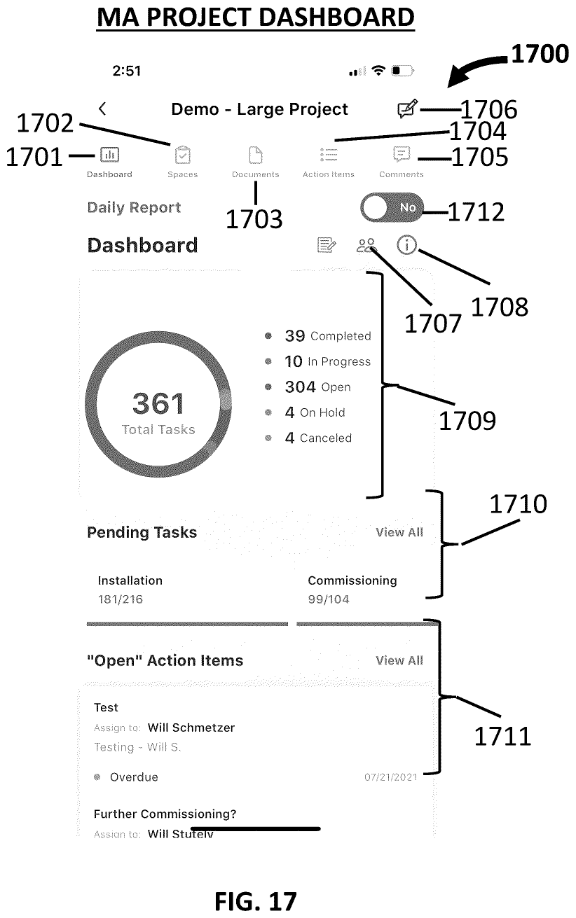

The Platform has provisions to automatically disseminate Daily Reports (1410) to eligible Users of the Enterprise who should be apprised of the Project's daily progress. The process, as shown in FIG. 14C, is initiated by a User or a type of a “go-ahead” Boolean tag for the Platform to then execute a series of steps to generate and deliver the Daily Report (1410) for a given Project. Hence, if the eligible User (e.g., Lead Technician on the A/V system integrator application embodiment) clears (14101) the Platform to prepare and send the Daily Report (1410), then steps 14103-14107 are executed. The preferred embodiment of the present invention has a toggle (1712) on the MA (300) where the eligible Vendor-side user can activate or deactivate the automated generation and dissemination of Daily Reports (1410) (see FIG. 17). If off or the feature is not cleared to be active (14102), then nothing further will happen with respect to this Daily Report (1410) functionality for a given Project. However, if the answer is “yes,” the Platform queries the Platform's Database (14103) for a specific pre-defined and/or User-defined set of information fragments that can succinctly define the Project's daily progress. Targeted extracted information is then mapped (14104) to their destination fields in the formatted Daily Report (1410). The process then includes file-size compressing (14105) the Daily Report (1410) into a compact archive format like portable document format (PDF). Then the Platform automatically composes an Email and attaches this Daily Report (1410), and Emails (14106) to designated recipients at the end of the day, or business day, or a designated subset of days as long as the Project status is active and not completed. The list of designated recipients is pre-determined. After the Daily Report (1410) is sent, the Platform then archives (14107) the Daily Report (1410) just sent into a repository of Daily Reports (1410) for a given Project. Alternative embodiments can instead have the archiving process occur in steps (14104) or (14105). In addition, the Platform Daily Reporting GUI has some widgets that allow eligible Users to access, view, edit, delete, or download a specific archived Daily Report (1410) from the Platform's Database.

As previously suggested, the notion of “Daily” in Daily Report (1410) can be replaced by periodic in alternative embodiments. For example “Weekly Report,” “Monthly Report,” etc. or periodic reports at irregular time intervals can be executed using the process outlined here.

B) Current Snapshot Report (1420) (Ref. FIGS. 14D-G): While a Project is In Progress, the Platform has provisions, with activation of one button widget, to generate and view a Project's Current Snapshot Report (1420). This feature is useful for instances such as when a replacement Project Manager is introduced midway into the Project and requires an efficient means to “get up to speed” on the Project's status.

FIGS. 14D-F shows an example of a preferred embodiment of the Current Snapshot Report (1420) that can be in a number of formats comprising a PDF, an image format such as JPEG, TIFF, PNG, BMP, rich text, or a specific word processor file format. Embodiments of the Current Snapshot Report's header (1421) can include information comprising a document indicating “Current Snapshot Report,” Vendor and Customer identifying information and logos, Project title, Vendor contact information and website address, the lead Team member(s) on the Vendor-side, and Project address. In the body of the Current Snapshot Report (1420), embodiments can indicate the names of the following comprising the Vendor-side Team, the lead Team member on the Vendor side, and the Customer-side Team (1422). Embodiments can additionally provide a brief description of the completed Units (Spaces) with embodiments listing information per Unit (Space) (1423) comprising the Unit (Space) name each with a list of Task progress that has been Completed, In Progress, Open, On Hold, and Cancelled. Other embodiments may include other status monikers. Embodiments can also have a number in each of the total Project-wide statuses, a percentage of the total, or a graphical indicator. Additional information like Start and End Dates, associated Units (Spaces), Budget line items, overall Budget expenditures, and Milestones (not shown) can also be added. The preferred embodiment of the Platform has a hyperlink to the Portal (200) where one can view and download Project Pictures that visually document progress (1424). Other embodiments of the Current Snapshot Report (1420) can also incorporate the cumulative Action Items (1425) and Comments (1426) starting with the most recent on top, where each Comment identifies the Team User who wrote the particular comment and any priority assignment if the matter requires future attention. For A/V and security system integrator application embodiments as well as services that involve equipment installation, the preferred embodiment of the Current Snapshot Report (1420) has a catalog matrix of registered installed equipment for each Unit (Space) (1427), where each row of information can comprise the Unit (Space), device model name or part ID number, device serial number, device IP address if applicable, device MAC address if applicable, and other information. The preferred embodiment of the invention closes off the Current Snapshot Report (1420) with a total Project-wide list of Tasks that have been Completed, In Progress, Open, On Hold, and Canceled (1428). Other embodiments may include other status monikers. Embodiments can also have a number in each of the total Project-wide status monikers, a percentage of the total Tasks fulfilled, or a graphical indicator.

The process, as shown in FIG. 14G, of generating and downloading, viewing, and/or disseminating a Current Snapshot Report (1420) is initiated by an eligible User. This can be permitted by the Platform after the Project has started and a specific report-generating Milestone criterion/criteria were achieved and the on/off toggle (932, 933) to trigger generating/disseminating is set to “on” or an eligible User has requested a Current Snapshot Report from Platform (14201). If none of the criteria in (14101) is satisfied, then no further action is carried out (14202) with respect to the specific Project's Current Snapshot Report (1420) functionality for a given Project. However, if the answer is “yes,” then the Platform queries the Platform's Database (14203) a specific pre-defined and/or User-defined set of information fragments that can succinctly define the Project's current cumulative progress. Targeted extracted information is then mapped (14204) to their destination fields in the formatted Current Snapshot Report (1420). The process then includes file-size compressing (14205) the Daily Report into a compact archive format like portable document format (PDF). Following this, the Platform displays the Current Snapshot Report (1420) on the Platform hosting device's display and/or downloads Snapshot Report from Platform's Database onto the designed storage location (14206). An alternative embodiment of (14206) has the Current Snapshot Report (1420) distributed to eligible Users.

C) Project Completion Report (1430) (Ref. FIGS. 5, 6, and 14H-J): FIG. 14H shows an example of a preferred embodiment of the Project Completion Report (1430) that can be in a number of formats comprising a PDF, an image format such as JPEG, TIFF, PNG, BMP, rich text, or a specific word processor file format. Embodiments of the Project Completion Report's header (1431) can include information comprising a document indicating “Project Completion Report,” Vendor and Customer identifying information and logos, Project title, Vendor contact information and website address, the lead Team member(s) on the Vendor-side, and Project address. In the body of the Project Completion Report (1430), embodiments can include Final salient Comments written by an eligible User on the Vendor side (1432a). The Final Comments are entered on a dialog (1432b) on the Portal (200). Embodiments of the preferred embodiment indicate the names of the following comprising the Vendor-side Team, the lead Team member on the Vendor side, and the Customer-side Team (1433). Embodiments may also include a section devoted to the Units (Spaces) worked on, the success rate of completing tasks in each Unit (Space), and a list of the Unit (Space) names worked on (1434). The preferred embodiment of the Project Completion Report has a hyperlink to the Portal (200) where one can view and download all project Documents, Pictures, Action Items, and Comments (1435). For A/V and security system integrator application embodiments as well as services that involve equipment installation, the preferred embodiment of the Project Completion Report (1430) has a matrix catalog of registered installed equipment for each Unit (Space) (1436), where each row of information can comprise the Unit (Space), device model name or part ID number, device serial number, device IP address if applicable, device MAC address if applicable, and other information. Budget line items, overall Budget expenditures, and Milestones (not shown) can also be provided in the Project Completion Report (1430). The preferred embodiment closes off the Project Completion Report (1430) with a standard parting message (1437) where embodiments of the Platform can also include a hyperlink to a web address and/or contact information that eases the process to obtain price quotes on future Projects.

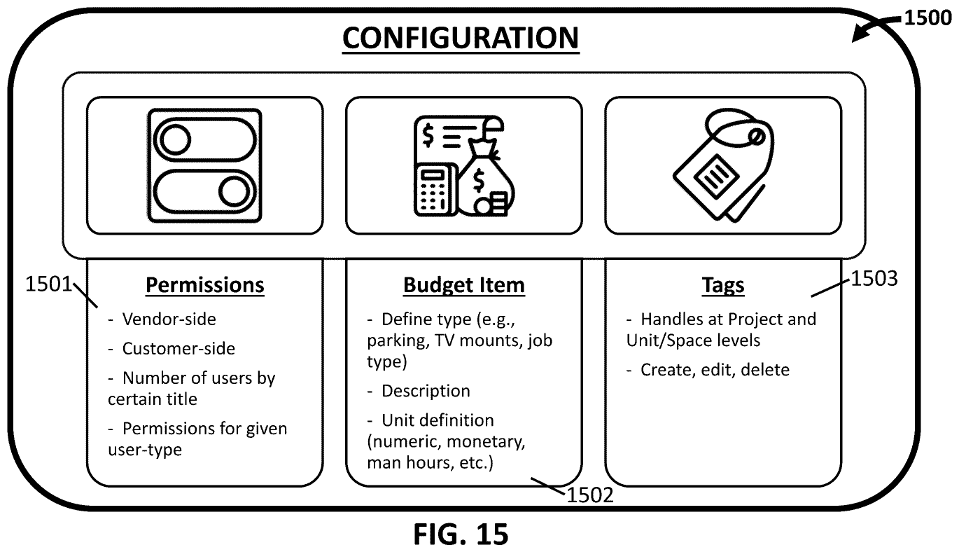

When an eligible Team User signs off (505, 603) or declares a Project completed on the Platform's MA (300), this triggers a chain of actions that ultimately leads to the generation, dissemination, and archiving of the Projection Completion Report (1430). The process begins with the eligible Project lead (e.g., Lead Technician in the A/V system integrator application embodiment) declaring the Project has been completed (14301). If not (14302), then no further action is carried out with respect to the Projection Completion Report (1430) functionality for a given Project. If the answer is “yes,’ then the Platform queries the Customer to concur on satisfactory Project completion (14301) for which the answer can be inputted by the hosting device of either the Portal (200) or MA (300) and recorded by the Platform's application. If all parties sign off on satisfactory Project completion and, for certain embodiments, a signoff form has been uploaded (14301), then the Platform opens a dialog (1432b) for the lead Team User to enter salient close-out remarks reflecting on the Project and attaching any recommendations (14303). An embodiment of this dialog (1432b) is shown in FIG. 14I from the Portal (200). Alternative embodiments leave the scope open for close-out remarks to be written in by a designated User in the field using the MA (300). This step (14303) is optional. The close-out comments, if any, are retrieved by the Platform for later placement in the Project Completion Report (1430). Next, a specific pre-defined set of information fragments that summarize the Project's (“Project” is equivalent to “P.” in FIG. 14J) completed milestones, team members, and other salient information are queried from the Platform's Database (14304). Targeted extracted information is then mapped (14305) to their destination fields in the formatted Project Completion Report (1430). The process then includes file-size compressing (14306) the Project Completion Report (1430) into a compact archive format like portable document format (PDF). Then the Platform automatically composes an Email and attaches this Project Completion Report (1430), and Emails (14307) to designated recipients at the end of the day, or business day, or a designated subset of days as long as the Project status is active and not completed. The list of designated recipients is pre-determined. After the Project Completion Report (1430) is sent, the Platform then archives (14308) the Project Completion Report (1430) just sent into a repository of Project Completion Reports (1430). Alternative embodiments can instead have the archiving process occur in steps (14305) or (14306). In addition, the Platform's Project Completion Reporting GUI has some widgets that allow eligible Users to access, view, edit, delete, or download a specific archived Project Completion Report (1430) from the Platform's Database.
20) Configuration (Ref. FIGS. 2, 7, and 15): Before eligible Vendor-side Users add Tasks of a certain Task Group, add Team Users of a certain Role with corresponding Permissions, or a Budget line item, their definitions need to be first established under the Configuration Global Systems Menu option (1500) on the preferred embodiment of the Portal (200). Under Configuration (1500), Project Managers (701) or eligible Team member Users define types of Role-based Permissions (1501) within a Project's Enterprise (Vendor and Customer), define types of Budget line items (1502), and Tags (1503). One of the ideas behind the Configuration (1500) is, Users are able to set the parameters of different object classes, where classes for the exemplary embodiment are types of Role-based Permissions (1501), Budget line items (1502), Tags (1503), etc., so those object class definitions can be automatically inherited in instants of those objects' classes under the Projects Navigation Topics Submenu. Alternative embodiments of the Platform can include types of configurable objects different or beyond Role-based Permissions, Budget line items, and Tags.

Selecting the Permissions Navigation Topic (1501) under the Configuration Global Systems Menu option on the preferred embodiment of the Portal (200) has the UI show either a scrollable window or a non-scrollable window of a list of Team User Roles on either the Vendor-side or Customer-side of the Project's Enterprise. On the preferred embodiment, the Vendor or Customer list choice is determined by the default or User choice of buttons labeled Vendor or Customer. For an A/V system integration application embodiment, examples of Project Roles comprise Super Administrator, Administrator, Engineer, Project Manager, Lead Technician, Technician, and more. In the preferred embodiment of the Platform, the main UI page for Roles can have the following labels or widgets:
i) Number of possible Project Roles and corresponding Permissions defined on the Platform.
ii) String search bar for finding an existing Role-based Permission title, which dynamically filters to show just the displayed Role titles on the main Permissions page as the title is being typed.
iii) An “Add Permissions” or “Add Role-based Permissions” button, which gives eligible Users the ability to define new Role-based Permissions on the Platform. After this button is clicked, an embodiment can first open a dialog to provide the new Project Role name. The following dialog can list all the possible topics where actions can be performed on the Platform followed by a list matrix comprising three types of actions that act as headers on a column: View, Create, and Delete. For the A/V system integration application embodiment, the list of possible topics can comprise a list including Action Item, Comment, Customer, Dashboard, Feedback, Project, Reporting, Permissions Definition, Task Group Definition, Template Definition, and more. The UI form on the Portal (200) then has a set of View, Create, and Delete checkbox controls for each topic that can be set to define the type of action permission for a given topic with the User Role Permissions set. Embodiments of the present invention can also open this dialog when viewing and editing a current registered Project Role-based Permission set, by clicking a specific frame corresponding to one Role-based Permission set.

Separate from the Vendor-side and Customer-side listings is a Project Roles-based Permissions page(s) where all the Enterprise's Project Role-based Permissions titles can be shown and sorted in rows, where each row has information pieces defining each Role-based Permission set placed under columns titled:
i) “Title” of the Project Role (e.g., Engineer, Technician) and the entire list can be sorted by alphanumerical—ascending or descending order of the Title string.
ii) In the preferred embodiment, a button widget labeled “+” expands the frame corresponding to a specific Project Role to list all Users defined under the specific Project Role.
iii) “Users” which are the actual registered Platform Users under the corresponding Title. The preferred embodiment displays up to a specific allowed number of icon tags of Users (e.g., colored shapes with first, last, or first and last initials) defined by the corresponding row. If the number of Users exceeds the number of User icons shown, then a number indicates the count not shown (e.g., “+21” means 21 more Users with the same Project Role).
iv) “Created By” shows which eligible Platform User created the corresponding Role and the entire list can be sorted by alphanumerical—ascending or descending order of the name of the User who created the specific Role-based Permission set.
v) “Created On” is another attribute of the Project Role-based Permissions that can be stored and displayed on the Platform, which mentions the date stamp the specific Project Role-based Permission was created. The entire list can be sorted by chronological—ascending or descending order of the “Created On” date.

Selecting the Budget Navigation Topic (1502) under the Configuration Global Systems Menu option on the preferred embodiment of the Portal (200) has the UI show either a scrollable window or a non-scrollable window of a list of types of Budget line items. The provisions here are part of the “Budget Management Module.” However, compared to the Budget Navigation Topic (922) under the Project Global Systems Menu choice—described in Section 17K of the present disclosure—which pertains to a specific Project with allocation, notification thresholds, and usage are defined and monitored, the Budget line items shown here under Configuration contain only general parameters (name or type, description, unit of measure, numeric or monetary, and if numeric what type of unit) and are available Platform-wide. Thus, Budget line items created under Configuration (1502) contain general parameters that a specific Project inherits when a Budget line item of that type is used and where Project-specific values and thresholds are defined under the separate Project Global Systems Menu choice/Budget Navigation Topic.

There are also other distinctions between the Configuration Global Systems Menu choice—Budget Navigation Topic (1502) and Project Global Systems Menu—Budget Navigation Topic (922). In the preferred embodiment of the Platform, the main UI page for Budget Navigation Topic (1502) can have the following labels or widgets:
i) Total number of Budget line items defined Platform-wide.
ii) Budget line item string search bar that filters to the displayed names containing the typed letters on the main scrollable window as the name is being typed.
iii) Import line item that in embodiments of the Platform, can be from a Project or external file.
iv) Select Line Item.
v) Select All line items.
vi) Delete selected line items.
vii) Export line item attributes.
viii) An “Add/Edit Line Item” button that in the preferred embodiment, opens a dialog window with fields for “Line Item Name,” “Line Item Description,” type of unit (monetary or numeric), and unit of measure. Examples of Line Item Names can be: parking, trucks, installation, commissioning, programming, etc. Numeric type of units has User-defined units of measure. Example units of measure are man days, man hours, or any unit of measure defined by the User.

On the main Budget line item page(s) (1502), where multiple Budget line items arranged along sorted rows can be shown, the information pieces for each Budget line item are placed under columns titled:
i) Budget line item name.
ii) Description of Budget line item.
iii) Unit: Monetary or Numeric.
iv) Unit of Measure: If numeric, the unit of measure can be arbitrary, as just discussed.
v) Action: Embodiments can include delete, copy, edit, etc. of the Budget line item on the same row.

Basically, the main page provides a quick view of each and up to several Budget line item parameters. The field values in the main Budget line item page(s) can be directly edited without having a full Add/Edit Budget Line Item dialog open. By engaging the field of interest by, for example, double-left mouse clicking while the UI pointer is hovering above the field of interest, the Platform will know to switch to a quick edit mode, and the User can directly select/type an edited value or a minimal UI dialog pops up with widgets comprising +/−buttons and editable string fields that the User can interact with. A save or confirm widget can exit the quick edit mode for the field of interest.

Selecting the Tags Navigation Topic (1503) under the Configuration Global Systems Menu option on the preferred embodiment of the Portal (200) has the UI show either a scrollable window or a non-scrollable window of a list of Tags. In the preferred embodiment of the Platform, the main UI page for Tags can have the following labels or widgets:
i) Number of possible Project Tags and Space Tags on the Platform.
ii) String search bar for finding an existing Tag title, which dynamically filters to show just the displayed Tag titles on the main Tags page as the title is being typed.
iii) An “Add Tag” button, which gives eligible Users the ability to define new Project or Space Tags on the Platform, depending on which Tag mode the UI page is on. After this button is clicked, an embodiment can first open a dialog to provide the new Tag name and identifying tags, keywords, handles, or identifiers that aids in database sorting, searching, retrieval, or categorization.

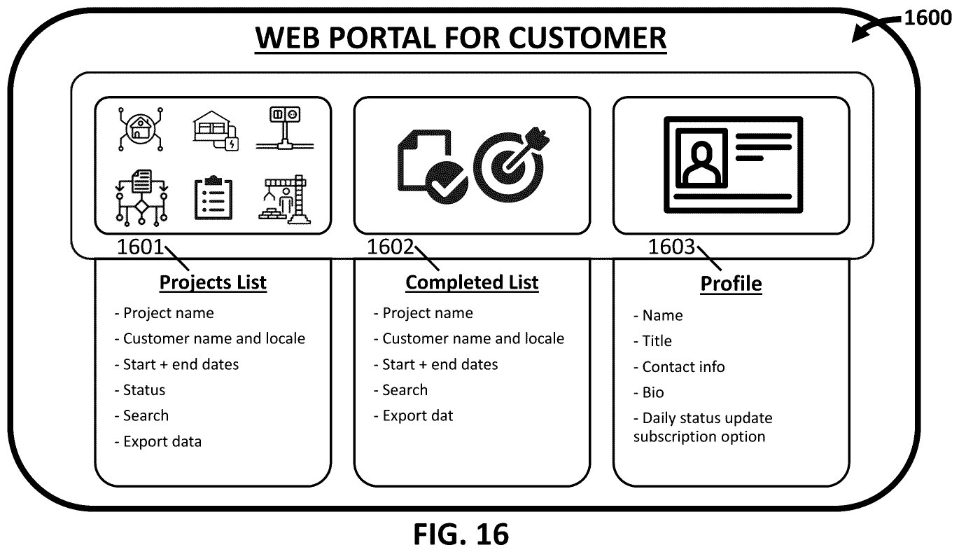

On the main Tags page(s) (1503), where multiple Tags arranged along sorted rows can be shown, the information pieces for each Tag are placed under columns titled:
i) Tag name.
ii) Name of User who created the Tag.
iii) Date when the Tag was created.
iv) Action: Embodiments can include delete, copy, edit, etc. of the Tag on the same row.
21) Customer Accessible Embodiment of Web Portal (Ref. FIG. 16): After a User on the Customer-side of the Enterprise successfully logs into the Portal (200), the Portal (200) presents a Customer-specific UI (1600). Compared to the Vendor embodiment of the Portal's (200) UI, the preferred embodiment shows on the list of Project(s) (1601) under the Customer's account. The list of completed Projects (1602) can be shown by pushing a button widget on the main page of the UI (1600) labeled “Completed.”

The entire list of Customer projects can be sorted by alphanumerical—ascending or descending order of the Project string. In the preferred embodiment of the present invention, the main UI page for Project User Roles can have the following labels or widgets:
A) Number of Projects.
B) String search bar for finding a Project name, which dynamically filters to show just the displayed Project names on the main Customer-specific Portal page (1600) as the name is being typed.

Each Project in the list has the following fields of information:
A) “Customer” Name and the entire list can be sorted by alphanumerical—ascending or descending order of the Customer string.
B) “State” or geographic location and the entire list can be sorted by alphanumerical—ascending or descending order of the State or location string.
C) “Start Date” of the Project and the entire list can be sorted by chronological—ascending or descending order of the Start Date.
D) “End Date” if applicable of the Completed Project and the entire list can be sorted by chronological—ascending or descending order of the End Date.
E) “Status” of the Project's progress.
F) “Export Data” button which opens a dialog to export Project data.

A widget to open a dialog to view and edit the Platform's User profile (1603) is also accessible in preferred embodiments of the Platform and was described earlier in the section titled “Two-Tier Menu and Curated Titles/Topics.”
22) Users: Selecting the “User” title from the Global Systems Menu of the preferred embodiment of the Portal (200) has the UI show either a scrollable window or non-scrollable window of a list of Vendor-side Users. In the preferred embodiment of the Platform, the main UI page for Users can have the following labels or widgets:
i) Number of Vendor-side User Accounts Registered in the Platform.
ii) String search bar for finding a Vendor-side Username or their registered Email, which dynamically filters to show just the displayed User on the main User page as the name or Email is being typed.
iii) An “Add User” button, which gives eligible Users the ability to add a new Vendor-side Platform User to the Platform's User registry. After this button is clicked, an embodiment can first open a dialog with fields comprising the User's name, contact information, an upload User photo widget or previously loaded photo of the User, Role and corresponding Permissions, Job Title, and geographic locale of work or living address.

Once added, embodiments can have widgets so that another new User can be added. After all new User(s) are added, a widget on the dialog allows confirmation on registration of the new User(s) profile(s) on the Platform's Database. Embodiments of the Platform allow User profile edits by double-clicking on the frame for the User in question.

On the main Users page(s), multiple Users can be shown and sorted in columns titled:
i) “Name” of the User and the entire list can be sorted by alphanumerical—ascending or descending order of the Name string.
ii) “Status” of the User, which an embodiment of the present invention, can include a list of labels comprising “Active,” “Inactive,” “Suspended,” and more. The entire list can be sorted by alphanumerical—ascending or descending order of the Status label string.
iii) Job “Title” of the User, and the entire list can be sorted by alphanumerical—ascending or descending order of the Title label string.
iv) “Phone” number of the User and the entire list can be sorted by numerical—ascending or descending order of the telephone number.
v) “Email” of the User, and the entire list can be sorted by alphanumerical—ascending or descending order of the Email label string.
vi) Role-based Permissions of the User, and the entire list can be sorted by alphanumerical—ascending or descending order of the Role label string.
vii) “Created On” date that the User was added to the Platform's Database and the entire list can be sorted by chronological—ascending or descending order of the “Created On” date.
vii) “City” that the User works or lives in and the entire list can be sorted by alphanumerical—ascending or descending order of the City label string.
viii) Action: Embodiments can include delete, copy, edit, etc. of the User on the same row.
23) Vendor-side Navigation Topics Submenu and Project Dashboard of MA (Ref. FIGS. 2, 3, 5, 14B, and 17): The preferred embodiment of the MA (300) for Vendor Team Users as it appears when the “Dashboard” Navigation Topics Submenu option (1700) is selected is shown in FIG. 17. The preferred embodiment of the Platform has the Navigation Topics Submenu along the top of the mobile device's display. However, it can be arranged along any edge of the displayed area. The Navigation Topics Submenu choices are Dashboard (1701), Units (Spaces) (1702), uploaded Documents (1703) that are germane to the Project completion, Action Items (1704), and Comments (1705). Each of the menu items has been elucidated before in the sections explaining the Portal (200). The UI window shown in FIG. 17 may have embodiments that are a scrollable window.

The icon with a balloon and pencil drawing (1706) is a button that when pressed takes the MA (300) to a page showing Feedback (307) on the MA (300). The icon depicting two people (1707) is a button widget that when pressed shows the Team members assigned to the Project. Embodiments can show just the Vendor Team members or vendor and Customer Team members. The widget labeled “i” (1708) when pressed directs the MA (300) to a screen with more Project descriptions in a custom text field.

The top of the Dashboard shows the Task Status Pane (1709), which in the presented embodiment, comprises a combination of graphical and text conveyance of the total number of tasks assigned to the Project, color-keyed proportional arc length indication along the ring of the total number of tasks fall into one of the status monikers: “Completed,” “In Progress,” “Open,” “On Hold,” and “Canceled.” Other Dashboard embodiments can have additional, less, more, or different monikers. The status monikers are also written out in the presented embodiment and show the number of tasks falling into each moniker.

In the preferred embodiment of the Platform, the Pending Tasks Pane or portion of the GUI window (1710) with a collapsed view synopsis of Tasks that fall under specific Task Groups, with a fractional number indication of the proportion of Tasks completed compared to the total. The preferred embodiment has a “View All” widget that when pressed, expands the pane to show the rest of the Task Groups. This window (1710) may have a scrollable pane embodiment.

Embodiments of the Platform may also have an “Open Action Items” Pane (1711) that shows outstanding Action Items, where each Action Item information capsule contains the Action Item Title, Vendor Team members the Action Item is assigned to for resolution, short text notes, an Action Item Priority and Status Moniker (e.g., “Overdue”), and Action Item record creation date.

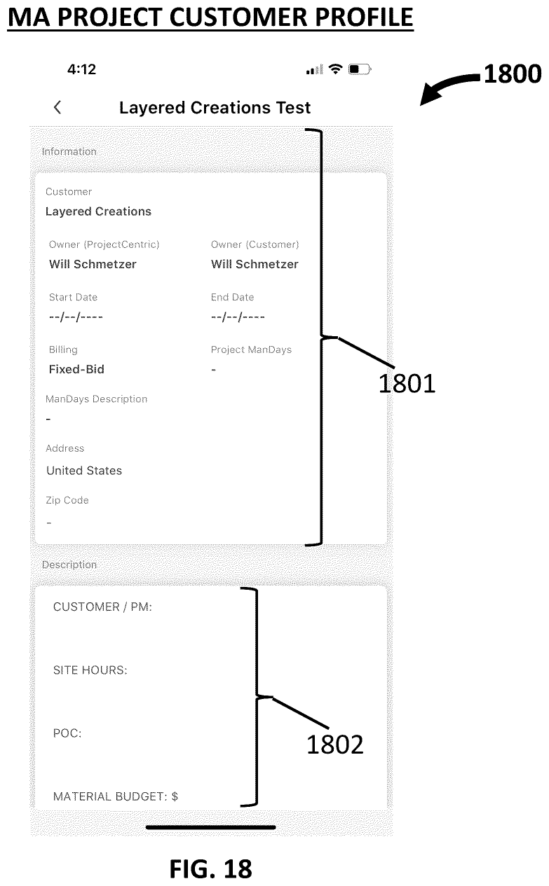

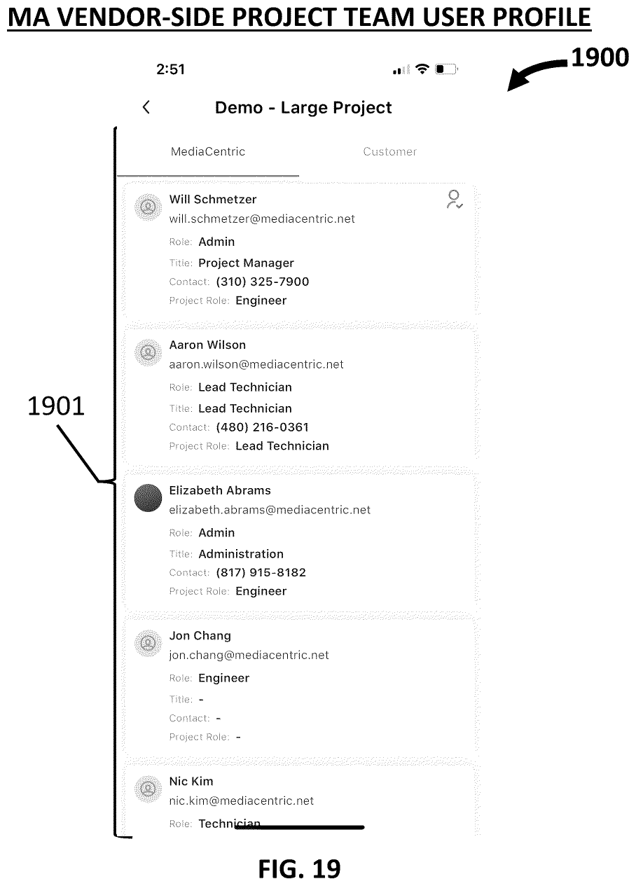

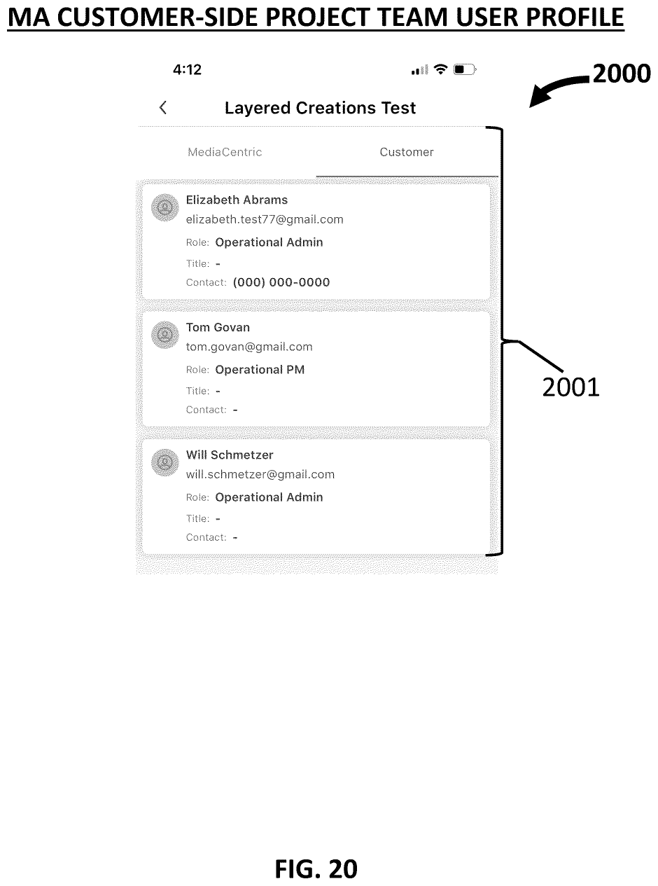

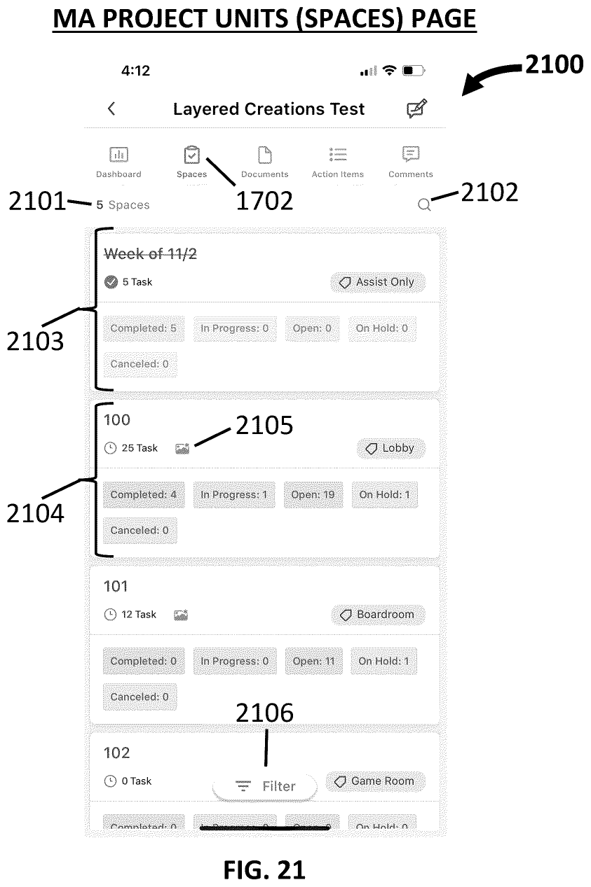

Embodiments of the MA (300) may also have an on/off toggle (1712) to enable Daily Reports (1410) to be automatically generated. Embodiments of the MA (300) may only show this toggle (1712) for eligible Vendor-side Users, for example, a Lead Technician (501).
24) Project Information on MA (Ref. FIGS. 3, 17, and 18): When the “i” icon button (1708) is pressed on the preferred embodiment of the MA (300) implementation, the screen in FIG. 18 (1800) is shown. Embodiments can show any type of pertinent information, but for the preferred embodiment, as applied to A/V system integrator usage, the top-most pane has Information (1801) comprising the customer company name, the “owners” on the Vendor and Customer side, Start and End Dates, Billing option, anticipated Man-hours to complete the Project, and geographic location of the Project site. The bottom pane covers the Description (1802) and has a list of information fields comprising the name of the Project Manager on the Customer-side, Site Hours, Point of Contact, and Material Budget.
25) Team User Profiles on the MA (Ref. FIGS. 3, 19, and 20): FIGS. 19 and 20 show the MA (300) displaying the Team Users (1900 and 2000) from both the Vendor (1901) and Customer (2001) sides assigned to the Project, respectively. The preferred embodiment of the present invention shows the Team User's Name, Email, Role-based, Title, and Contact Telephone Number.
26) Card View of Project Unit (Space) Status on the MA (Ref. FIGS. 3 and 21): FIG. 21 shows the preferred embodiment of the MA on the Units (Spaces) Navigation Topics Submenu option (2100) in Card View on a scrollable window. This screen is shown only to the Vendor Team members. Embodiments of the MA can have labels for the total number of Units (Spaces) to be serviced (2101) in the Project, and a string search bar (2102) for finding an existing Unit's (Space's) title or name, which dynamically filters to show just the displayed Units' (Spaces') titles or names on the window as the title is being typed. A Unit (Space) Task progress summary for two Units (Spaces) is shown in (2103) and (2104). The preferred embodiment of the MA (300) has the Unit (Space) Task summary showing information comprising the Unit (Space) name, total number Tasks required to complete the Unit (Space) obligations, descriptive search tags (e.g., “Assist Only” and “Lobby”), an icon of a picture (2105) indicating at least one of the Tasks assigned to the Unit (Space) requires picture proof to be uploaded to the MA (300) to satisfy Task and Unit (Space) completion, the status monikers (e.g., “Completed,” “In Progress,” “Open,” “On Hold,” and “Canceled”), and the number of tasks falling into the category of the given status moniker.

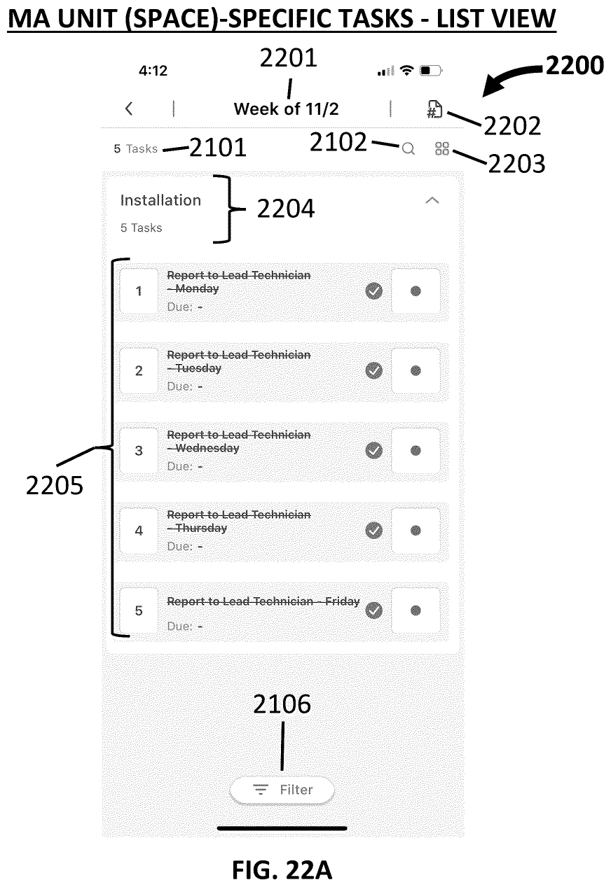

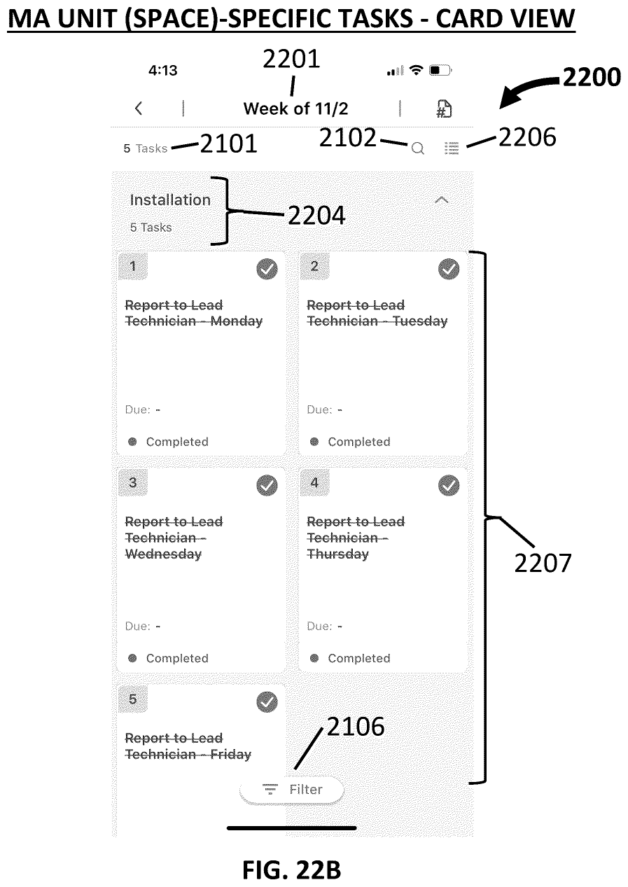

(2103) shows the Unit (Space) name with a strikethrough text feature to indicate all the requisite tasks for that Unit (Space) have been completed. In the preferred embodiment of the MA (300), the check mark next to the total number of tasks is a redundant indicator of completion. The “Filter” button widget (2106) at the bottom of the screen, when pressed, opens a dialog that shows only the Units (Spaces) that fit a display criterion/criteria.
27) Completed Project Units (Spaces) on the MA (Ref. FIGS. 3, 22A-B, and 23A-B): FIGS. 22A-B shows the preferred embodiment of the present invention's MA (300) showing one particular Unit (Space) (2200) in List and Card Views on a scrollable window, respectively. This screen is shown only to the Vendor Team members. The Unit (Space) name or scheduling period is shown at the top of the page (2201). The hash symbol and document icon on the upper right (2202) when pressed, takes the MA to the page (2400) where equipment numbers and identifiers are entered.

In List View (2206), the preferred embodiment of the MA (300) has the button widget to toggle to the Card View (2203) when pressed. Conversely, in Card View (2203), the button widget in the same location toggles to List View (2206).

(2204) is the Task Group and the total number of Tasks section. The itemized Individual Tasks are shown in (2205) and (2207). Each Individual Task block can have information like the Individual Task Name (a strikethrough indicates that Task is completed along with a separate checkmark), status moniker, and due time.

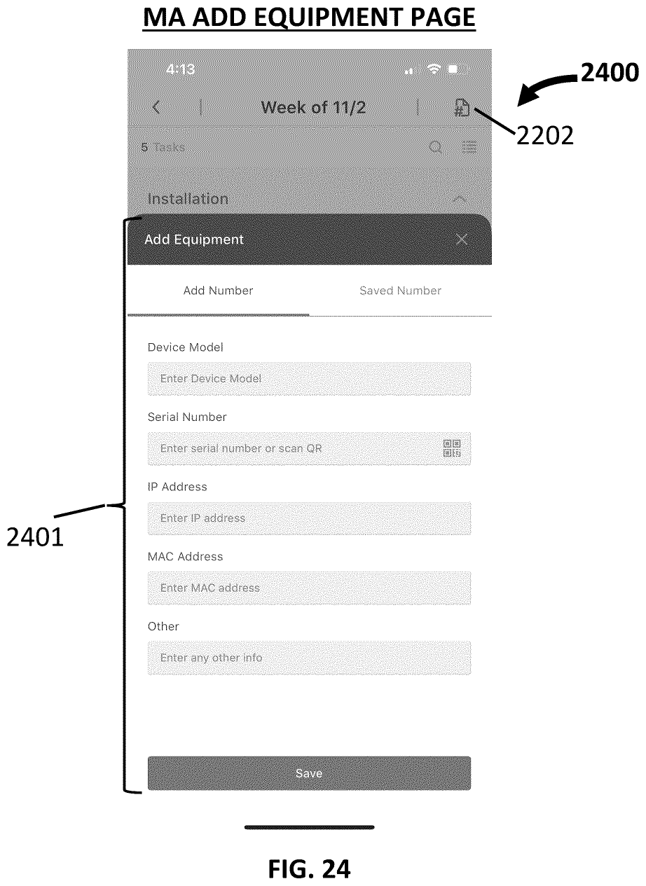

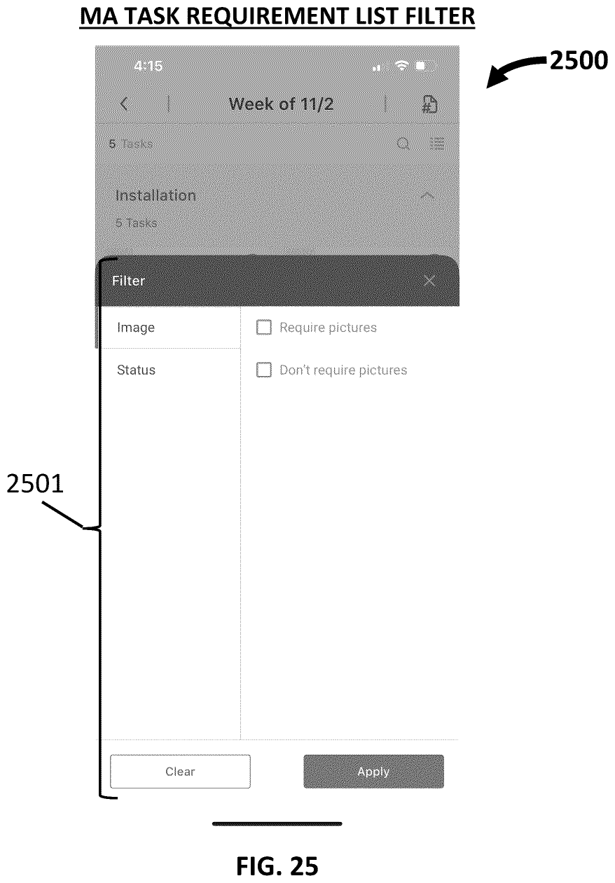

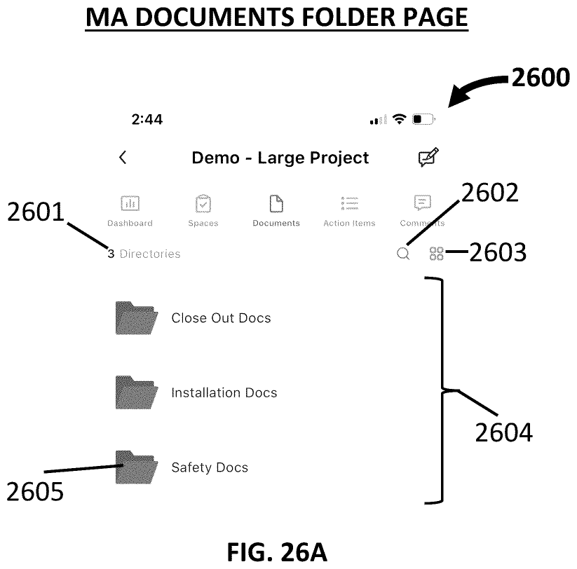

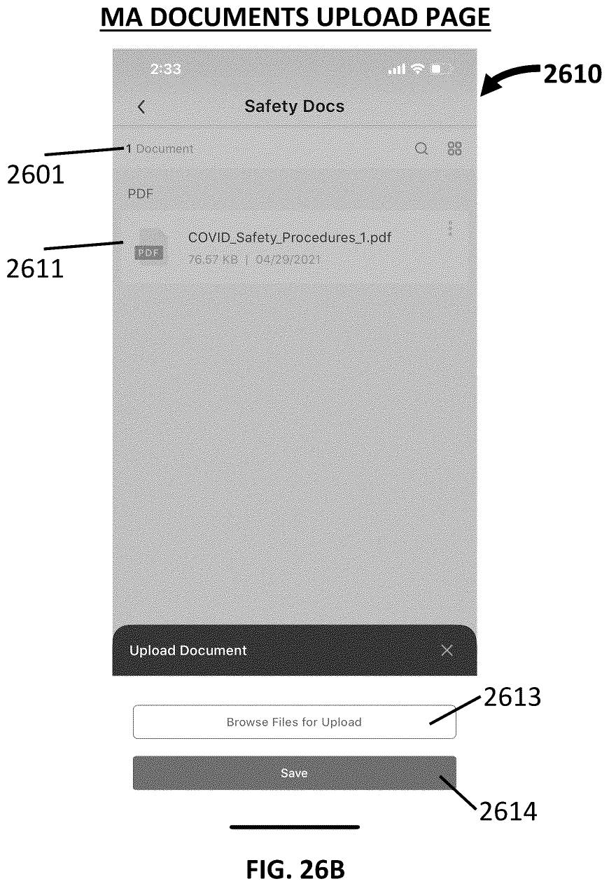

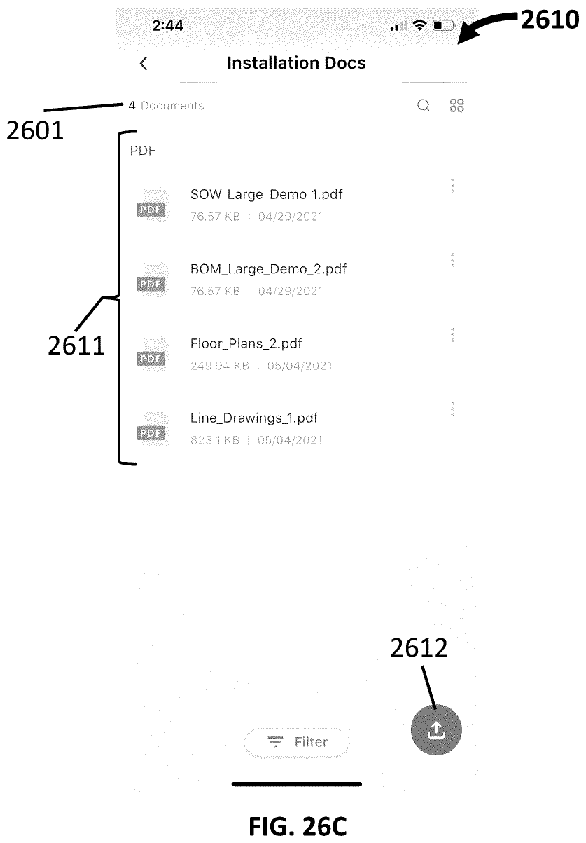

A single Task order page (2300) can be shown on the MA (300) if a single Task is selected to open. Embodiments for opening can comprise tapping or double-clicking or double-tapping the Individual Task frame.
29) Single Task Order on MA (Ref. FIGS. 3 and 23A-D): FIGS. 23A-D show the preferred embodiment of the MA (300) as seen by a Vendor Team User for a single Task order (2300). At the top is the name of the Individual Task (2301). The page can show the details of the Task Order (2302), which can comprise the Task Group classification (e.g., “Installation”), a pull-down menu to view or select the status moniker (2303, 2306), the Individual Task Order number, the Start and End Dates, the anticipated time to complete the task, Task Completion Date, Task order creator name, name of Team member the Task is assigned to, a text description, and an Add Image button widget (2305) that when pressed will open dialogs asking for permission to access the mobile device's files (2308) and take a picture or browse from a file from a Gallery (not shown). After an image attributed to this Task record is uploaded to the MA storage, the image thumbnail is shown (2307) on the gallery pane for this specific Task order.
30) Equipment Registration Page on MA (Ref. FIGS. 3 and 24): FIG. 24 shows the preferred embodiment of the MA (300) as seen by a Vendor Team User for registering installed equipment (2400). The possible pieces of identifying information are placed in fields (2401) comprising Device Model, Serial Number, IP Address, MAC Address, and any other information. Tapping or clicking the Serial Number field in this preferred embodiment opens a dialog (not shown) asking permission to take a picture or video for picture proof, bar code scanning, or QR code scanning. The MA (300) has an image recognition reader that processes photographic images taken from said the portable digital device's camera containing bar codes, QR codes, serial numbers of equipment, or other identifying information and registers said codes or numbers in the equipment registration portion of a Unit in a Project.
31) Search Filter by Requisite Task Action on MA (Ref. FIGS. 3, 21, and 25): FIG. 25 shows the preferred embodiment of the MA (300) as seen by a Vendor Team User after pressing or tapping the Filter widget (2106). The GUI screen (2500) is a dialog asking the User for the Filter criteria. The presented embodiment includes Filtering by Units (Spaces) that have Tasks requiring picture proof or not and based on the status moniker. The list of Filter criterion/criteria is particular to the application embodiments and can differ from the presented embodiment.
32) Documents Page on the MA (Ref. FIGS. 3 and 26A-26C): FIG. 26A shows the preferred embodiment of the MA (300) as seen by a Vendor Team User on the top-level Documents page (2600). The presented embodiment of the MA (300) shows the number of Document directories (2601), a search widget (2602), and a toggle widget (2603) between List (as shown, 2604) and Card views of the directory listing. The search widget (2602), when pressed, opens a search string field that dynamically filters and displays the search results as the Document name string is typed into the search bar. Embodiments of the List (2604) or Card view of the Document folders are shown on a scrollable window.

If the User selects one of the individual folders (2605), then the user is taken to the folder's contents (2610) shown in FIGS. 26B-C. The number of Documents (2601) now changes the context from the total number when on the top-level Documents page to the number of Documents in the folder being viewed. In the folder contents page (2610), embodiments of the MA (300) can list all the files. Each window frame or partition can contain files of the same type and multiple file types stored on the device hosting the MA (300), and can be displayed on the same overall window, which embodiments can include a scrollable window. Embodiments of the MA's (300) Document folder view can additionally indicate each listed file's filename (2611), file size, and an icon indicating the file format (e.g., .xls, .xlsx, PDF, .jpg, etc.). Embodiments of the MA's (300) Documents pages have widgets to initiate upload actions (2612), browse folders (2613) to find Documents, and save/upload (2614) Document(s) from locally accessed storage of the device hosting the MA (300) to the Platform's Database.
33) Vendor-Side Team Member Comments on the MA (Ref. FIG. 3): The MA (300) has provisions (not shown) for the Vendor Team User to add Comments (307). The preferred embodiment of the MA (300) lists the number of Comments and a search widget. The search widget, when pressed, opens a search string field that dynamically filters and displays the search results as text from a given Comment block is typed into the search bar.

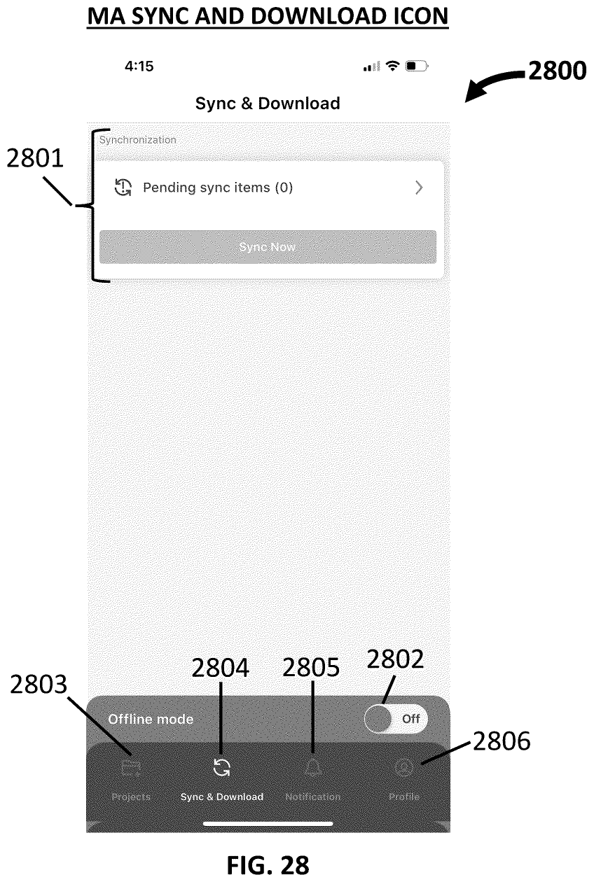

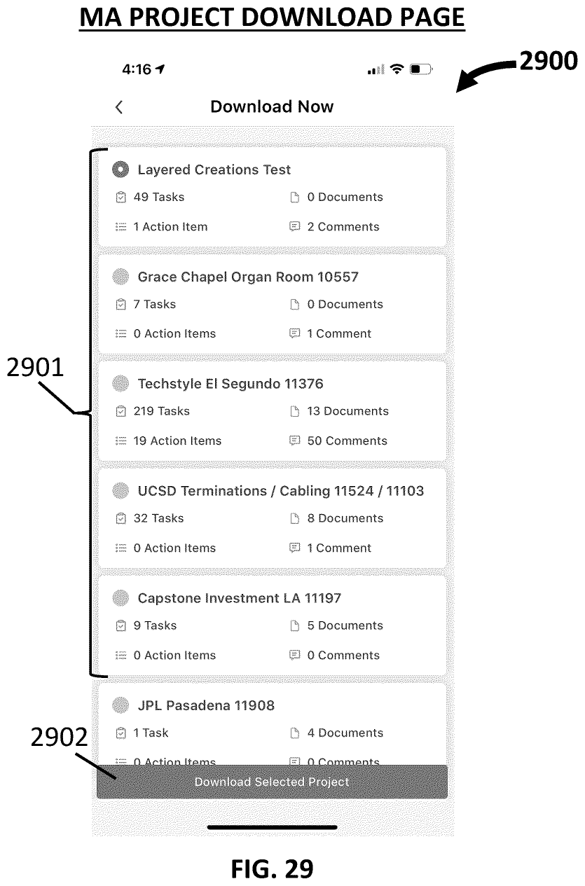

Comments are arranged vertically with the most recent showing on top of a scrollable window listing all project Comments. Each Comment of the presented embodiment of the MA (300) can have information comprising the Comment author's name and avatar/photo, time or date, first few lines of the comment, a widget to Read More of the Comment if pressed, and Priority level.
34) Feedback Surveys on the MA (Ref. FIGS. 3 and 27A-C): FIGS. 27A-C show the preferred embodiment of the Feedback forms (2700, 2710, and 2720) of the MA (300) for the Vendor Team User (2710) and Customer (2720) with questions (2701) specific to each form, multiple choice answers (2711, 2721), yes/no radio buttons (not shown), or text string fields (not shown). The survey questions are dependent on the particular application embodiment. A Save button widget (2702) allows the answered questions to be stored in the MA (300) for later upload to the Platform's Database or directly to the Platform's Database if a data connection linking the MA's (300) hosting device to the Platform's Database is available.
35) Sync and Download on the MA (Ref. FIGS. 3 and 28): FIG. 28 shows the preferred embodiment of the MA (300) as seen by a Vendor Team User for the Sync & Download page (2800) within the Global Systems Menu. The toggle widget (2802) turns the Offline mode of the MA (300) on or off. When the Offline mode is on, the MA (300) allows for reading and creating, updating, or deleting project and/or customer records from the portable digital device's memory. If the Offline mode is off, then any newly acquired data (status update, Signoff Documents, Feedback, etc.), Documents, recorded on the MA (300) or Platform Database during use offline use are immediately exchanged between the MA (300) and Platform Database after the Sync Now widget (2801) is pressed. The alignment occurs such that the project records shared between the Portal (200) and MA (300) are aligned to the version with the most recent timestamp. Alternative embodiments of the syncing feature allow MA Users to override with a version other than one with the most recent timestamp. Near the Sync Now widget is a counter of items on the MA side ready to upload to the Platform's Database. When the Offline mode is toggled on, then no attempt to exchange data and files will be attempted. For the presented embodiment, the Global Systems Menu Titles for the MA (300) are Projects (2803), Sync & Download (2804), Notification (2805), and Profile (2806).
36) Project File Access and Download on the MA (Ref. FIGS. 3 and 29-31): FIG. 29 shows the preferred embodiment of the MA (300) as seen by a Vendor Team User for the Projects download page (2900) within the Global Systems Menu. This page (2900) shows the list of downloadable Projects (2901). Each Project block has information comprising the Project name, the number of Tasks, Documents, Action Items, and Comments. Radio buttons next to each Project Name can allow Users to select which Project to download files from the Platform's Database onto the MA (300). When the User presses the button to download the selected project (2902), the download occurs if data network connectivity to the Platform's Database is available and Offline Mode is toggled to off (2802).

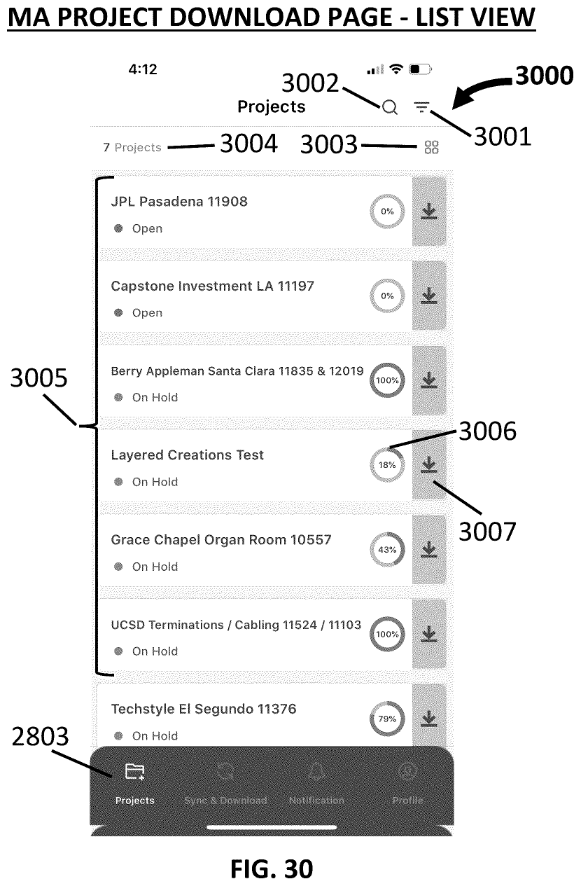

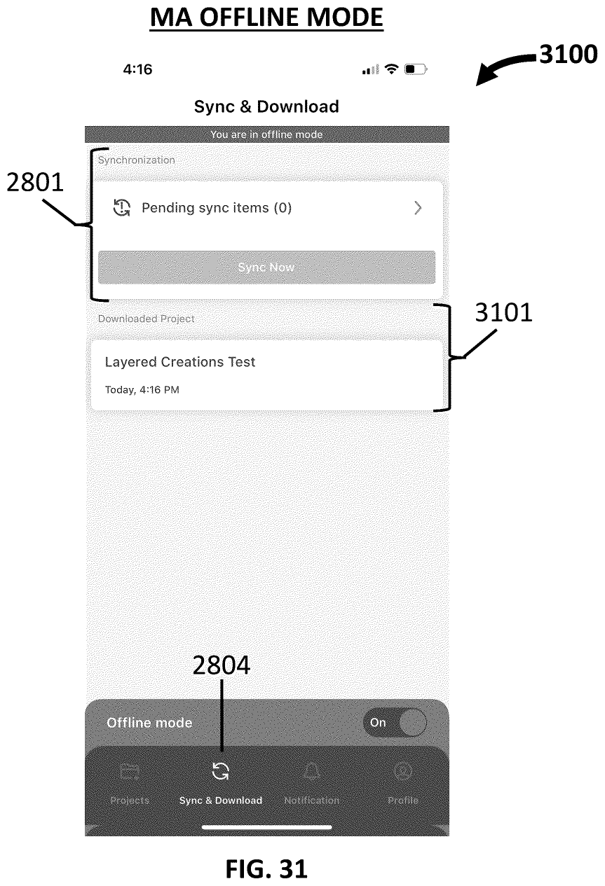

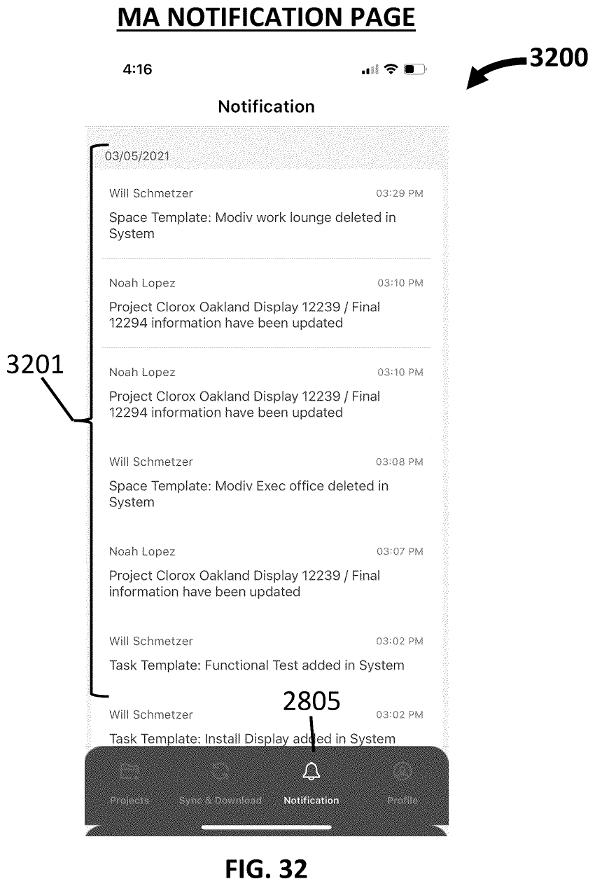

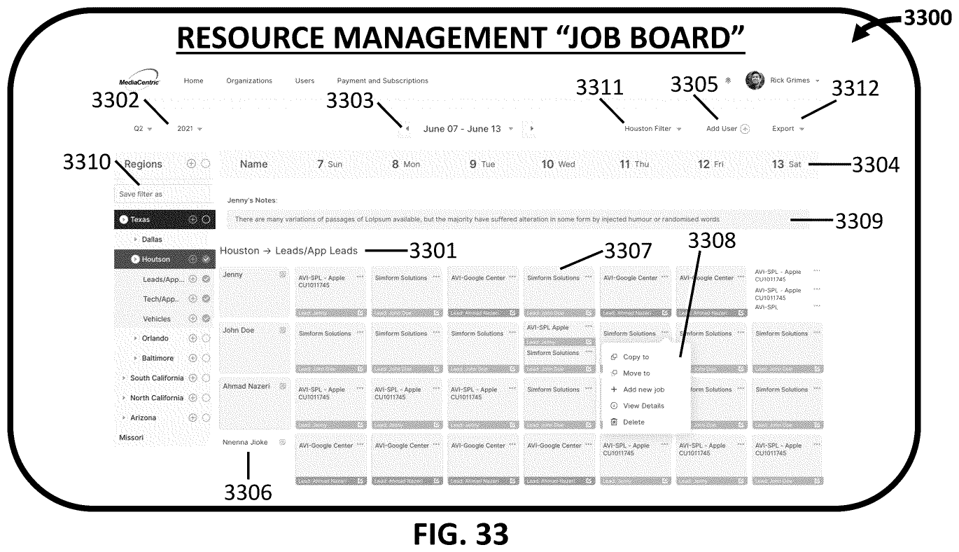

FIG. 30 shows the preferred embodiment of the MA (300) as seen by a Vendor Team User for the Projects page (3000) within the Global Systems Menu. (3001) is the Filter widget that when pressed allows Projects to be searched based on a Filter criterion/criteria. The search widget (3002), when pressed, opens a search string field that dynamically filters and displays the search results as the Project name block is typed into the search bar. (3003) is the toggle for Card view if the page is in List view, and conversely, the List view widget when the page is in Card view (not shown). (3004) shows the total number of projects shown in list form (3005) on the scrollable window. (3006) is a graphical and numerical indicator of the percentage of Projects completed compared to the total number of Tasks that need to be completed. (3007) is the download button widget that downloads the Project files when pressed. When Offline Mode is toggled off (2802) and a data network is available, the syncing happens immediately. FIG. 31 shows a variation (3100) on the panel (2800) seen in FIG. 28 after a project has been downloaded. The indication and timestamp of the downloaded Project are shown in (3101).
37) Notifications Page on the MA (Ref. FIGS. 3 and 32): FIG. 32 shows the preferred embodiment of the MA (300) as seen by a Vendor Team User for the Notifications page (3200) within the Global Systems Menu that shows a list of Notifications (3201). This list (3201) can be placed on a scrollable frame. Embodiments of the Platform can enable eligible Users (e.g., PMs) to post Notifications readable by other eligible Users. One embodiment can allow Notifications to be immediately seen by an internet-connected client device running the Platform application once posted. Embodiments of the Platform can allow postings to be distributed by RSS (RDF Site Summary or Really Simple Syndication) feed modules.
38) Customer Implementation of MA (not shown): The MA (300) implementation for Customer Users have a Dashboard home page, Projects page, and Reporting page.
39) Job Board (JB) Resource Management Module (Ref. FIG. 33):
   A) Background: Project duration for the A/V and security system integration usage embodiment can range from a half-day to months at a time. For extended duration Projects, the Vendor's Team members may not engage in any activities (i.e., off or “On Hold” days) due to waiting on a part needed to fulfill a task, or the site being unavailable for continued work on a particular day, and other reasons that preclude Project Task fulfillment. For Vendors that need to oversee many Projects, keeping track of the resource commitments for multiple Projects is critical to resource management and optimization. The resources referred to here span a wide range, but all relate to a reusable person, machine, or article of manufacture that contributes to the completion of a Project. Examples include a Vendor-side User, truck, ladder, etc.
   B) Purpose: The Job Board (JB) (3300), whose term is used interchangeably with “Resource Management Module” in the present disclosure, enables the Platform to automatically classify and reclassify the project status based on the “active” dates selected on the JB (3300) for a given Project. In the current embodiment, classification based on the JB's content is limited to “In Progress” or “On Hold” and is done by the Platform automatically without any user intervention.
   When a Project is created manually, the JB (3300) automatically assigns an “Open” status or Draft Mode. When the Project is scheduled on the JB (3300), it will automatically be put into “In Progress” for the day that it is scheduled. The Platform classifies the Project as “In Progress” if the present day falls under one of the selected dates or within the date range defined for the Project on the JB (3300). Otherwise, as long as the Project that has already started, has not “Closed,” and the present day does not fall within the selected dates or date range defined for the Project on the JB (3300), then the Platform classifies the Project to be “On Hold.”
   While the current embodiment classifies based on dates, other embodiments can classify for any time period, including hours, minutes, or even seconds. In one embodiment, like the “Open” status described earlier, the “Completed” status is established manually, although alternative embodiments can also trigger automated classification of “Open” or “Completed” status based on other inputs provided to the Portal.

Other embodiments of the JB (3300) can additionally store committed dates for Team members. In the preferred embodiment for A/V and security system integration applications, the onsite Lead Team member's dates are only those corresponding to when a notable milestone will be achieved so that an assessment can be made on whether the Daily or Completion Report is ready to be sent. The content of the JB (3300) is preferably viewable from eligible Vendor-side Team members.

C) Features:
i) JB Storage: The Platform's Database archives the JB's information.
ii) Weekly View Sheets: The preferred viewing embodiment of each sheet or page of the JB (3300) is a weekly view corresponding to a certain week. Alternative embodiments can scope out to a month, day, etc.
iii) Three Sections: The preferred JB (3300) embodiment is mainly composed of an always-visible “Top Bar,” a spreadsheet-like matrix, portions of which may be on a scrollable window, and a side pane that can be on a separate, optionally scrollable window.
iv) Location and Resource Type (3301): An exemplary JB organization embodiment can have each block of reserved resources on the vertically scrollable window delineated by region and resource type. The example shown in FIG. 33 shows the top block of reserved resources corresponding to Lead Techs (500) in the Houston city region. In addition, for example, this block can be stacked above another block of reserved resources corresponding to Techs (600) in the Houston city region (not shown). Since resources are arbitrary, a block can correspond to a truck in a certain region (not shown).
v) JB Viewable Date Range (3302, 3303): Embodiments of the JB have gross (3302) and specific (3303) time filters for displaying reservations on the JB (3300). FIG. 33 provides an example of a pair of pull-down menu widgets (3302) with Q2 (2^{nd} quarter) of the year 2021 selected. Another pull-down menu containing choices of weeks with Q2 or the year 2021 shows the week of June 7-13 was selected for display.
vi) JB Matrix Column Headings (3304): The column heading (3304) of the JB is shown in FIG. 34, which for the exemplary embodiment, shows the days of the selected week shown in the pull-down menu (3303). For the given embodiment, the far-left leading column has “Name” but can alternatively be called anything arbitrary, such as “Name/Item,” “Equipment,” etc.
vii) JB Add User (Resource) Widget (3305): Embodiments of the JB (3300) may include a widget to add the resource (3305) under the “Name” column as shown in FIG. 33. Engaging this widget (3305) may spawn a pop-up dialog to select from a list or new entry. The list is tied in with human resources records of actively employed Vendor-side Users, inventory records of potentially available equipment, etc.
viii) JB-listed User (Resource) Widget (3306): Under the “Name” column shown in FIG. 33 and within the appropriate “block” of reservations, region, and resource type (e.g., Lead Tech, Tech, truck, etc.) are the actual resources to be reserved. The intersection of a given date and resource name/item is a potential reservation or reservation.
ix) Resource Reservation (3307): A single JB interior cell (“Interior Cell”) (3307) is the intersection of a particular date and onsite resource (staff, item, etc.). Each group or block of reservations or unreserved slots is bounded by the date or time range and the number of resources corresponding to a block classification (e.g., Lead Techs in Houston). The text label shown within an Interior Cell can tersely identify the Customer, geographic location, Project name, Project ID number, and more. The background and optionally the foreground colors can be color-keyed to a particular Customer-side Team.
x) JB Pop-Up Menu (3308): JB Interior Cell embodiments can also display a drop-down menu (3308) after right-clicking from a hardware input device with a UI pointer placed on the cell of interest. Exemplary embodiments of this menu (3308) can include the choice to “Copy to,” for copying an existing Interior Cell information from one slot to another slot that is open for reservation. If the Interior Cell crosses into a different row, which signifies a different resource, then the resource is changed within the JB. Embodiments of the JB can offer a “Move to” choice, which is like “Copy to,” but the originating Interior Cell turns into an open slot. Availability of each resource is tied in with the human resource and/or equipment inventor parts of the Database. For example, if “Jenny” decides to call in sick for the entire week shown in FIG. 33, the entire row can be either removed or the Interior Cells for the “Jenny” row indicated sick leave. JB embodiments can trigger notifications to eligible User(s) who need to know if a previously scheduled resource becomes unavailable. Embodiments of the JB can auto-allocate other comparable available resources or query certain Users for alternative dates if a specific resource reservation needs to be canceled. “Add New Job” as shown in FIG. 33 represents the option to reserve a resource in a slot. The “View Details” option queries the Database and lists all relevant background information pertaining to the Task being fulfilled in the slot of interest. “Delete” expunges from the JB Database all records for that slot.
xi) Resource-linked Notes (3309): Each resource on the JB has a text string field (3309) for job-specific notes. Embodiments of this JB's text string field (3309) can change for each resource based on which resource name/item is brought to focus (e.g., single left clicking the resource in column (3306).
xii) Display by Region Filters (3310, 3311): Embodiments of the JB (3300) can have a side pane that allows users to set the regions where resources are being allocated. At one level, there can be a cascading menu of regions (from large to smaller areas), then when selected, will show on the main JB (3300). Another embodiment of the JB (3300) additionally includes a saving provision (3310) to save the selections for future quick-recall (3311).
xii) Holiday Schedule JB Dependencies: Embodiments of the JB (3300) can create dependencies to each Team User's Holiday Schedule record stored on the Platform's Database. The holiday schedule can be loaded through the Configuration (1500) Global Systems Menu option. Team User holiday dates on record would auto-block the addition of that User to the JB′ on that date(s). This can be overwritten if the holiday has a “Floating” modifier which signifies the Team User agrees to work during a previously declared holiday and prevent holiday time from being charged. JB embodiments can optionally accept Holiday Schedules that periodically recur.
xiii) Other JB Content: Embodiments of the JB (3300) can also access from the Platform, provisions for time or geolocating tracking a Project, Team member, delivery, or any Task critical element.
xiv) Provisions for JB Export (3312): JB content can be exported by engaging the corresponding UI widget (3312) on the JB. Content can be exported by way of an automatic Email, mobile device text message, or formatted (e.g., CSV, PDF, etc.) file. The JB's export function (3312) can retrieve Database stored information as identified by a week, weeks, month, or months of interest.

Many alterations and modifications may be made by those having ordinary skill in the art without departing from the spirit and scope of the embodiment. Therefore, it must be understood that the illustrated embodiment has been set forth only for the purposes of example and that it should not be taken as limiting the embodiment as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.
ZOHO® is a registered trademark of AdventNet, Inc.
@d® is a registered trademark of D-Tools, Inc.
Microsoft® and 365® are registered trademarks of Microsoft Corporation
ADA is a trademark of CARDANO Foundation
Java® and JavaScript® are registered trademarks of Oracle Corporation.
Kotlin™ is a registered trademark of The Kotlin Foundation.
Prolog® is a registered trademark of Trimble Inc.
Python®, is a registered trademark of The PSF.
Bluetooth® is a registered trademark of Bluetooth Special Interest Group (SIG).
Zigbee® is a registered trademark of ZigBee Alliance.
Wi-Fi is a registered trademark of Wi-Fi Alliance.
Perl is a registered trademark of The Perl Foundation.

1. A system for cross-enterprise project monitoring, management, and reporting, comprising:
a plurality of digital devices each with a processor, a video display, local system memory, data storage hardware, input/output provisions for data and digital content, and networking provisions;
a remote server on a network;
a software application with a graphical user interface (GUI) installed on each digital device or said remote server;
said remote server with a database containing non-volatile memory for storing project and customer records;
wherein said application having the means for users to create, store, access, view, edit, delete, and manage data records and support content for projects and customers;
wherein the components of said application comprise two applications, a portal application and a mobile application;
said portal application further comprising a global menu and submenu for each global menu topic;
wherein each task of said project as organized by said application is binned under a task group;
wherein said project is further defined within said application by one or more units where tasks are to be fulfilled;
wherein said mobile application is installed on a portable digital device;
said application further comprising a suite of interlinked modules;
said modules comprising a project resource management module, milestones module, budget management module, and a reporting module;
wherein said reporting module mines certain project-specific information fragments stored on the database and generates one of various types of reports;
said types of reports comprise a periodic, current status, and completion report.

2. The system of claim 1, further comprising a means for system users with administrative privileges to define other system user types defined by a set of permissible actions on said system, add a system user with certain permissions, delete a system user, create customer account records, create project records, create tasks to be fulfilled in a certain unit, and create templates for tasks to be fulfilled in a certain unit or templates for a set of tasks under a task group or category.

3. The system of claim 1, further comprising a gallery of pictures showing completed tasks within a unit that is accessible from said portal application and/or mobile application.

4. The system of claim 1, wherein said menu structure of said portal application further comprises:
a plurality of global menu topics comprising those that relate to records for an application home, customers, projects, templates for specific records, platform configuration, reporting, and resource management;
a plurality of submenu topics for each global menu topic;
said submenu topics for the portal application's projects global menu comprising those related to definable project-specific records comprising the unit(s) where tasks are fulfilled, the task(s), team member(s), document(s), periodic report(s), action items, and chargeable or budget item(s);
said submenu topics for the portal application's templates global menu comprising those related to the definition of units in terms of tasks that are to be fulfilled and the definition of task groups;
said submenu topics for the portal application's configuration global menu comprising those related to the definition of each user's permissions and privileges to carry out actions of said application, budget line item(s), and searchable tag word(s) or phrase(s);
said submenu topics for the portal application's reporting global menu comprising those related to a project's timeline and status, actions item(s) and status, assigned team member(s), and budget item(s);
said submenu topics for the portal application's resource management module comprising those related to display filters organized by date range and location range.

5. The system of claim 1, further comprising:
said mobile application featuring an offline mode with a means to create, store, access, view, edit, and manage project data records, form(s), and document(s) from the portable digital device's memory without the need to be connected to a remote server and database;
said offline mode that can be activated or deactivated by engaging a toggle switch widget shown on a touchscreen video display of said portable digital device; and
a synchronization feature where the project records, form(s), and document(s) shared between the portal and mobile applications are aligned to the version with the most recent timestamp as long as the offline mode is off and a data connection between the system's database and portable digital device exists.

6. The system of claim 1, further comprising one or more of the following:
said application that tracks the date and/or time slots assigned by eligible user(s) on said application for certain resource(s) toward the completion of said project;
said application that tracks expenditures for individual budget line items defined in said budget management module;
said application that tracks the state of completion of said task(s) within said unit(s) of said project;
said application that tracks whether previously defined milestone(s) have been attained based on said expenditures and/or said state of completion; and
said application that provides notifications based on a triggering condition based on date(s), state of completion, and/or certain resource expenditure(s) whose threshold(s) have been crossed.

7. A method of structuring and defining a project within a system for cross-enterprise project monitoring, management, and reporting, comprising the steps:
loading initial project documentation;
adding searchable tag words or phrases as needed;
defining the two intermediate layers between said project and task(s) to complete the project, wherein one layer is the set of unit(s) where task(s) need to be fulfilled and another layer is task group(s) that each comprises a set of task(s);
defining templates for unit(s), task(s), or task group(s) as necessary;
defining budget item(s);
adding action item(s) as necessary;
adding note(s) and/or comment(s) as necessary;
assigning system user(s) to said project team within a resource management module;
assigning other resources within said resource management module; and
defining project milestone(s) as necessary;
wherein all steps are accomplished by the user engaging the widgets of a graphical user interface (GUI) of said system with a plurality of input/output devices comprising a video display, virtual or physical keyboard, and a user interface pointer control device; and
whereby the results of all steps are applied to the portion of the system's database storing all records related to said project in non-volatile memory.

8. The method of claim 7, wherein said documentation comprises one or more of the following:
statement of work;
bill of materials;
drawings;
installation guide(s); and
forms.

9. The method of claim 7, wherein a unit template is defined by the user on said system as follows:
identifying the unit template being created with a name;
naming the type of unit template; and
creating a new tasklist for this particular unit or choosing another unit template to inherit its built-in attributes as a starting point.

10. The method of claim 7, wherein a task group template is defined by the user on said system as follows:
identifying the task group template being created with a name; and
adding and defining one or more task(s) to be included in said task group.

11. The method of claim 7, wherein a unit is defined by the user on said system as follows:
identifying the unit being created with a name;
deciding whether to define the unit being created from scratch or expedite the definition of the unit with a previously defined template stored on said system's database with one or more defining aspects;
said defining aspects comprise one or more of the following: total number of tasks to complete within said unit, searchable tag phrases, provision to add action items, whether to require a picture to be uploaded onto said database, and if so, provide a provision for the user to upload one or more pictures, and a provision to define the current status of task fulfillment within said unit.

12. The method of claim 7, wherein said task is defined by the user on said system as follows:
deciding whether to define the task being created from scratch or expedite the definition of the task with a previously defined template stored on said system's database with one or more defining aspects;
said defining aspects comprise one or more of the following: name, description of the task, anticipated duration to complete the task, start and end dates of fulfillment, the category or group the task falls under, task type, task subtype, project team member to fulfill the specific task, and whether to require a picture to be uploaded onto said database, and if so, provide a provision for the user to upload one or more pictures.

13. The method of claim 12, wherein said task comprises the following hierarchy:
a task group which the task falls under, wherein said task group is a collection of individual tasks that compactly describe the overall job toward completion of a unit;
type of task; and
subtype that more precisely defines the nature of said task.

14. The method of claim 7, wherein the scope of system interaction privileges and permissions of a specific user class or type defined on said system, how specific budget items are to be defined, and searchable tags are defined by an eligible system user or administrator with the system's configuration module.

15. The method of claim 14, wherein each budget item is defined by those comprising one or more of the following:
description suggesting the type;
a more detailed description; and
whether the definition of the budget quantification metric is either user-defined or from a pre-defined list of metrics.

16. The method of claim 7, wherein said milestones are established by the user of said system as follows:
defining the number of milestones;
defining a given milestone based on one or more of the following metrics comprising time intervals, man hours expended, number of units completed, and particular billed item charged; and
defining a triggering criterion or criteria for automatically sending notification(s) electronically to designated system users based on one or more of the following conditions comprising dates, percentage of all units completed, and percentage of all allocated man hours charged.

17. A method of remotely updating the project records within a project management system, comprising of the steps:
determining first whether the tasks are to be fulfilled in an area where a data connection between a mobile device with a mobile application version of said system and the internet is either prohibited or unavailable;
synchronizing with project records stored on said system's database before entering an area where a data connection between said mobile device and internet is either prohibited or unavailable; and
engaging a toggle switch of a mobile application version of said project management system installed on a data network linkable mobile device to enable said application's offline mode;
wherein said synchronizing process includes updating all project-specific including those comprised of one or more of the following: unit(s), tasks(s), action item(s), comment(s), notification(s), downloading form(s) and/or document(s), vendor-side project team member information, and customer-side project team member information;
wherein said mobile device possesses optical hardware and driver to at least enable pictures to be taken that shows complete task(s).

18. The method of claim 17, further comprising the steps:
working on fulfilling tasks within a task group for a given unit;
registering hardware where applicable;
wherein hardware registration comprises the recordation of one or more of the following pieces of information: device model name or number, serial number, IP address, and MAC address, and any other information;
wherein hardware information is entered by a means comprising one of the following:
tapping the field shown on a touchscreen video display of said mobile device to open a dialog to take a picture or video, perform bar code scanning, or scan a QR code;
recording picture or video evidence for a task, task group, or unit completion as required;
filling out form(s) and acquiring document(s) as needed; and
setting the status of the task fulfillment by selecting the appropriate choice from the widget shown on the video display of said mobile device;
wherein all recorded project information is stored locally on said mobile device before immediate synchronization between project records on said mobile device and said system's database to the most up-to-date records provided said offline toggle switch was set to off and a data connection between said mobile device and said system's database exists.

19. The method of claim 18, further comprising the steps:
switching said offline toggle switch mode to the off position if the switch was previously on to signify data synchronization of project and customer record(s) are allowed;
wherein once a data connection has been established between said mobile device and said system's database, the most up-to-date records will be loaded or updated to said mobile device and system's database.

20. A method for generating and disseminating periodic project status reports within a project management system, comprising the steps:
checking whether a Boolean switch that enables said report to be generated and disseminated at predetermined time(s) has been previously activated by a user via widget engagement on the user interface of the application of said project management system;
at the predetermined time, querying specific information fragments from a database of said project management system storing project information records in non-volatile memory;
mapping or transferring each information fragment to a pre-defined field in said report;
digitally compressing said report, archiving said report into said database; and electronically delivering said report to a predetermined list of recipients; or
digitally compressing said report, electronically delivering said report to a predetermined list of recipients, and archiving said report into said database.

21. The method of claim 20, whereby said information fragments include those related to one or more of the following:
line item budget expenditure(s) and status indicator(s) that characterize the level of expenditure relative to the allocated budget;
vendor- and customer-side identifying information, project title, contact information, and for arbitrary remote locations, the project site location;
project team member or user names comprising those with one or more of the following roles within the project including the vendor-side team lead(s);
fully task fulfilled or completed units with embodiments listing a summary comprising each of the unit's name and type of task or task group fulfilled in each of said unit(s);
wherein each unit's summary contains an embedded jump link that when engaged, opens a file or accesses information to a linked database and shows on a video display of the application's host device further details of the unit's task fulfillment;
wherein said organized list of tasks or task groups each comprises one or more of the following information including the task completion status label start and end dates, associated units, budget line items and the corresponding state of budget expenditures, overall budget expenditures, and milestones;
an organized list of comment(s) or handle(s) to comment(s) provided by one or more project team members starting with the most recent on top;
wherein each comment is assigned a priority level;
an organized list of action item(s);
a tally of the completed project-wide task set by status; and
a numerical or graphical indication of the progress toward the completion of all project tasks.

22. A method for generating and disseminating a current status report within a project management system, comprising the steps:
checking a project management system's database stored in non-volatile memory to see if the project of interest has started, and if started, is in progress, and is not yet completed, execute the following steps;
actively monitoring whether a certain project milestone has been completed or if a user has requested by engaging a widget of the project management system's application to receive a current status report, and if either case is true, execute the following steps;
querying specific information fragments from the database of said project management system storing project information records;
mapping or transferring each information fragment to a pre-defined field in said report;
digitally compressing said report; and
projecting said report onto said user's video display or archiving said report into a database.

23. The method of claim 22, whereby said information fragments include those related to one or more of the following:
line item budget expenditure(s) and status indicator(s) that characterize the level of expenditure relative to the allocated budget;
vendor- and customer-side identifying information, project title, contact information, and for arbitrary remote locations, the project site location;
project team member or user names comprising those with one or more of the following roles within the project including the vendor-side team lead(s);
fully task fulfilled or completed units with embodiments listing a summary comprising each of the unit's name and type of task or task group fulfilled in each of said unit(s);
wherein each unit's summary contains an embedded jump link that when engaged, opens a file or accesses information to a linked database and shows on a video display of the application's host device further details of the unit's task fulfillment;
wherein said organized list of tasks or task groups each comprises one or more of the following information including the task completion status label start and end dates, associated units, budget line items and the corresponding state of budget expenditures, overall budget expenditures, and milestones;
an organized list of comments or handle to comments provided by one or more project team members or users starting with the most recent on top;
wherein each comment is assigned a priority level;
an organized list of action item(s);
for hardware installation-related projects, a catalog matrix of registered installed equipment for each unit, wherein each row of information comprises the unit, device model name or part ID number, device serial number, device IP address if applicable, and device MAC address if applicable;
a tally of the completed project-wide task set by status; and
a numerical or graphical indication of the progress toward the completion of all project tasks.

24. A method for generating and disseminating a project completion report within a project management system, comprising the steps:
declaring a project as completed on the project management system's application, receiving concurrence through said system from the customer that the project was satisfactorily completed, signing off on project completion with said system application by all parties of interest, and uploading a signoff form a system's database stored in non-volatile memory;
receiving via input/output device on a textbox on the system's graphical user interface, close-out comments, and parting message from an eligible user to be shown in said report;
querying specific information fragments from the database of said project management system storing project information records;
mapping or transferring each information fragment to a pre-defined field in said report;
digitally compressing said report, archiving said report into a database; and electronically delivering said report to a predetermined list of recipients; or
digitally compressing said report, electronically delivering said report to a predetermined list of recipients, and archiving said report into a database.

25. The method of claim 24, whereby said information fragments include those related to one or more of the following:
line item budget expenditure(s) and status indicator(s) that characterize the level of expenditure relative to the allocated budget;
vendor- and customer-side identifying information, project title, contact information, and for arbitrary remote locations, the project site location;
project team member or user names comprising those with one or more of the following roles within the project including the vendor-side team lead(s);
completed units with embodiments listing a summary comprising each of the unit's name and type of task or task group fulfilled in each of said unit(s);
the success rate of completing task(s) for each unit;
wherein each unit's summary contains an embedded jump link that when engaged, opens a file or accesses information to said system's database and shows on a video display of the application's host device further details of the unit's task fulfillment;
wherein said organized list of tasks or task groups each comprises one or more of the following information including the task completion status label start and end dates, associated units, budget line items and the corresponding state of budget expenditures, overall budget expenditures, and milestones;
final close-out comments just entered by one or more project team members;
for hardware installation-related projects, a catalog matrix of registered installed equipment for each unit, wherein each row of information comprises the unit, device model name or part ID number, device serial number, device IP address if applicable, and device MAC address if applicable; and
an embedded hyperlink that when engaged, accesses from the system and downloads to the requesting user's local storage device all project documents, pictures, action items, and comments.
